(19) United States
(12) Patent Application Publication
(10) Pub. No.: US 2008/0026816 A1
(43) Pub. Date: Jan. 31, 2008

(54) Providing Benefits To Players Who Agree To Appropriation Of A Portion Of Future Winnings

(76) Inventors: Russell P. Sammon, San Francisco, CA (US); Jeffrey Y. Hayashida, San Francisco, CA (US); Daniel E. Tedesco, Huntington, CT (US); Stephen C. Tulley, Monroe, CT (US)

Correspondence Address: WALKER DIGITAL MANAGEMENT, LLC, 2 HIGH RIDGE PARK, STAMFORD, CT, 06905, US

(21) Appl. No.: 11/577,633

(22) PCT Filed: Jul. 25, 2006
(86) PCT No.: PCT/US06/29008

§ 371 Date: May 11, 2007

(51) Int. Cl. G06F 17/00

(52) U.S. Cl. 463/20

(57) ABSTRACT

The invention includes methods and apparatus for providing a benefit to a player in return for the player agreeing to have a portion of at least one anticipated future winning outcome appropriated during play of a wagering game. In an embodiment, the method includes providing an offer for a benefit to a player in exchange for entering into an agreement to appropriate a portion of at least one future winning outcome of a wagering game, and providing the benefit if the player accepts the agreement. In some embodiments, the method may also include determining that a player of a wagering game entered into the agreement, and appropriating a portion of the value of at least one winning outcome in accordance with at least one condition of the agreement.

This application claims priority from International Application No. PCT/US06/29008 filed Jul. 25, 2006, entitled “PROVIDING BENEFITS TO PLAYERS WHO AGREE TO APPROPRIATION OF A PORTION OF FUTURE WINNINGS”.

### FIELD OF THE INVENTION

The present invention generally relates to methods for enticing players to play wagering games, for example, by using electronic Game Devices (GDs), such as slot machines, video poker machines and pachinko machines. More specifically, the present invention relates to methods and apparatus for providing a benefit to a player in return for the player agreeing to have a portion of anticipated future winning outcomes appropriated during wagering game play. For example, a player may receive an offer for twenty-percent off the price of a product in exchange for agreeing to terms and conditions associated with appropriating a portion of future winning payouts during wagering game play on a particular type of GD in a casino gaming parlor. The benefit is provided if the player accepts the terms and conditions.

Advantages and features of the invention will become apparent upon reading the contents of this document, and the nature of the invention may be more clearly understood by reference to the following detailed description of the invention, the appended claims and to the drawings attached hereto.

### BRIEF DESCRIPTION OF THE DRAWINGS

FIG. 1A is a plan view of an embodiment of an example of an electronic Game Device (GD) of a type adapted for use in some embodiments according to the present invention;

FIG. 1B is a simplified block diagram of an embodiment of a GD similar to that depicted in FIG. 1A;

FIG. 2A is a block diagram of an embodiment of an electronic Game Server (GS) in accordance with the invention, wherein the GS is a component of a system and may be configured to communicate with a plurality of GDs;

FIG. 2B illustrates an embodiment of an Agreement Paytable for use in governing payouts during play in an appropriation mode according to an embodiment;

FIG. 2C is an embodiment of a printed cash register receipt that includes an offer for a benefit according to an embodiment;

FIG. 2D is a simplified drawing of a Personal Digital Assistant (PDA) having a display screen that may be utilized to output offers for benefits according to an embodiment;

FIG. 2E is a simplified drawing of a television screen that may be used to display offers for benefits according to an embodiment;

FIGS. 3A, 3B and 3C depict a flowchart illustrating an embodiment of a process concerning offering a benefit in return for a player agreeing to have a portion of anticipated future winning outcomes appropriated;

FIGS. 3D to 3H are screen shots of an embodiment of a portion of a GD front panel illustrating various messages that may be displayed to the player concerning an agreement that the player made to receive a benefit;

FIGS. 4A and 4B illustrate a tabular representation of an agreements database according to an embodiment;

FIG. 4C is a screen shot of an embodiment of a portion of a GD front panel illustrating a Feature Selection menu display on a touch screen that is offered to a player who may enable or disable various GD features and then start wagering game play;

FIGS. 5A and 5B illustrate a tabular representation of an appropriation scheme database according to an embodiment;

FIG. 6 is a tabular representation of an agreement valuation database in accordance with an embodiment;

FIG. 7 is a flowchart illustrating an embodiment of a process concerning determining that a player entered into an agreement associated with the receipt of a benefit;

FIG. 8 is a tabular representation of an appropriations tracking database according to an embodiment; and

FIGS. 9A, 9B and 9C are screen shots of a portion of a GD front panel illustrating a Welcome Screen display, Purchase History display, and a “Play It Off” Agreement Manager display, respectively, according to embodiments of the invention.

### DETAILED DESCRIPTION OF THE INVENTION

Revenues from non-gaming activities in gaming locations such as Atlantic City and Las Vegas have grown, and are now greater than revenues from gaming activities. Although wagering games are still an important driver for enticing people to visit such locations, it has become apparent that many people prefer to spend a disproportionate amount of their money on restaurants, shopping, various services, spas, shows, and other forms of non-gaming entertainment. Some casinos will discount a player's hotel room if the player plays a wagering game for a specified period of time. For example, a player may get a 10% discount on his hotel room if he plays poker for at least 6 hours. Casinos would benefit from other methods of motivating customers of non-gaming establishments (e.g., restaurants, spas, retail stores) to visit the casino parlors and play wagering games.

In some embodiments, a benefit may be provided to a player in exchange for the player agreeing to have a portion of his anticipated future winnings on an electronic game device (GD) appropriated. For example, a player who is operating a slot machine in a casino may wish to activate movie playback on the GD (a premium feature) in exchange for agreeing to have one coin appropriated or taken from any prize or jackpot that she wins of more than ten coins. This may be presented to the player as a “Play It Off” option on the GD, and the money appropriated from the player's winnings is used to pay for the activated feature on the GD.

In another example, a consumer may bring an article of merchandise to a point of sale (POS) terminal of a retail store and be presented with a pitch to obtain a discount if she agrees to “Play It Off” at a nearby casino. The offer may be presented verbally by a sales clerk or may be displayed at the POS terminal as: “Get 10% Off the retail price of this article of merchandise if you agree to play the “Hillbilly Haven” video gaming machine at the “Lucky Star Casino” for 6 hours anytime within the next 5 days”. The person can then decide whether to accept these terms to obtain the benefit (the discounted price) or to pay full price for the merchandise. In this example, if the consumer wishes to accept the terms of the agreement, the sales clerk may require her to use an electronic device to provide her digital signature to acknowledge acceptance. In some embodiments, consumers are directed to utilize an electronic touch pad having an associated plastic stylus to sign their names on a provided touch display screen signature line, and the electronic touch pad is capable of communicating such digital signatures to the POS terminal or to another device for verification purposes and the like.

In some embodiments, a player may make a “Play It Off” agreement within the confines of a casino, such as when engaged in a wagering game on the casino floor and/or when patronizing establishments that are inside of a hotel casino building, such as a coffee shop or souvenir store. In some embodiments, the player may obtain a benefit and make a “Play It Off” agreement in a location that is physically separated from and distinct from the casino, for example, at establishments or properties owned by third parties located a distance away from the casino (for example, a point-of-sale (POS) terminal of a retail store that is five miles away from the casino). For example, a player who is shopping at a clothing store, department store or other retail establishment separate from and not affiliated with any casino, may be offered a benefit of up to $50 off of a cashmere sweater that she has brought to a POS terminal, if she agrees to have a portion of her winning outcomes that include a “Lemon” symbol appropriated while she is playing a particular type of GD at the “Lucky Horse-Stars” casino. The sales clerk may be entrusted or prompted to make such “Play It Off” offers to consumers who buy particular types of merchandise, for example, any article of clothing costing more that $75 dollars. In this example, the total discount that the player receives on the cashmere sweater may be determined at a later time, as it would be based on the amount and the value of any winning outcomes the player achieves that include the “Lemon” symbol.

In some embodiments, the manner and amount of a player's winning outcomes at a GD that are apportioned and/or appropriated to satisfy the debt associated with the benefit may proceed according to a particular appropriating scheme, and the conditions may be specified in an agreement made with the player (e.g., at the time the player agreed to receive the benefit). For example, an agreement may specify an appropriating scheme in which 10% of any prize won by a player will be appropriated until a total of $20 is taken, or appropriated from the player's winning outcomes (in some embodiments, the appropriated amount may be equal to the value of the benefit that the player has received, or the appropriated amount may be of less than the value of the benefit). In another example, the player may have agreed to an appropriating scheme that takes the entire amount (i.e., 100%) of any prize won by a player until a predetermined total value is reached, after which time the player is entitled to all winning outcomes. In this case, when a winning outcome occurs, the credit meter of the GD that the player is utilizing may not be incremented until the amount owed is reached, and a display screen may present messages to the player during game play reminding him of the debt owed and presenting his progress towards his goal of totally paying off the debt. Of course, other examples that include different percentages or portions of the player's winning outcomes to appropriate may be used, for example, to mitigate any risk that a player may default or otherwise fail to repay the amount owed.

Funds that are to be appropriated from the player's winning outcomes may be electronically transferred or credited, for example, from a GD to a casino account. In addition, the agreement may specify a gaming requirement to be completed by the player. For example, the player may be required to wager at least a certain minimum amount of money or to play a GD for at least a certain number of outcomes (or period of time). In some embodiments, a benefit that was provided to a player (for example, a discount on a spa treatment) may be revoked if the player does not satisfy a gaming requirement (e.g., her credit card may be charged for an amount equal to the discount, or equal to a remainder of the debt that she owes).

There are numerous potential benefits to casinos and to GD manufacturers for directing players that are engaged in non-wagering activities to play wagering games at their casinos' and/or on their GDs. For example, casinos and GD manufacturers may wish to encourage players to try new GDs, and thus benefits (e.g., a discount at a restaurant) may be offered to entice players to engage in wagering play on such GDs. In an embodiment, patrons may be encouraged to play GDs that are located at a visible, central location on a slot floor, perhaps at non-peak times so that the casino has patrons at all hours and thus looks inviting. In addition, the casino may be able to obtain some general flexibility concerning managing the flow of players of GDs on the slot machine floor. That is, by providing a potentially small benefit, players may be driven to particular areas or to particular GDs as the casino sees fit.

In some embodiments, players may be eligible to receive various benefits (which they may be able to select, for example, an extension of credit to purchase a good or a service, and/or deferring payment for a product or service) in exchange for having a share of their anticipated future winnings appropriated, including having certain features activated on a GD. According to one aspect, a player receives a benefit prior to winning any prizes at the GD in a casino, and it is contemplated that players will be particularly interested in receiving benefits and/or prizes immediately based on their anticipated future winnings.

In some embodiments, a person may request a benefit and then be provided with the benefit in exchange for agreeing to play a wagering game and to have a portion of at least some winning outcomes appropriated up to a specified amount. For example, a consumer about to purchase clothing in a retail shop located near a casino may ask a store clerk if there is an agreement that she can consider to obtain a discount in exchange for allowing the casino to appropriate a portion of her future winning outcomes. In such embodiments, information concerning one or more agreements may be output to the person (consumer) in many ways, for example, via a display screen of a POS terminal, by an in-room television, by cell phone, by a wireless device, and/or by a personal digital assistant (PDA), so that she can decide whether or not to enter into the agreement.

It is contemplated that the disclosed methods and apparatus will permit casinos and other game machine operators to offer new features on their GDs without forcing a player to pay an upfront cost to activate these features. This may result in players experimenting with additional premium features on GDs, which would be beneficial to the GD owners and/or to the operators. In addition, such methods may motivate players to purchase or try products or services that they would not otherwise have tried or purchased. For example, a retailer may offer a product at a reduced price if the player agrees to “Play It Off” at a casino, or may offer a discount on an expensive product for the same “Play It Off” terms, and be subsidized for any lost profits by the casino which gains a player. The cross benefits of such a “Play It Off” process, and how different entities (i.e., casinos, retailers, service providers, and the like) interact to achieve advantageous results will be described in more detail below.

In some embodiments, players already playing wagering games at GDs, such as slot machines, can receive gaming-related benefits in exchange for agreeing to have a portion or a share of their anticipated and/or future winning outcomes appropriated until a predetermined value is reached. In this case, the casino solely reaps any rewards gained by having the player agree to terms and conditions to secure the gaming-related benefits. In some embodiments, a GD may include a button or touch-screen selection that enables a player to request a benefit in exchange for entering into an agreement. Similarly, consumers may be presented with indicators, such as signage or audio/video messages, in a retail store or other retailing establishment concerning benefits that may be obtained in exchange for agreeing to “Play It Off” at a participating casino. These general offers for obtaining benefits may motivate patrons of certain establishments and/or customers of providers that may be separate from a casino (e.g., local area stores, retail chain stores, area service providers, websites, and the like) to visit the casino and to operate GDs and/or play wagering games that are offered by the casino.

In some embodiments, consumers may be permitted to ask if any “Play It Off” offers are associated with a particular product or service, and a retailer may have the flexibility to make one or more such offers that would be acceptable to both the retailer and to a casino. Thus, persons who may not have ordinarily played a wagering game may be enticed to do so because they perceive that the benefit received and the agreement made to “Play It Off” are favorable and/or are otherwise agreeable to them. This may be particularly advantageous and/or beneficial to casinos that are interested in attracting new players. In addition, such offers may require wagering game play on newly introduced GDs, so that players will be enticed or encouraged to try out such new GDs which they may not have ordinarily played when visiting the casino.

It is contemplated that the methods disclosed herein may also provide a method of limiting a player's play, and/or limiting the player's losses on a GD. For example, money that is appropriated from a player's winnings may be used to pay for a benefit agreed to by the player (e.g., paying down the player's credit card bill). In this manner, the processes disclosed herein may be used to help problem gamblers from losing excessive amounts of money by playing GDs.

The present methods and apparatus permit players to obtain benefits, such as product discounts and/or game play features, and entices players to agree to “Play It Off” by having a share of future winning outcomes appropriated so as to repay the debt and/or to provide value in exchange for benefits. In some implementations, the methods, apparatus and systems described herein include processes and/or components configured to collect data associated with the benefits and with the “Play It Off” offers and agreements, such as the number and the types of offers for benefits that are made to players, and to collect data that is associated with appropriation schemes.

Before describing further details associated with the offers to obtain benefits, the agreements, and the methods for appropriating winnings, presented below are descriptions of illustrative apparatus and related components.

### 1. Electronic Game Device (GD) Components

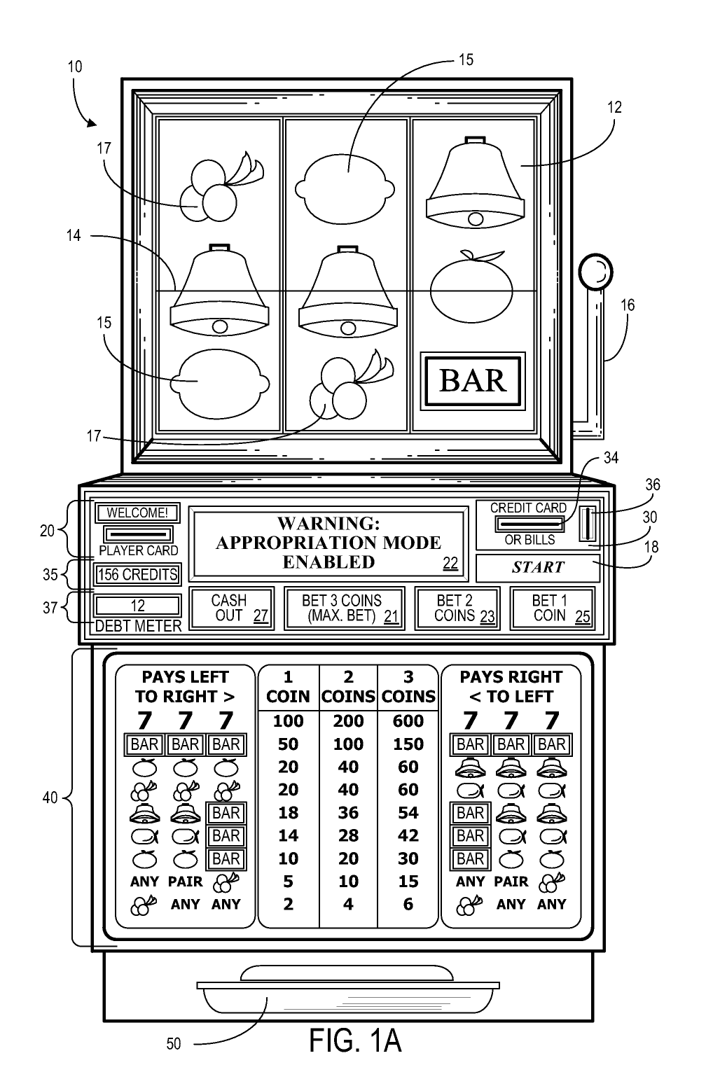

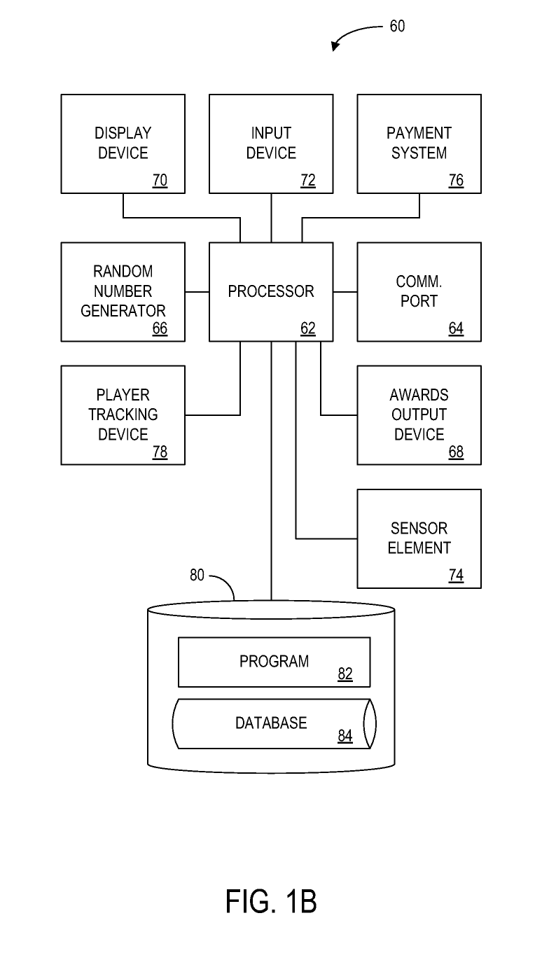

FIG. 1A is a plan view of an embodiment of an electronic game device 10 (GD). In this example, the GD 10 comprises a three-reel slot machine that includes a display area 12 in which an outcome for a game of the slot machine is displayed to the player. The display area 12 may be, for example, a video display that displays simulations of reels. The display area 12 may be, in another example, a transparent window behind which is located mechanical reels. A payline 14 appears within the display area 12, and the payline is used to determine the outcome of a game. In particular, a particular set of symbols displayed along a payline of a reeled slot machine may be determinative of a winning or losing combination.

FIG. 1A shows two bells and an orange along the payline 14, and a message appears in display area 22 that recites: “Warning: Appropriation Mode Enabled” that informs the player that he is gaming under the terms of a “Play It Off” agreement, wherein a portion of his winning outcomes are being appropriated. Also shown are Lemon symbols 15 and Cherry symbols 17, but other types of symbols or icons could be used and are well known. In some GD embodiments, multiple paylines (not shown) may be provided that may be horizontal (such as payline 14), vertical, and/or diagonal.

It should be understood that other methods of outputting outcomes could be used instead of utilizing icons that spin and then stop to line up on paylines. For example, a continuous reels display, such as that described in published U.S. Patent Application No. 2003-0,220,134 A1 entitled “Apparatus Having Movable Display and Methods for Operating Same”, filed on May 23, 2003, and which is assigned to the assignee of the present application and is incorporated in its entirety herein, could be used. As described in detail in that publication, a slot machine includes mechanically spinning reels that each comprise one or more display devices for electronically or optically displaying symbols, which enables many of the advantages of both mechanical reel slot machines and video slot machines to be combined into a single device. For example, the mechanically spinning reels and the finite number of surface locations for displaying indicia along the reels may alleviate player suspicions that outcomes are being generated in a biased fashion. Also, the display devices allow the slot machine to change the indicia displayed on the reels without the need for mechanical replacement of components. Therefore, a single mechanical reel comprising one or more display devices is operable to display a very large number of indicia relative to what a conventional mechanical reel with a reel strip is capable of displaying. Furthermore, multiple different games may be played on the same mechanical reel slot machine. The slot machine may switch games by changing one or more of the indicia displayed on the reels. The display devices may also allow for the inclusion of supplementary information for the player's viewing. For example, the display devices of a reel may display pay tables, instructions on how to use the slot machine, explanations of outcomes, and marketing offers. In one embodiment, the reels of a slot machine are fitted with display devices on the outer surface of the rim of the reel. Display memories may be fitted, for example, on the inner surface of the rim. The display memories may store graphical information about multiple different indicia. In one embodiment, each of the display memories may be respectively in communication with a corresponding display device. For example, upon an instruction from a processor of the slot machine, the display memories may transmit data representing one or more indicia to the display devices, causing the display devices to change the symbols currently being displayed.

Referring again to FIG. 1A, the slot machine 10 further comprises a handle 16, which may be used by a player when pulled to initiate the movement of the reels in display area 12 to generate a game outcome. Alternatively, a player may initiate the movement of the reels in display area 12 by actuating the “START” button 18. When a player utilizes the GD in a regular mode of operation, he may place a bet by using the “BET 3 COINS; MAX BET” button 21, or the “BET 2 COINS” button 23, or the “BET 1 COIN” button 25” before utilizing the handle 16 or START button 18 to initiate play (In some embodiments, the GD may include additional and/or alternate types of buttons, for example, an “INCREASE BET” button and/or a “DECREASE BET” button operable to either increase or reduce the size of the bet). Any or all of handle 16, START button 18, BET 3 COINS; MAX BET button 21, BET 2 COINS button 23, and the BET 1 COIN button 25 are exemplary embodiments of an input device of the GD. The player may also use a Cash Out button 27 during game play to obtain a cashout ticket (not shown) that includes an indication of his remaining credit balance.

In this exemplary implementation, the slot machine 10 also comprises a player tracking device 20 that includes a player tracking card reader and a display (e.g., an LED display) for outputting information related to the player identifier (e.g., player's name and number of comp points associated with that player's account). In this example, the display of the player tracking device 20 reads “welcome”. The card reader of the player tracking device 20 may be configured to read, for example, a magnetic stripe found on the reverse side of a player gaming card provided by a casino, and to write information thereto. In some embodiments, the player tracking device 20 may be configured to communicate with a smart card or other types of cards that may include storage means for storing player data and the like.

The display area 22 may be used to display different types of information and/or graphics to a player. For example, as will be explained in more detail below, display area 22 may comprise a touch screen that could be used, for example, to provide option buttons that may be selected by a player with regard to one or more “Play It Off” agreements. For example, in FIG. 1A the display area 22 recites “Warning: Appropriation Mode Enabled” to ensure that the player realizes that a portion of his winning outcomes is subject to appropriation according to an agreement. The display area 22 may also be used to display an offer to a player for a benefit, such as the opportunity to obtain a 20% discount on her hotel room rate if she agrees to allow the casino to appropriate 1 credit for every 10 credit or greater jackpot on the “Lucky Lady” GD (which is different than the GD that the player is currently playing) for the duration of a 5 hour gaming session. The player may also be required to agree to play that GD within 48 hours of the making the “Play It Off” agreement in order to satisfy the gaming terms, or else the player's credit card will be charged for a predetermined amount. The display area 22 may also be used to convey other information to the player, such as a map and/or directions to the exact location of the “Lucky Lady” GD.

A payment system 30 includes a bill acceptor and credit card reader 34, and a coin acceptor 36. Other payment systems, such as ticket or coupon acceptors, and/or a smart card reader, could also be utilized. A player utilizes the payment system 30 to provide payment to obtain wagering credits so that the player may make a wager for playing a game.

The slot machine 10 further comprises a credit meter balance 35 that reflects the amount of electronic credits currently available to a player (as shown in FIG. 1A, the player has 156 credits available). In some embodiments, the GD also includes a debt meter balance 37 that reflects the amount of credits owed to the casino according to the agreement made by the player for the benefit. In this example, the debt meter balance shows 12 credits, which is the amount owed by the player. In some embodiments, the debt meter balance is revised downward (until it reaches zero) as the player achieves winning outcomes and a portion of some (or all) of the winning outcomes is applied to the debt. The player may use the electronic credits shown in the credit meter balance 35 to place wagers or bets for games played on the gaming device, and in some embodiments, electronic credits may be “cashed out” as coins, bills, tokens, a cashless gaming receipt, and/or value transferred to another financial account associated with the player. In addition, the player may use the electronic credits shown by the debt meter 37 as a reminder of the balance remaining on her obligation to the casino, and this number may be thought of as a goal to reach in order to pay off the debt owed that is associated with a value of the benefit received by the player. It should be understood that the debt meter may be implemented as a physical meter (electro-mechanical, analog or digital), or may be contained within a software program. It should also be understood that the debt meter may be a stand-alone display, or may be displayed in a portion of a larger video display screen. The debt meter may also only be visible as a “pop-up” screen that only appears within a display area when credits are being added to or subtracted from a balance, and/or may appear upon player request, and/or may appear upon cashout, and/or may be selectively output upon the occurrence of one or more triggering events.

In this example, the slot machine 10 includes another display area 40, which displays a regular mode payout schedule (i.e., the payouts associated with various winning combinations when no credits are being appropriated) for the slot machine 10. The payout schedule indicates the payouts that correspond to various outcomes obtainable during the regular mode of operation of the slot machine 10. In one or more embodiments wherein the player has made a “Play It Off” agreement, the display area 40 may show different payouts for winning combinations that correspond to the appropriation scheme agreed to by the player when she obtained a benefit. In some embodiments, under an appropriation mode of play, the display area 40 always displays the regular mode winning outcomes, but the credit meter balance 35 is increased by an amount of electronic credits that is equal to the amount shown in the display area 40 minus the portion appropriated according to the appropriation scheme agreed to by the player. In addition, the credit balance on the debt meter 37 may be reduced by the same amount. In such cases, the player may be reminded on another display screen, such as display 22, that she is in appropriation mode play and the amounts appropriated may also be shown so that she understands how many credits have been taken. In some embodiments, an alternate payout schedule, such as a bonus-round payout schedule (not shown) or an altered paytable schedule (not shown) may also be displayed in the display area 40 or elsewhere, and may be dynamically generated based on the “Play It Off” agreement associated with the player. It should be understood that GDs currently being used in casinos may be capable of providing an indication of the payouts available to a player who is engaging in appropriation mode wagering game play under a “Play It Off” agreement.

Finally, the slot machine 10 comprises a coin tray 50 into which payment to the player may be rendered by dispensing coins. Such coins may be dispensed based on, for example, a player's indication that the player would like to cash out his credit meter balance and/or after a winning outcome obtained by a player as a result of playing a game on the slot machine 10.

It should be understood that, in some embodiments, an existing GD that does not include any specialized components may be used in association with a “Play It Off” agreement. In particular, a separate debt meter is not required because in some embodiments the appropriated amount of a player's winnings may be taken from a final credit balance. For example, if the player made a “Play It Off” agreement to have $20.00 appropriated from his winnings at a “Lucky Red Dog” GD and plays the GD for six hours and wins $40.00, then when he presses the cash out button 11 on the GD to cash out his credits an appropriate amount of credits (having a $20.00 value) is deducted from the total, and this smaller total amount is printed on his cashout ticket. The cashout ticket may also include information concerning the terms and conditions of his “Play It Off” agreement, such as the amount the player agreed to have appropriated, data concerning his current game play (i.e., duration and winnings), and the amount of credits deducted in the gaming session. If the player satisfied all his gaming requirements and paid back the full amount owed, the cashout ticket may also include a congratulatory statement and/or another offer to obtain a benefit that may also be “played off”.

FIG. 1B is a block diagram 60 of an embodiment of a GD or player terminal which may be similar to that of FIG. 1A. The GD 60 may be implemented as a system controller, a dedicated hardware circuit, an appropriately programmed general-purpose computer, or any other equivalent electronic, mechanical or electro-mechanical device. The GD 60 may comprise a game of skill or a game of chance, for example, a reeled slot machine (whether mechanical or video), a video poker terminal, a video blackjack terminal, a video keno terminal, a video lottery terminal, a pachinko machine, or any apparatus that provides an electronic version of any tabletop game. In various embodiments, a GD may comprise, for example, a personal computer (e.g., which communicates with an online casino Web site), a cell phone or telephone (e.g., to communicate with an automated sports book that provides gaming services), a dedicated or non-dedicated portable handheld wagering game device (e.g., a personal digital assistant (PDA), a wireless intra-property handheld wagering device, a Nintendo GameBoy™, or SONY brand PSP™), a skill crane, a skee-ball machine, and/or hardware positioned adjacent to or in association with a table game (for example, blackjack, wheel of fortune, craps, roulette, baccarat). Consequently, in some embodiments a user device such as a PDA may be used in place of, or in addition to, some or all of the GD 60 components depicted in FIG. 1B.

The GD 60 of FIG. 1B includes a processor 62, such as one or more Intel® Pentium® processors, or similar processors manufactured by other companies such as Advanced Micro Devices, Incorporated. The processor 62 is in communication with a memory 80 and a communication port 64 (e.g., for communicating with one or more other devices, such as with a peripheral device). The memory 80 may comprise an appropriate combination of magnetic, optical and/or semiconductor memory, and may include, for example, Random Access Memory (RAM), Read-Only Memory (ROM), a compact disc and/or a hard disk. The memory 80 may comprise or include any type of computer-readable medium. The processor 62 and the memory 80 may each be, for example: (i) located entirely within a single computer or other device; or (ii) connected to each other by a remote communication medium, such as a serial port cable, telephone line or radio frequency transceiver. In one embodiment, the GD 60 may comprise one or more devices that are connected to a remote server computer, such as a GS, which may be a casino server, for maintaining databases or data in another memory scheme.

It should be understood that any and all databases discussed herein may be stored in at least one of a tabular form, in an object-oriented format, in an XML format, and in a relational database format. Appropriate database formats for use with the disclosed apparatus, systems and methods are known, and need not be described in detail herein.

The memory 80 stores a program 82 for controlling the processor 62. The processor 62 performs instructions of the program 82, and thereby operates in accordance with embodiments of the present invention, and particularly in accordance with the methods described in detail herein. For example, in some embodiments, the program 82 also includes instructions operable to provide an offer to a player to obtain at least one benefit if the player agrees to permit a casino, for example, to appropriate a share of the player's future winnings during her wagering game play. The program 82, as well as any other program for controlling a processor described herein, may be stored in a compressed, uncompiled and/or encrypted format. The program 82 furthermore includes program elements that may be necessary, such as an operating system, a database management system and “device drivers” for allowing the processor 62 to interface with one or more computer peripheral devices. Appropriate program elements are known to those skilled in the art, and need not be described in detail herein.

According to an embodiment, the instructions of the program 82 may be read into a main memory from another computer-readable medium, such from a ROM to RAM. Execution of sequences of the instructions in program 82 may cause processor 62 to perform one or more process steps described herein. In alternate embodiments, hard-wired circuitry may be used in place of, or in combination with, software instructions for implementation of some or all of the processes of the present invention. Thus, embodiments described herein are not limited to any specific combination of hardware and software.

The memory 80 may also store one or more databases 84, or portions thereof. For example, the database 84 of memory 80 may include one or more probability databases, one or more payout databases, and one or more “Pay It Off” agreement databases. Thus, the memory 80 of the GD 60 may be configured to provide at least some of the data required for a player to play a game of chance, and/or data to enable the GD to offer a benefit, such as a gaming feature, to a player if he agrees to the terms and conditions of a “Pay It Off” agreement. The GD may then obtain any other required software, data, and/or instructions from one or more other devices.

As mentioned above, in some embodiments the memory 80 includes a “Play It Off” agreement database for storing data such as terms, conditions, appropriation schemes, percentages of players that accept such terms, and the like data associated with “Play It Off” agreements. Such “Play It Off” data may be analyzed, for example, to spot trends and/or to make improvements. For example, data concerning one or more players may be analyzed to determine whether changes should be made with regard to the manner in which offers for benefits are made, and/or to determine if modifications should be made to some or all of the terms and/or conditions contained in “Play It Off” agreements. One or more trends may be discovered, for example, the appropriation data may suggest that a higher percentage of players prefer to have a portion of winning outcomes appropriated when the winning outcomes are below a certain dollar amount, and prefer to keep the entire payout for larger winning outcomes (i.e., keep all of the money when the player hits a large jackpot). An indication of such a trend may be generated so that, for example, casino personnel can identify and modify one or more terms of existing “Play It Off” agreements so that a higher percentage of players will accept agreements to obtain benefits in exchange for playing a wagering game and having a share of winning outcomes appropriated. In addition, in some embodiments, regulators and/or casino personnel, for example, may be able to access the appropriation data and use it for various purposes, such as checking to ensure that the agreements being offered to players are fair, and that the methods used to appropriate a share, or a percentage, or a portion of winning outcomes are implemented in a manner that is consistent and that is fair to all players.

As mentioned above, in some embodiments the memory 80 includes a probability database that may specify, for example: (i) a random number (or range of random numbers) that may be generated by a random number generator; and (ii) an outcome that indicates the one or more indicia comprising the outcome that corresponds to the random number of a particular record. A GD 60 may utilize a probability database to determine, for example, what outcome corresponds to a random number generated by a random number generator and to display the determined outcome. For example, the outcomes may comprise the three symbols to be displayed along the payline of a three-reel slot machine. Other arrangements of probability databases are possible. For example, the book “Winning At Slot Machines” by Jim Regan (Carol Publishing Group Edition, 1997) illustrates examples of payout and probability tables and how they may be derived. The entirety of this book is incorporated by reference herein for all purposes.

The memory 80 may also include a payout database that includes fields that specify, for example: (i) an outcome, which indicates the one or more indicia comprising a given outcome; and (ii) a payout that corresponds to each respective outcome. If GD 60 comprises an electronic version of a three-reel slot machine, for example, the outcomes may mirror those obtained on a three-reel slot machine so that, after determining the outcome for displaying on the GD display, the GD may access a payout database to determine whether that outcome is one of the outcomes stored as corresponding to a payout. If it is, the GD may provide the corresponding payout to the player via a benefit output device described herein. Other arrangements of payout databases are possible. For example, the book “Winning At Slot Machines” by Jim Regan (Carol Publishing Group Edition, 19264), previously incorporated by reference, illustrates many examples of payout and probability tables and how they may be derived. In some embodiments, a benefits payout database may be used to specify, for example: (i) one or more outcomes that includes a definition of which indicia comprise any/each of the predetermined outcomes; and (ii) a decreased payout or prize award that corresponds to each respective outcome during, for example, wagering game play under an agreement to appropriate a portion of certain winning outcomes.

The processor 62 is also operable to communicate with a random number generator 66, which may be a component of the GD 60 in some configurations or of a GS in some embodiments. The random number generator 66 (as well as any other random number generator described herein), in accordance with at least one embodiment, may generate data representing random or pseudo-random values (referred to as “random numbers” herein). The random number generator may generate a random number every predetermined unit of time (e.g., every second) or in response to an initiation of a game on the gaming device. The generated random numbers may be used as they are generated and/or stored for future use.

A random number generator, as used herein, may be embodied as a processor separate from but working in cooperation with processor 62. Alternatively, a random number generator may be embodied as an algorithm, program component, or software stored in the memory of a GD or on another device, such as on a GS, and used to generate a random number. Alternately, a GD owner or operator may obtain sets of random numbers that have been generated by another entity using known methods.

The processor 62 is also operable to communicate with an awards output device 68, which may be a component of GD 60. The awards output device 68 may comprise one or more devices for outputting an award to a player of the gaming device 60. For example, in one embodiment the GD 60 may provide coins and/or tokens and/or chips as an award. The GD 60 may also or alternately provide a receipt or other document on which there is printed an indication of an award and/or a benefit, such as a cashless gaming receipt that has printed thereon a monetary value redeemable for cash and/or a benefit offer having a cash value, or having no monetary value but good for obtaining a benefit such as a free wagering game play. In such an embodiment the awards output device 68 may comprise a printing and document dispensing mechanism, to provide, for example, a ticket, coupon, a rebate form, and/or a cashless gaming voucher. In yet another example, the GD 60 may provide electronic credits that may be subsequently converted to coins and/or tokens. In yet another example, the GD 60 may credit a monetary amount to a financial account associated with a player, such as a credit card account, a debit account, a charge account, a checking account, and/or a casino account. In such an embodiment, the awards output device 68 may include a credit meter balance and a debt meter balance and/or a processor that manages the amount of electronic credits indicated on a display of both a credit meter balance and a debt meter balance. In such an embodiment the awards output device 68 may comprise a device for communicating with a server on which the financial account is maintained. In some embodiments, the awards output device 68 may output a coupon or voucher or a ticket that may be used to obtain a benefit, such as a discount on a product or service, or additional game play.

In one or more embodiments, the GD 60 may include more than one awards output device 68 even though only one awards output device is illustrated in FIG. 1B. For example, GD 60 may include both a hopper and hopper controller combination and a credit meter balance and a debt meter balance (See FIG. 1A). Such a GD may be operable to provide more than one type of payment or award to a player.

The processor 62 is also operable to communicate with a display device 70, which may be a component of GD 60. The display device 70 may comprise, for example, one or more display screens or areas for outputting information related to game play on the GD or to an offer for benefits. For example, a cathode ray tube (CRT) monitor, liquid crystal display (LCD) screen, or light emitting diode (LED) screen may be used. In addition, the GD 60 may include more than one display device 70, for example, an LCD display for displaying electronic reels and a viewing window behind which are located mechanical reels so that the player can view rotation of the mechanical reels during game play. The display device 70 may also be operable to display one or more messages to a player, for example, an indication that the player is playing the GD in a regular mode or under the terms of an agreement made prior to game play. If a portion of the player's winning outcomes are being appropriated during game play, then an indication of such operation may be provided to the player at all times during game play on the GD, or only after winning outcomes occur, or only upon initiation of game play on the GD.

The processor 62 may also be in communication with one or more other devices besides the display device 70, for outputting information (e.g., to a player or another device). Such other one or more output devices may also be components of GD 60. Such other one or more output devices may include, for example, an audio speaker (e.g., to output a message to a player, in addition to or in lieu of such a message being output via a display device 70), an infra-red transmitter, a radio transmitter, an electric motor, a printer, a coupon or product dispenser, an infra-red port (e.g., for communicating with a second gaming device or a portable device of a player), a Braille computer monitor, and/or a coin or bill dispenser. Examples of common GD output devices include a cathode ray tube (CRT) monitor on a video poker machine, a bell on a gaming device (e.g., rings when a player wins), an LED display of a player's credit balance, an LED display of a player's debt balance, and an LCD display of a personal digital assistant (PDA) for displaying keno numbers.

The processor 62 is also in communication with an input device 72, which is a device that is capable of receiving an input (e.g., from a player or another device) and which may be a component of GD 60. An input device may communicate with or be part of another device (e.g. a server, another GD, etc.). Some examples of input devices include: a bar-code scanner, a magnetic stripe reader, a computer keyboard or keypad, a computer mouse, a button (e.g., mechanical, electromechanical, or “soft”, as in a portion of a touch-screen), a switch (e.g. a two position toggle switch that may be used to switch between, for example, different game types or modes of operation), a handle, a keypad, a touch-screen, a microphone and associated voice recognition unit (which may include voice recognition software), an infrared sensor, a voice recognition module, a biometric input device (i.e. a fingerprint or retinal scanner), a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port (e.g., for receiving communications from a second gaming device or a another device such as a smart card or PDA of a player), a weight or pressure sensor (such as a weight scale), a motion sensor, and a global positioning system card, chip or sensor. Common GD input devices include a button or touch screen on an electronic video poker machine, a lever or handle connected to the GD, a magnetic stripe reader to read a player tracking card inserted into an GD, a touch screen for input of player selections during game play, and a coin and bill acceptor (see e.g., FIG. 1A). Input device 72 may comprise any of the above-described input devices or any combination thereof (i.e., input device 72 may comprise more than one input device).

The input device 72 may include an apparatus for determining a “Pay It Off” agreement so that an offer for a benefit can be made to a player, and the processor 62 may then provide an offer to obtain the benefit. Such an apparatus may include, for example, a counter that monitors, tracks and/or counts the number of non-winning outcomes generated by the GD and then outputs a signal when the number of non-winning outcomes exceeds a predetermined threshold number. In some embodiments, an apparatus is provided that is operable to determine if the player is feeling frustrated, and configured to provide an output signal to the processor as an input for determining a trigger condition that may be used to identify the player and/or to offer a benefit to the player. For example, the device may include a play activator coupled to the processor, and a sensor coupled to the play activator and the processor, wherein the sensor is operable to generate a signal indicative of an amount of force that the player exerts on the play activator, and wherein the processor is operable to receive the signal and determine if the amount of force exceeds a predefined threshold amount of force. In some embodiments, the input device 72 may be configured to communicate with a peripheral device, a smart card, a USB key device, a personal digital assistant, a handheld device, and a casino personnel device, and may be configured to permit access to the database 84 to obtain data.

In some embodiments, a GD 60 may comprise components capable of facilitating both input and output functions (i.e., input/output devices). For example, a touch-sensitive display screen is an input/output device (e.g., the device outputs graphics and receives selections from players). In another example, a processor may communicate with a “ticket-in/ticket-out” device configured to dispense and receive cash-out tickets. Such a device may also assist in (e.g., provide data so as to facilitate) various accounting functions (e.g., ticket validation and redemption).

Of course, as would be understood by one of ordinary skill in the art, a GD 60 may comprise various combinations of any or all of the component devices described herein. For example, in one or more embodiments, the GD may include more than one display device, one or more other output devices, several input devices, and so on (e.g., two display screens, two audio speakers, a headset, a ticket-in/ticket-out device and several buttons).

The processor 62 is also in communication with a payment system 76, which may be a component of the GD 60. The payment system 76 is a device capable of accepting payment from a player (e.g., a bet or initiation of a balance) and/or providing payment to a player (e.g., a payout). Payment is not limited to currency, but may also include other types of consideration, including products, services, comp points, and alternate currencies. Payment system 76 may be considered to be an example of an input device 72 in some embodiments.

Exemplary methods of accepting payment by the payment system 76 include (i) receiving hard currency (i.e., coins or bills), and accordingly the payment system 76 may comprise a coin or bill acceptor; (ii) receiving an alternate currency (e.g., a paper cashless gaming voucher, a cashout ticket, a coupon, a non-negotiable token), and accordingly the payment system 76 may comprise a bar code reader or other sensing and/or reading means; (iii) receiving a payment identifier (e.g., a credit card number, a debit card number, a player tracking card number or other account identifier) and debiting the account identified by the payment identifier; and (iv) determining that a player has performed a value-added activity.

Processor 62 may also be in communication with a player tracking device 78, which may be a component of GD 60. Player tracking device 78 may, in some embodiments, be considered an example of an input device 72. Player tracking device 78 may, in one or more embodiments, comprise a reader device operable to read information from and/or write information to a card such as a smart card and/or a player tracking card, such that (i) players may be identified, and (ii) various data associated with players may then be determined. For example, previous wagering, coin-in and/or cash-out behaviors previously engaged in by the player, the number of promotional credits available to that player, the number and types of “Pay It Off” offers and/or agreement terms that are available for presenting to the player, and the number and types of agreements entered into by the player, may be determined and/or accessed based on information associated with the player identifier.

In one embodiment, the player tracking device 78 may comprise (i) a card reader (e.g., a port into which player tracking cards may be inserted), (ii) various input devices (e.g., a keypad, a touch-screen), (iii) various output devices (e.g., a small, full-color display screen), and/or (iv) combinations thereof (e.g., a touch-sensitive display screen that accommodates both input and output functions). Various commercially available devices may be suitable for such an application, such as the NextGen™ interactive player tracking panel manufactured by IGT or the iVIEW display screen manufactured by Bally® Gaming and Systems.

Smart cards may incorporate (i) a memory, and (ii) means for accessing such a memory. For example, in an embodiment, the memory may store data related to aspects of the present invention. Data may be written to the smart card during game play, and various data may be updated on a continuous, or periodic, or event-triggered basis. Accordingly, in one or more embodiments one or more devices operable to carry out various processes of the present invention may have associated therewith a smart card reader device, such that data may be read from the smart card or loaded onto the smart card pursuant to the execution of such processes.

In one embodiment, GD 60 may be operable to facilitate downloadable games such that games available for play on GD 60 may be stored on a server device and downloaded to the GD 60. In one embodiment, software components of the GD 60 may be remotely accessed, modified and/or updated by another device. For example, payout or probability tables for the regular mode of game play, and for game play occurring under one or more player agreements, may be stored in the memory of the GD 60, and may be accessed, altered, modified or updated remotely. In addition, hot fixes may be applied to software stored by the GD 60 and/or new versions of software may be downloaded to the GD 60. Similarly, the GD 60 may be programmed to retrieve any or all such updates from another device, as appropriate. Any of the above (e.g., accessing stored data, downloading of a game, updating of software, modification of a payout table or probability table) may occur, for example, based upon an occurrence of an event (e.g., a scheduled event, or a trigger event), and/or based on an indication being received from casino personnel or other personnel (e.g., a regulator). In an embodiment, GD 60 may be a thin client device that is controlled by one or more other devices.

In one or more embodiments, various aspects of the present invention may be practiced by replacing and/or augmenting one or more components (e.g., hardware and/or software components) of an existing GD. Thus, in one or more embodiments, the invention may be applied as a retrofit or upgrade to existing GDs currently available for play within various casinos.

In a specific example, a GD may comprise various electronic components mounted to one or more printed circuit boards (PCBs). Such components may include various hardware as described herein, such as a communications port and various controllers associated with peripheral devices (e.g., a display controller), as well as a memory for storing programming instructions (software) and a processor for carrying out such instructions. One form of memory commonly found in GDs is electronically erasable programmable read-only memory or erasable programmable read-only memory (EEPROM or EPROM). Thus, in one or more embodiments, an EEPROM storing software with instructions for carrying out aspects of the present invention (as well as instructions for carrying out other functions traditionally performed by the GD) may replace or augment an EEPROM previously installed in a GD, such that the gaming device may be configured to operate in accordance with various processes described herein.

For example, a separate display device or LED meter, such as a debt meter, may be used during wagering game play of a GD to display the amount of credits that a player still owes under the terms of an agreement that he made to obtain a benefit. Such a display device may be made available for purchase to various casino operators. Such components which may comprise various hardware and software (e.g., an EEPROM storing software instructions), may be installed in and/or retrofit to an existing device such as a GD (e.g., a video-reel slot machine, a video poker machine, etc.). In some embodiments, when the separate display device and/or LED debt meter is installed (and/or retrofitted), then “Pay It Off” offers may be presented to a player at that GD that may be based on the various gaming outcomes generated by that player, and/or each of the terms and/or requirements specified in the “Pay It Off” agreements may be tracked and/or stored. In an embodiment, the player may be required to input payment of a nominal fee in order to receive a “Pay It Off” offer.

In some embodiments, rather than configure existing GDs to execute embodiments described herein by installing or connecting new hardware and/or software, software may be downloaded into an existing memory of one or more GDs. U.S. Pat. No. 6,805,634 to Wells et al. teaches methods for downloading data to gaming devices in such a manner. The entirety of U.S. Pat. No. 6,805,634 is incorporated by reference herein for all purposes. Thus, in some embodiments, an existing GD may be reprogrammed to accommodate new functionality of the present invention without the need, or by minimizing the need, to remove and replace hardware within the GD.

### 2. Electronic Game Server (GS) Components

It has been recognized that organizations, such as casinos, who have or are planning large-scale deployments of networked GDs may implement the idea of a single logical Electronic Game Server (GS) that transmits gaming computations and instructions by utilizing multiple physical Electronic Game Servers. In addition, a multi-layer architecture (such as Model-View-Controller) may be used that may result in more than one logical grouping of functions in the GS implementation. In such implementations, a single request for game play from a GD of a plurality of GDs can be satisfied by a large number of possible combinations of physical devices. A “gaming request” is a solicitation by a GD for data that will be used to formulate at least a portion of a gaming outcome, and such requests may be made substantially simultaneously by a plurality of GDs in a thin client system. Requested functions may be handled by a GS or other device, that may be a component of a gaming system (such as a gaming network that includes one or more casino or gaming servers and one or more GDs), and then provided to the GD. In some embodiments, the GS may also handle some or all of the functions associated with determining if players should be made an offer to receive benefits, the types of offers to make, the types of agreements to provide, the types and the number of conditions to include in agreements, and/or tracking and storing indications of appropriated amounts acquired from winning outcomes, for example, obtained by players at particular GDs, and/or tracking and storing player data associated with benefits received and/or the agreements made.

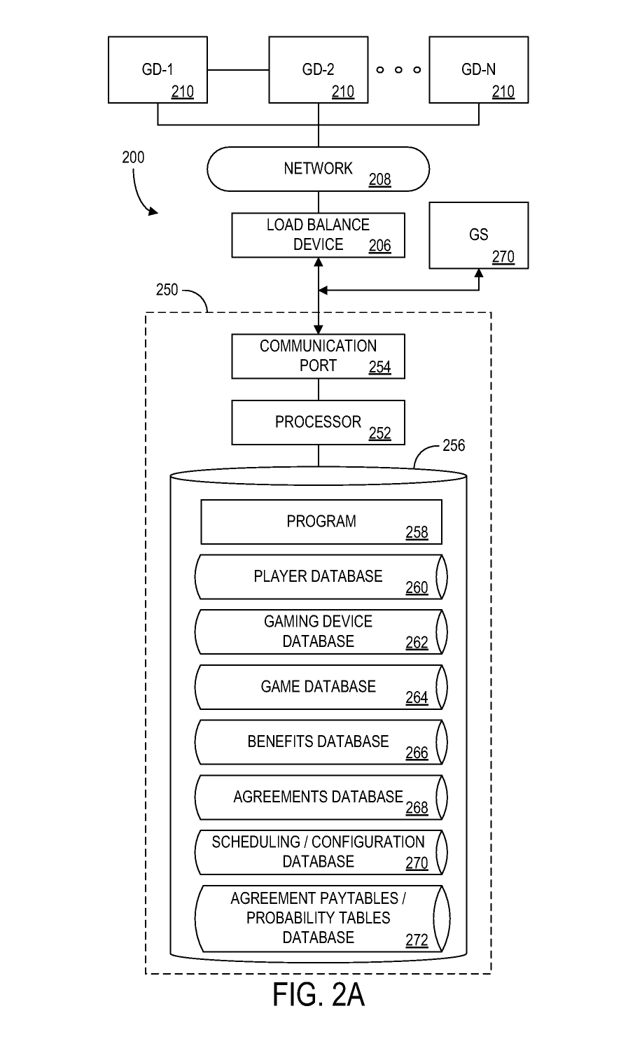

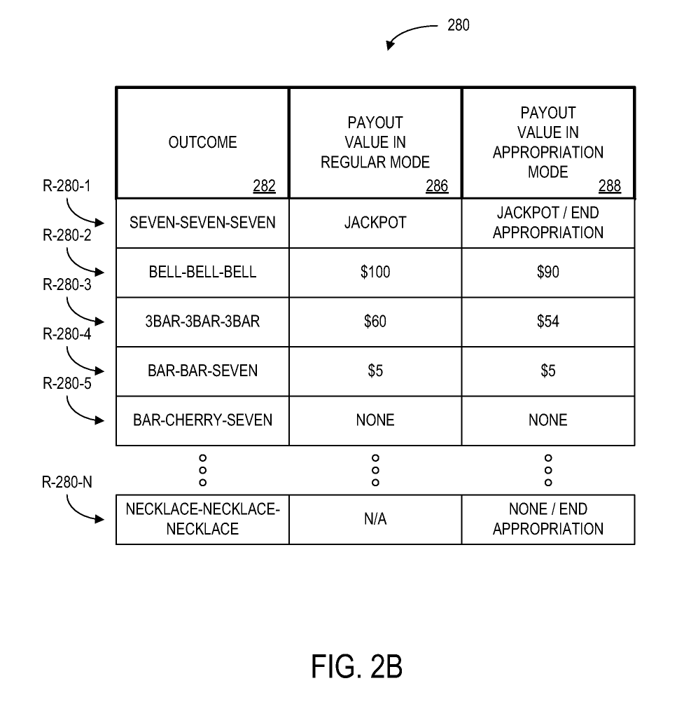

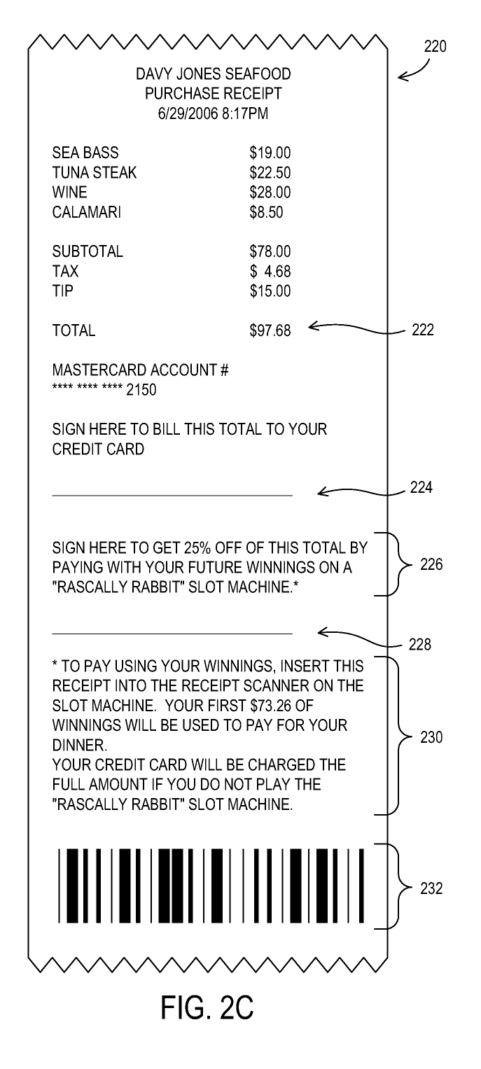

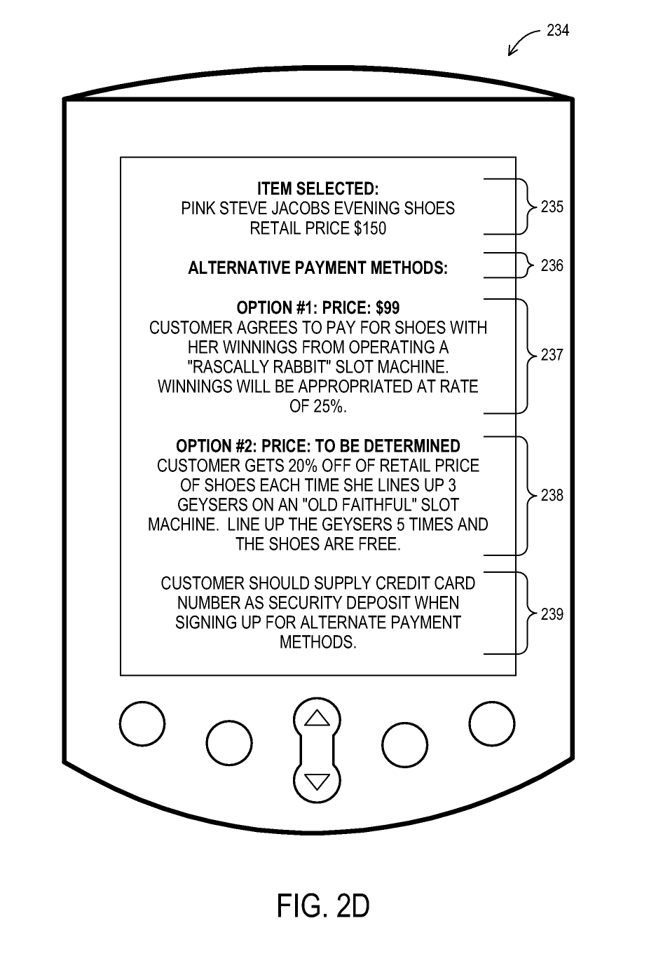

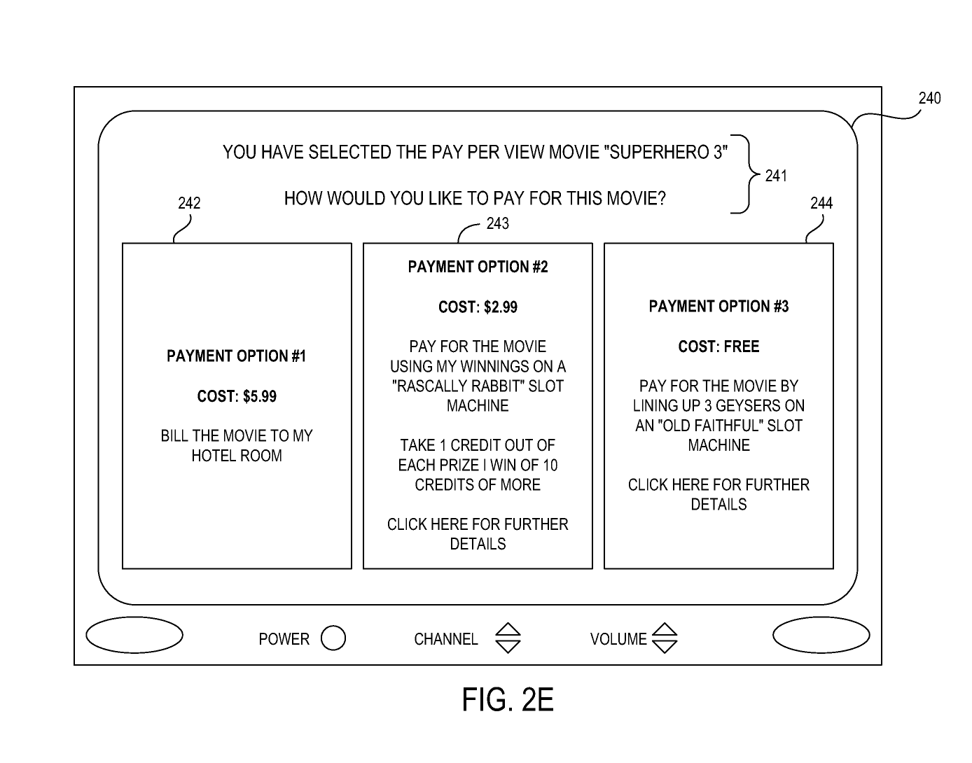

FIG. 2A illustrates an example of a system 200 that includes an embodiment of an Electronic Game Server (GS) 250 configured to communicate, through a Load Balance Device 206 and communications network 208, with a plurality of GDs 210. A second GS 270 is also shown in communication with the plurality of GDs 210 and Bonus GD212 through the Load Balance Device 206 and communications network 208. It should be understood, however, that only one GS or more than two GS's could be used, and that in some embodiments a Load Balance Device 206 is not required. Thus, the network configuration depicted in FIG. 2A is provided for illustrative purposes only. In addition, although FIG. 2A indicates that there may be any number of GDs (GD-1, GD-2 to GD-N), in any particular system configuration including the embodiment shown having two GS's, there will exist a threshold maximum number of GDs 210 that could be handled to ensure that the system functions efficiently.

The GS 250 includes a processor 252, such as one or more Intel® Pentium® processors. The processor 252 is in communication with a communication port 254 for communicating with one or more other devices, such as the Load Balance Device 206, and a memory 256. The memory 256 may comprise an appropriate combination of magnetic, optical and/or semiconductor memory, and may include, for example, Random Access Memory (RAM), Read-Only Memory (ROM), a compact disc and/or a hard disk. The processor 252 and the memory 256 may each be, for example: (i) located entirely within a single computer or other device; or (ii) connected to each other by a remote communication medium, such as an Ethernet cable, telephone line or radio frequency transceiver. In one embodiment, the GS 250 may comprise one or more devices that are connected to a separate, remote server computer or computers for maintaining databases.

The memory 256 stores a program 258 for controlling the processor 252. The processor 252 performs instructions of the program 258, and thereby operates in accordance with at least some embodiments of the present invention, and particularly in accordance with the methods described in detail herein. The program 258 may be stored in a compressed, uncompiled and/or encrypted format. The program 258 furthermore includes program elements that may be necessary, such as an operating system, a database management system and “device drivers” for allowing the processor 252 to interface with one or more peripheral devices. Appropriate program elements are known to those skilled in the art, and need not be described in detail herein. The program 258 may include computer program code that allows the GS 250 to employ the communication port 254 to communicate with one or more GDs 210.

According to an embodiment, the instructions of the program 258 may be read into a main memory from another computer-readable medium, such as from a ROM to a RAM. Execution of sequences of the instructions in program 258 may cause processor 252 to perform some or all of the process steps described herein. In alternate embodiments, hard-wired circuitry may be used in place of, or in combination with, software instructions for implementation of the processes of the present invention. Thus, embodiments of the present invention are not limited to any specific combination of hardware and software. For example, in some embodiments, a peripheral device may be provided for storing benefits data that can only be accessed by authorized personnel, such as by a regulator and/or by a designated casino employee.

In an embodiment, the GS 250 functions to provide one or more parameters for downloadable games playable on one or more GDs 210, and may also store and/or provide data and/or agreements for providing offers to players for benefits in exchange for the player agreeing to having a portion, share and/or a percentage of his future winning outcomes appropriated to pay for a value associated with the benefit. Accordingly, as shown in FIG. 2A, the memory 256 may also store: (i) a player database 260, (ii) a gaming device database 262 that stores information related to one or more gaming devices with which the controller 250 is operable to communicate, (iii) a game database 264 that stores information regarding one or more games playable on and/or downloadable to one or more gaming devices, (iv) a benefits database 266 that may contain data concerning a plurality of different types of benefits available to players, (v) an agreements database 268 that may include agreements that have been entered into by players and/or agreement terms and conditions associated with various benefits and appropriation schemes, (v) a scheduling and/or configuration database 270, and/or (vi) Agreements Paytables and/or Probability Tables database 272.

The player database 260 may include, for example, data corresponding to a player identifier, player preferences, an indication of wagers placed or number of games played by a player, an indication of duration of play by a player at the GD, agreements entered into (or data associated therewith, such as one or more debts owed by a player as a result of the player entering into one or more agreements), and the like. The benefits database 266 may include, for example, data associated with types of benefits, one or more values associated with each type of benefit, and offer terms that may be presented to players to obtain a benefit. The benefits data may include, for example, criteria that governs how and when offers are made to players for obtaining such benefits as discounted prices on products or services, or additional game play, which will be discussed in more detail below.

In some embodiments, the Agreements Database 268 includes a plurality of different agreements that are each associated with different benefit types and/or with other variables such as player preferences. The Agreements Database 268 may also include agreement data concerning player agreements that have already been entered into by one or more players. The Scheduling and/or Configuration database 270 may be useful for determining which games are available on which GD, and/or for determining when a GD should be operating in a regular mode of game play, or operating under the terms of an Agreement that the player previously agreed to honor in order to obtain a benefit that has already been provided. The Agreement Paytables and/or Probability Tables database 272 may include, for example, one or more agreement paytables and/or probability tables, and/or data concerning the paytables and/or probability tables for use when a player is operating the GD under the terms of an Agreement, which will be discussed in more detail below.

FIG. 2B illustrates an Agreement Paytable 280 for use in governing payouts in some embodiments when a GD is operating in an appropriation mode according to the terms of an agreement that the player has agreed to abide by. For example, the player may be offered a benefit of 50% off of the price of an item of jewelry at a POS terminal in a retail establishment, such as a necklace retailing for $250 dollars, if she agrees to play a “Rascally Rabbit” slot machine at the “Crystal Dodge City” casino under an appropriation scheme and for a predetermined minimum amount of time. The POS terminal may be configured to display and/or print out an agreement that, for example, specifies that she must play that type of GD and have her winning outcomes of $10 or more appropriated at a rate of 10% during her gaming sessions until a total of $100 is accumulated on (or subtracted from) a debt meter. The terms of the agreement may also include one or more gaming requirements, for example, that require the player to visit the casino and play the “Rascally Rabbit” GD within 48 hours of her purchase and wager at that GD for at least 6 hours. In addition, the agreement may specify that three “Necklace” icons will be added to the slot machine reels just for her, and if the “Necklace” icons appear together on a spin, then the appropriation mode terminates, even if there is still some amount left to go on the debt meter (i.e., the player has a chance to erase her debt completely if the “Necklace” icons appear early in her gaming session, before she has satisfied the gaming requirements of the agreement). The POS terminal may also be configured to capture the player's digital signature, for example, a touch sensitive screen and stylus may be available for the player to use to sign her name in order to signify her acknowledgement of the agreement for obtaining the benefit. Later, as will be explained in more detail below, the digital signature may be presented to the player on a display screen of a GD when she is about to play the GD, to remind the player of the existence of the agreement.

Continuing with the same example, the player agrees and obtains the benefit on a Friday evening, paying $125 dollars (50% of the retail price) for the necklace and signing an agreement to play the wagering game under the terms specified. She also consents to have an authorization for a $125 dollar charge made on her credit card, as a precaution in case she does not follow through and adhere to the terms of the agreement (For example, by failing to gamble on the “Rascally Rabbit” slot machine). In this case the player receives a paper receipt that identifies the purchase and includes a barcode identifier (or other identifier) associated with the Agreement, and she is instructed to insert that receipt into the GD when she initiates play on the “Rascally Rabbit” GD. On Saturday night (of the next day), she travels to the “Crystal Dodge City” casino, inserts the receipt into a reader device, inserts payment, and begins to play the “Rascally Rabbit” slot machine.

It should be noted that, in some embodiments, the authorization made to the player's credit card might be for a lesser amount than the value placed on the benefit by the retailer. In the example above, for example, a $100 authorization may be made instead of $125 to further entice the player to enter into the agreement for the benefit. In addition, in some embodiments, if the player begins wagering game play, but does not pay off the agreed to amount, then her credit card may only be charged for a portion of the amount owed. For example, if only a portion of the gaming requirements are satisfied and/or if only a portion of her debt is repaid then the remainder could be assigned a value and that remainder amount charged to the player's credit card.

Referring again to FIG. 2B, the Appropriation Paytable 280 is used to govern the payouts that occur during the player's wagering game play on a “Rascally Rabbit” GD under the terms of the Agreement made by the player. In this example, the paytable 280 includes three columns of data related to an Outcome 282, a Payout Value in Regular Mode 286 which lists the credits that would be applied to a credit meter for the various outcomes, and a Payout Value in Appropriation Mode 288 which lists the credits that would be applied in the appropriation mode to the credit meter. Referring to row R-280-1, when the player achieves a SEVEN-SEVEN-SEVEN outcome, as indicated the “Rascally Rabbit” GD normally pays out a jackpot regardless of whether the player is in the regular mode or in the appropriation mode (and the player also achieves an end to appropriation mode in this example). However, as shown in rows R-280-2 and R-280-3, when an outcome occurs that pays out more than $10, then 10% of that amount is appropriated under terms of the Agreement (i.e., which is not applied to the player's credit meter, and which may be applied to a debt meter to offset the portion of the benefit to be paid back, which is owed by the player). For example, if the player achieves a BELL-BELL-BELL outcome, then in regular mode she would have received a $100 payout (or addition to her credit meter), but since she is playing under the terms of the Agreement, she receives a $90 payout (which is added to her credit meter balance, while the remaining $10 is subtracted from whatever balance remains on the debt meter). In row R-280-4, the player achieves a “BAR-BAR-SEVEN” outcome, which pays out $5 in regular mode and is added to her credit meter. In this case, under the terms of the Agreement this outcome also pays out $5 in appropriation mode (since the total payout amount is less than $10, then according to the Agreement no portion is taken). For non-winning outcomes, such as that shown in row R-280-5, there is no payout in either of regular mode or appropriation mode.

As shown in row R-280-N, if at any point the reels of the GD display a “NECKLACE-NECKLACE-NECKLACE” outcome, then there is no payout under the terms of the Agreement, but the appropriation mode is terminated, and the player is absolved of her debt. Thus, the debt meter may be set to read “zero” or removed from the screen to show that the player is no longer playing in an appropriation mode, and a message may be displayed congratulating the player on her good fortune. The player may then continue to play the GD in the regular mode, which is governed by the regular mode payout values 286, and no further winning outcomes will be appropriated.

It should be understood, however, that a GD operating in appropriation mode need not utilize a different paytable from that used during regular mode operation. Instead, a program may direct a processor to appropriate a portion of a payout won using the regular mode paytable.

If the player doesn't win enough money to pay off her entire debt (i.e., in the example above, the player stopped gambling after 6 hours of play but only had enough winning outcomes to cover $75 dollars of the $125 dollar debt), then her credit card may be charged for the difference (i.e., $50 dollars). If the player doesn't gamble on the GD at all (i.e., defaults on the Agreement), then her credit card may be charged for the full amount owed under the Agreement. It should also be noted that, in some embodiments, the remainder of any remaining debt for a player may be forgiven or paid off in another manner, especially in cases where the player otherwise satisfied all the gaming requirements of the agreement, such as gambling for a predetermined minimum amount of time in the casino (examples of such circumstances will be discussed in detail below). In yet other embodiments, a player who entered into an Agreement and obtained a benefit up front, but failed to satisfy any of the gaming requirements (or only satisfied a small portion) may be subject to payment of a penalty. The penalty amount may be added to the benefit value such that the overall amount owed may be higher than the value of the benefit received by the player. In some embodiments, the penalty amount and the rules for imposing such a penalty are clearly set out in the Agreement.

With reference again to FIG. 2A, it should be understood that additional databases that store similar or different data could be included in the memory 256, and thus the particular configuration that is shown is for exemplary purposes only. In addition, some of the information stored in the various databases, such as the Agreement Paytable 280 illustrated in FIG. 2B, may also be stored in a memory associated with or physically located at one or more of the GDs. Further, one or more of the databases may contain data that is the same as, or overlaps with, data stored in another database.

Similarly, in one embodiment the GS 250 may be operable to configure one or more GDs 210 remotely, update software that may be stored on a GD and/or to download software or software components to a GD. For example, GS 250 may be operable to apply a hot fix to software stored on a GD 210, provide a modified payout and/or probability table for use on a GD that is being used by a player under an agreement, and/or transmit and/or receive data regarding agreements that have been previously entered into by a player and agreements that are available to a player (which may be based on the player ID), and/or transmit a new version of software and/or a software component to a GD 210. GS 250 may be programmed to perform any or all of the above functions based on, for example, an occurrence of an event (e.g., a scheduled event), receiving an indication from a authorized casino employee and/or other person (e.g., a regulator), and/or when receiving a request from a player.

Although the databases 260 through 272 are described as being stored in a memory of GS 250, in other embodiments some or all of these databases may be partially or wholly stored, in lieu of or in addition to being stored in a memory of GS 250, in a memory of one or more other devices. Such one or more other devices may comprise, for example, one or more peripheral devices, one or more GDs, a slot server (if different from the GS 250), another electronic gaming server (such as GS 270) or different type of application server, another device, or a combination thereof. Further, some or all of the data described as being stored in the memory 256 may be partially or wholly stored (in addition to or in lieu of being stored in the memory 256) in a memory of one or more other devices. Such one or more other devices may comprise, for example, one or more peripheral devices, one or more gaming devices, a slot server (if different from GS 250), another type of electronic gaming server or application server, another device, or a combination thereof. Thus, any or all of the devices in the system 200 may store one or more programs for executing one or more steps of the processes disclosed herein, and may maintain one or more databases that contain data that may be useful to execute one or more steps of the processes described herein.

For example, in an embodiment a particular GS such as GS 250 may be designated as a “Benefits Server” and/or an “Agreements Server” and function to obtain and store benefits and/or agreements (i.e., to generate and/or to provide offers for benefits and terms for agreements, and the like), responses, outcomes and/or other data that concern a GD 210, or a group of GDs, or an entire system of GDs. For example, an Agreements Server may be operable to provide terms for one or more agreements that accompany offers to players to receive benefits in exchange for entering into an agreement to appropriate a portion of future winnings that the player may obtain during wagering game play.

In some embodiments, one or more GS's may function to obtain and store data of GDs in disparate locations that may be owned by different entities, but that may be used by players to play wagering games according to one or more agreements. It is also contemplated that one or more servers may function to automatically analyze a portion or portions of the data gathered from the GDs, which may include benefits data and/or agreements data, concerning any particular GD or group of GDs (as described in more detail below). In addition, one or more of the GS's of a system may be a secure computer that can only be accessed by a regulator, or authorized casino personnel, or other authorized person. Accordingly, to access any of the databases of a secure GS, input of security codes, such as one or more passwords, may be required. It is also contemplated that additional security measures would be implemented, such as firewall programs to prevent unauthorized persons from viewing and/or modifying the data gathered therein. In some embodiments, a GS may be a Web Server.

Thus, in some embodiments, a system 200 for providing gaming and benefits to players may include a plurality of electronic game devices 210, wherein at least one of the GDs is configured to provide an offer or offers for benefits, and at least one of the GDs is configured to provide wagering game play according to one or more agreements. Such a network system may also include at least one server, such as the GS 250, configured to communicate with the plurality of GDs 210, and to output instructions and/or offers for benefits, and to receive agreements data and/or benefits data. The GS 250 may be configured to obtain and to store agreements data and benefits data in a benefits database 266 and an agreements database 268, wherein the benefits data may include types of benefits offers, and the agreements data may include a plurality of different types of agreements and related terms for use in providing offers for benefits. In addition, the GS may also be configured to store and/or obtain data identifying the GD that is currently operating under an agreement, data identifying the player of the GD, data concerning the amount of credits available to the player and the amount of credits remaining of the debt owed by the player to the casino, data identifying all other communicating devices associated with that GD, data corresponding to the time and date, and/or any other types of data associated with the benefit that was received, and the agreement entered into, by the player. In some embodiments, a GS includes at least one memory and is configured to automatically analyze the benefits data, agreements data, and wagering game data, and to generate output, which may be a report and/or one or more instructions for taking at least one action, based on the analysis.

In some embodiments, a player may receive an offer for a benefit at a Point-of-Sale (POS) Terminal, such as a cash register. For example, FIG. 2C illustrates an embodiment of a printed cash register receipt 220 from “Davy Jones Seafood” restaurant that indicates that a total amount 222 of $97.68 is due for a meal. The cash register receipt 220 also contains a printed offer 226 for taking 25% off the food bill if the consumer agrees to pay the remainder of the bill with anticipated future winnings on a “Rascally Rabbit” slot machine The consumer may sign his name on signature line 224 if he wishes to have his credit card charged for the full amount, or he may sign on signature line 228 if he wishes to enter into the “Play It Off” agreement. Terms, conditions and instructions 230 are also included on the receipt 220, including instructions to insert the receipt into a scanner so that the barcode 232 can be scanned so that the first $73.26 of winnings on the “Rascally Rabbit” GD will be appropriated. Thus, if the consumer signs on line 228, he can walk out of the restaurant without paying for his meal at that time. In the future, the consumer goes to the casino as a player and settles his debt by playing the GD according to his “Play It Off” agreement, and thus obtains the benefit of paying a reduced price of $73.26 (instead of the full price of $97.68) for the dinner out of his winnings.

FIG. 2D is a simplified drawing of a Personal Digital Assistant (PDA) 234 that may be utilized by a store clerk, for example, in an embodiment wherein offers for benefits may be made to consumers. In particular, the store clerk may notice that a customer is considering buying evening shoes priced at $150 and then inputs data concerning that selected item 235 into the PDA. In some embodiments, the PDA wirelessly communicates with another device, such as a POS Terminal or a central database, that is capable of transmitting product information, offer data, and the like, to the PDA. Alternately, the PDA may contain a memory that stores such information. The PDA may then be operable to display several Alternative Method Payments 236 to the clerk who may then make such offers to the consumer. Option one 237 in this example requires the customer to agree to pay for the shoes by having $99 appropriated from her winnings at the “Rascally Rabbit” GD at a rate of 25%. Option two 238 provides 20% off of the retail price of the shoes each time the player lines up 3 geysers on an “Old Faithful” GD. In addition, if she lines up the 3 geysers 5 times then the shoes are “free” (the player must understand that both options require her to insert payment and wager money at the GD, which will include losing spins, if she chooses either of these options). A reminder 239 is also displayed for the clerk to obtain the customer's credit card number as a security deposit if the customer chooses either Option one or Option two.

Players may also receive offers to obtain benefits via a personal computer with Internet access to, for example, an e-commerce website, or on a cell phone, wireless PDA, or other wireless communications device. For example, a player walking past a shoe store may receive an offer for a discount on tennis shoes if the player comes into the store, views one or more agreements concerning the appropriation of future winnings, and then agrees to play a wagering game according to certain terms and conditions. In some embodiments, the player may initiate the process by requesting a benefit and then asking if there is an agreement to play wagering games associated with that benefit that the player may consider. Any offer for the benefit may specify in an Agreement that the player must agree to play a wagering game at a GD owned by a casino, or use a website owned by the casino, for example. It is noted that the POS terminal may be owned and/or operated by a retail store that may or may not be affiliated with the casino. In such cases, the POS terminal may be configured to print out Agreements or otherwise display terms and conditions for review by players, and the cashier or other retail store employee may be trained to offer the benefits, to explain how the terms of the agreement would work, to answer questions, and to direct potential players to casino personnel, for example, if they still had concerns or questions.

In some embodiments, a casino representative presents an offer to the player. For example, the casino representative may notice that a particular player has spent a long time gambling at a GD, and possibly has just endured a losing streak. The casino representative may approach that player and, by use of a personal computer or wireless handheld device, may review and present indications of offers and terms of an agreement or agreements that the player may chose to accept.

In some embodiments, a player can make a “Play It Off” agreement by using a hotel cable TV interface. FIG. 2E is a simplified drawing of a television display 240 wherein a casino hotel guest has selected a premium television feature. In particular, a message 241 is displayed reciting that the Pay Per View movie “Superhero 3” has been chosen and offers several payment options. Payment Option one 242 is for the full price ($5.99) of the movie to be billed to the room. Payment Option two 243 is to have the guest “Play It Off” at a reduced cost ($2.99) if he agrees to have winnings on the “Rascally Rabbit” GD appropriated at the rate of 1 credit out of each prize of 10 or more credits. Payment Option three 244 is to obtain the movie for “Free” if the guest agrees to “Play It Off” by playing the “Old Faithful” GD and lining up 3 geysers on a payline. If the guest is interested in either option two or three, further details are available if the player uses his remote control to click on the boxes that contain descriptions of those options. Thus, the guest may obtain the movie for a reduce price or for “free” if he agrees to play a GD later by using the table-top cable television box and remote control provided in his hotel room. In some embodiments, the hotel may have a dedicated “Play It Off” cable television channel for displaying offers to guests for various types of benefits with terms and conditions associated with appropriating a portion of anticipated future winnings during wagering game play by the guests.

### 3. Benefits and Agreements

A. Benefit Offers

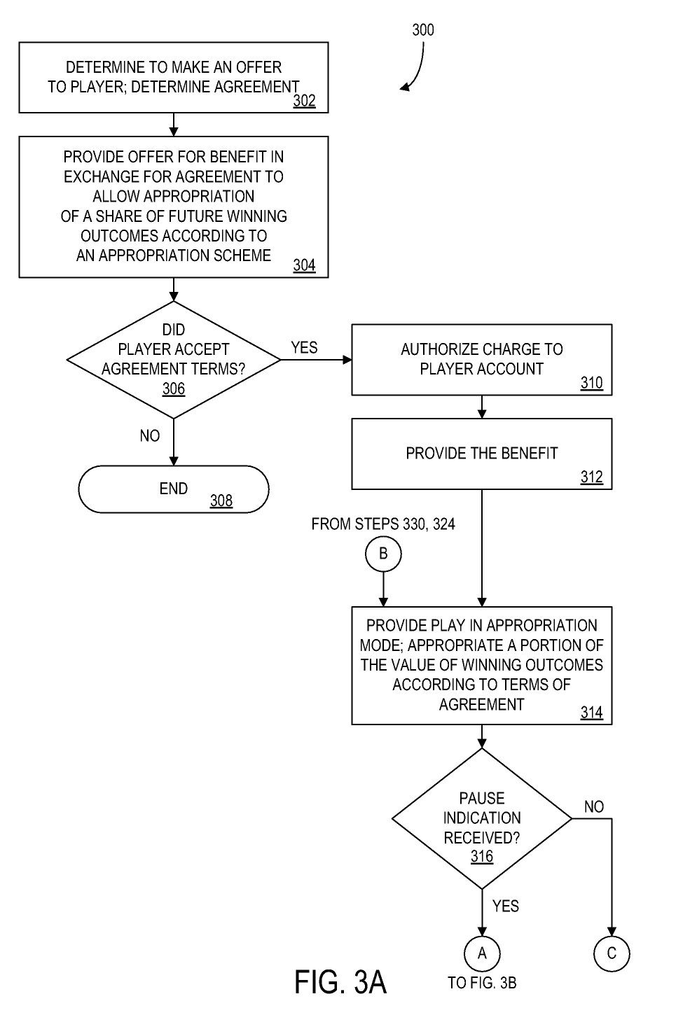

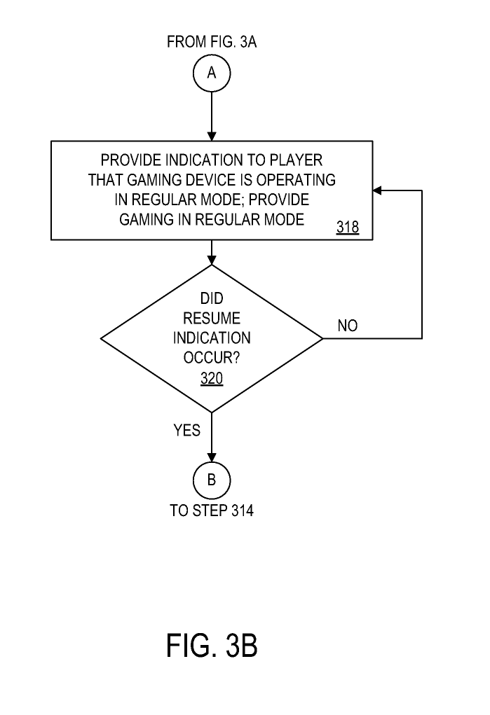

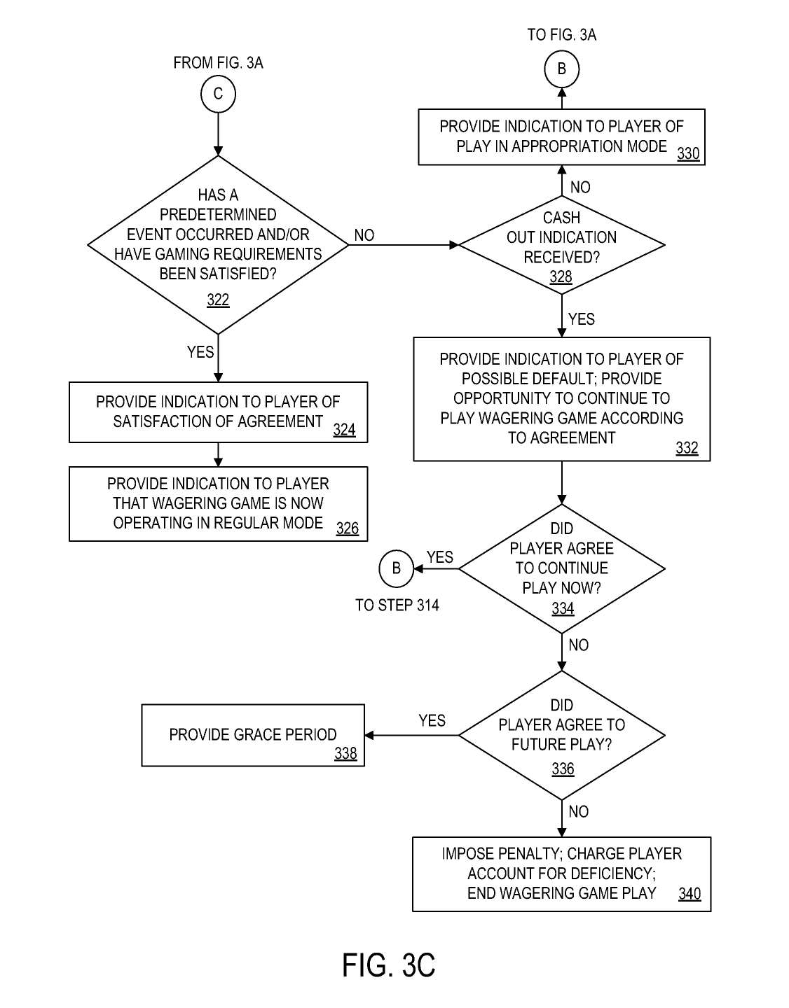

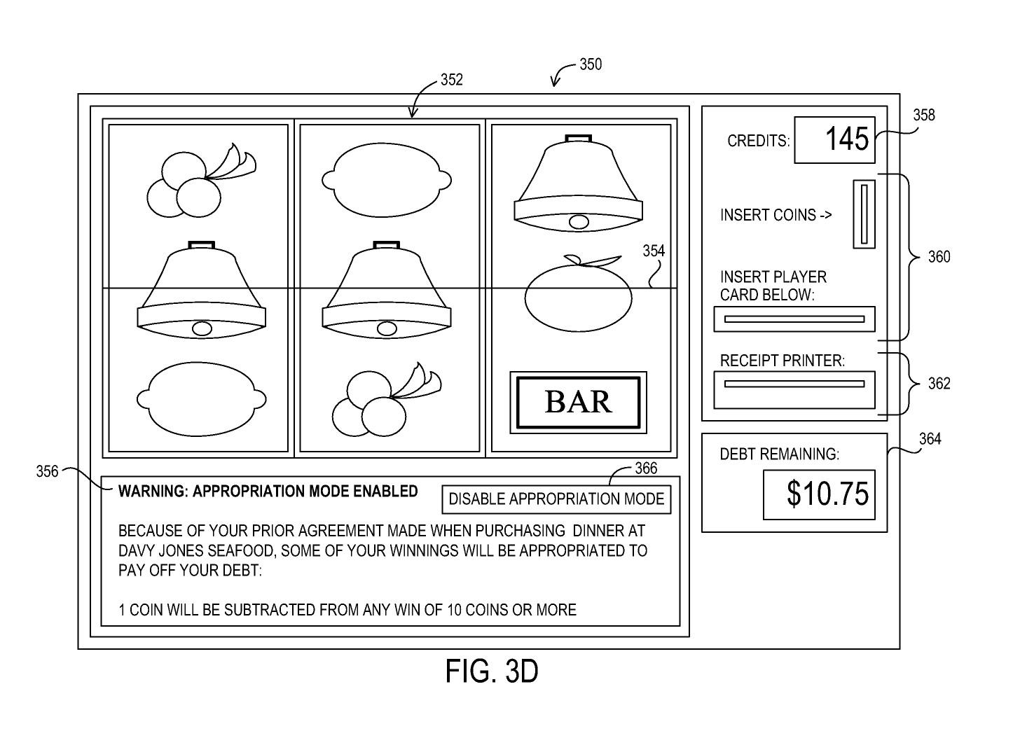

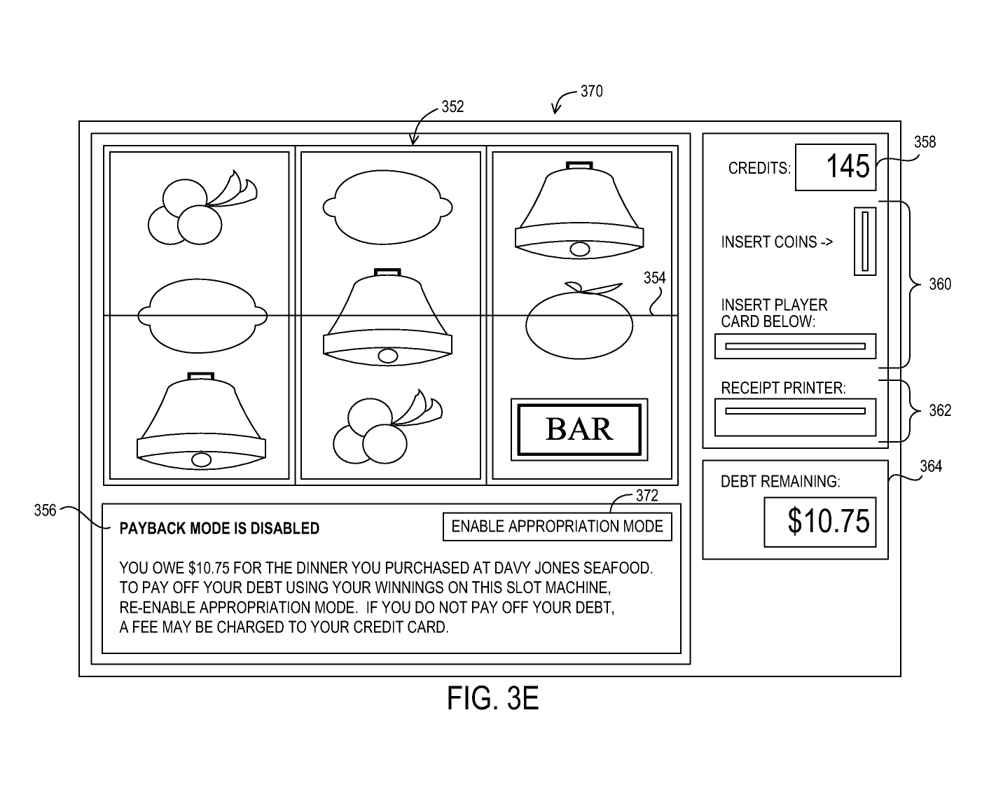

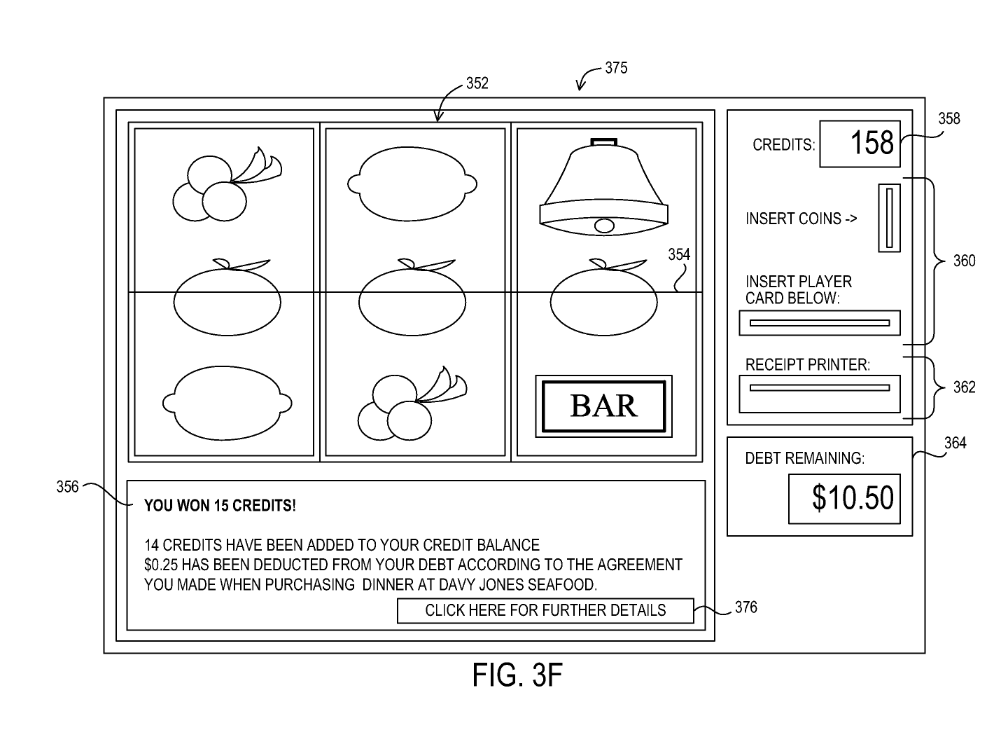

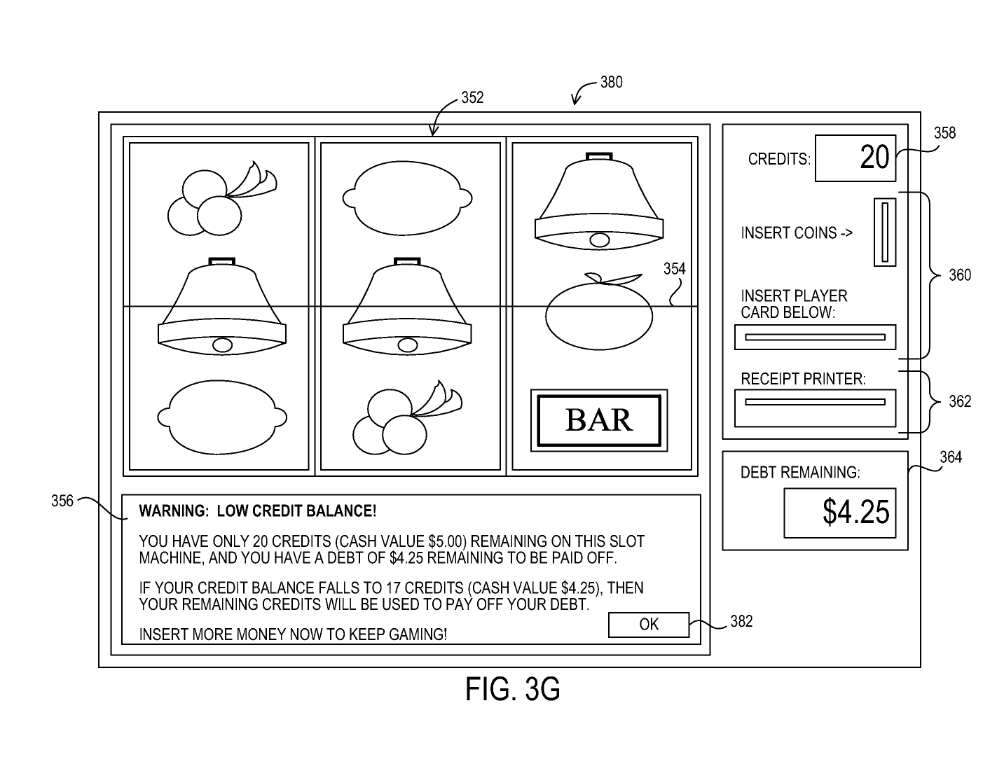

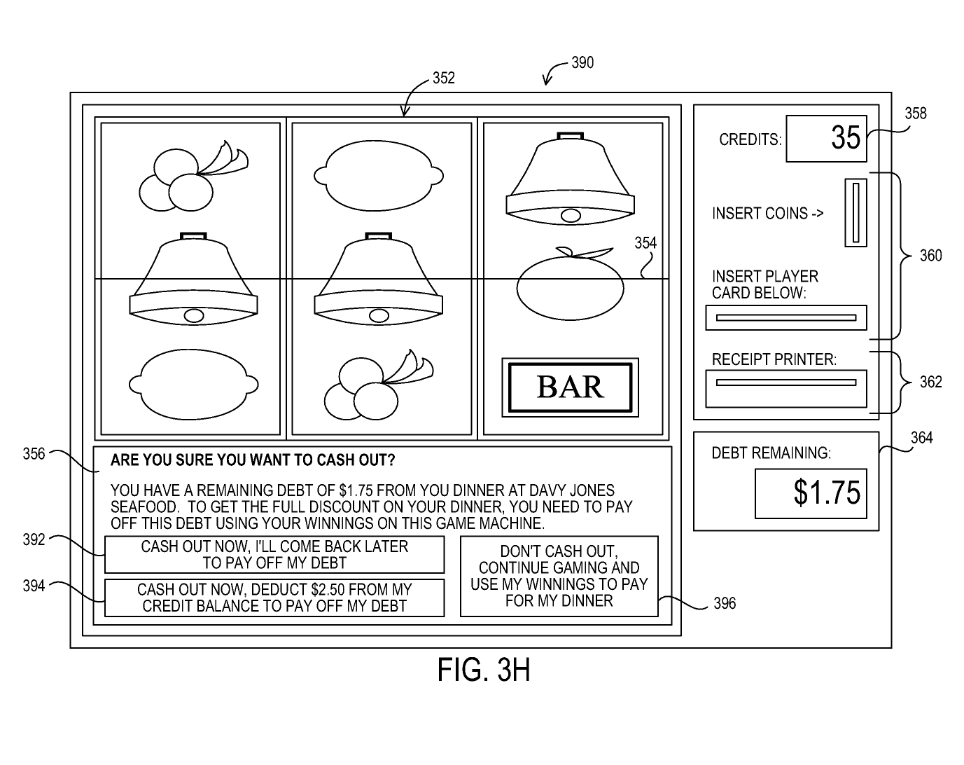

FIGS. 3A, 3 Band 3C depict a flowchart 300 illustrating an embodiment of a process for offering benefits to a player in return for agreeing to have a portion of anticipated future winning outcomes appropriated. For example, a GD may be configured to provide offers for benefits to players, and may also be configured to provide a benefit (e.g., bonus game play, and/or use of an advantageous paytable during play). The GD may be part of a gaming system, such as the network system 200 shown in FIG. 2A, or may be a stand-alone GD. Thus, as discussed above, the GD may be one of a plurality of GDs that may be in communication with other GDs, GS's, and/or other devices, which may be configured in a thin-client architecture.

Typically, a player initiates game play at a particular GD by inserting payment (such as cash, and/or a credit or debit card, and/or a voucher, and/or a gaming ticket) that may be read by a reading device to obtain a credit balance that is used to place wagers. Some players may also insert a player tracking card or to provide a player ID in order to acquire comp points, for example, or to indicate that a debt is owed in accordance with one or more embodiments described herein.

Referring to FIG. 3A, in some embodiments a determination 302 is made to make an offer for a benefit to a player. In some embodiments, an offer for a benefit may be provided to a player based on: (i) player request, (ii) gaming activity, (iii) player interest in a purchase, (iv) availability of GDs, (v) the time of day, and/or (v) the gaming activity of other players. In some embodiments, step 302 may also include determining which type of agreement to use (which may be based on such factors as the type and the value associated with the benefit, player information, player preferences, and current GD usage). In some embodiments, a player may request a benefit and then be provided with terms and conditions, for example, determined by a casino.

Turning again to the embodiment of FIG. 3A, an offer 304 for a benefit is provided (for example, an offer may be displayed by a GD to the player, or may be verbally presented to the player by a casino representative) which requires the player to agree to terms and/or conditions of an agreement that includes an appropriation scheme to appropriate a portion of anticipated winning outcomes. In some embodiments, multiple agreements may be presented to a player, and these may be output as a menu on a display screen for the player to read and/or to compare and/or select terms and conditions. (For example, one or more “Play It Off” agreements could contain one or more gaming requirements, in addition to time limitations for playing a wagering game, and such variations are discussed in detail herein). If the player does not accept the terms 306, then the process ends 308.

If the player accepts the agreement terms in step 306, then in step 310 a charge is authorized to the player's account. In this example embodiment, an actual charge is not applied to the player's account at this time, and the player's account will not be charged unless there is a default, which may occur if the player fails to satisfy one or more terms and/or conditions of the agreement, which will be discussed in detail below. (It should be understood, however, that in some embodiments no charges are authorized to a player account.) Next, the benefit is provided 312.

Wagering game play is then provided 314 in an appropriation mode, wherein a portion of some (or all) winning outcomes are appropriated according to the terms of the agreement (for example, one credit from each jackpot of 10 or more credits is appropriated by the casino). The terms and/or conditions of the agreement may also include one or more gaming requirements (for example, the player is required to play for 4 hours, or until a predetermined benefit value is achieved). The player continues wagering game play as before but the GD is no longer operating in a regular mode, even though the player is still required to place a wager (i.e., make a bet) before he is permitted to push a button to request, for example, five cards to be dealt. (It should be understood that, in some embodiments the player might have paid a flat rate to play the wagering game and that in such cases a wager is not required to place a wager before each spin.) As is known, the dealing task for such a wagering game may be handled by some other device (for example, the GD is a video five card stud gaming machine, and cannot itself generate the information). For example, the GD may make a request for five random numbers that may be handled by another device, for example, by a GS. The five random numbers are then mapped to cards, and this function may be handled by a GS that is different from, or the same as, the GS that generated the random numbers. The results are transmitted back to the requesting GD, which then uses the information to display the cards on a video screen to the player.

If a winning outcome was generated, a credit amount is added to the amount shown on a credit meter, which credit amount equals the payout minus the portion owed in accordance with the appropriation scheme. In addition, in some embodiments, the portion subtracted from the payout may also be used to reduce the amount shown on a debt meter. Furthermore, the fact that the GD is operating in an appropriation mode is clearly and prominently displayed to the player. Some or all of the data concerning the appropriation of credits during game play may be stored as transaction data and/or agreement data in one or more databases, and may also be stored in one or more additional databases.

Next, it is determined whether a pause indication was received 316, and if it was received, then an indication 318 (see FIG. 3B) is provided to the player that the GD is operating in a regular mode, and regular mode operation is provided. An appropriation mode pause button may be provided to the player as a menu option when the GD is operating according to the terms of one or more agreements, and/or may be a physical button or switch that is provided on the GD. Next, it is determined if a resume indication 320 has been received by the player. The resume indication may also be a menu option, and/or may be a physical button or switch provided on the GD to indicate that the player wishes to resume gaming under an appropriation mode. If a resume indication is provided, then the process branches back to step 314 (FIG. 3A) wherein wagering game play is continued in the appropriation mode. If not, then the process branches back to step 318 and game play continues in regular mode.

Referring again to FIG. 3A, if the player did not provide a pause indication in step 316, then a determination 322 (see FIG. 3C) is made as to whether a predetermined event occurred and/or if the gaming requirements (if any) associated with an agreement have been satisfied. A predetermined event may be defined in the Agreement, and may be considered to be a type of termination condition because when a player obtains one or more certain predefined outcomes then the agreement terminates. For example, a “Play It Off” agreement may include terms that specify one or more events that will terminate the agreement if they occur, such as the player obtaining a predetermined outcome of “JOKER-JOKER-JOKER” on a three-reel slot machine, or a hand of all Jokers as an outcome on a video slot machine. Examples of gaming requirements that must be satisfied by the player include playing the GD for a minimum amount of time, having a minimum amount of wagering, operating the GD at a minimum speed, and the like. (Further examples of predetermined events and/or gaming requirements are described in detail below). If the answer is yes to the query of step 322, then an indication 324 is made to the player that he reached his goal of satisfying the agreement for the benefit, and another indication 326 is made to the player that the GD will now begin play in a regular mode of operation (i.e., a message is displayed: “Congratulations!! You paid off your debt concerning the Agreement you made for the 25% discount on your restaurant meal. Game play will continue in a regular mode of operation, and you are now eligible to win the Mega Jackpot!”).

However, if in step 322 a predetermined event did not occur and/or the gaming requirements have not been satisfied, then a determination is made as to whether a cashout indication has been received 328. If not, then an indication 330 is made to the player that wagering game play is continuing in an appropriation mode, and the process branches back to step 314 of FIG. 3A (i.e., a message may be displayed by the GD to the player that wagering game play is continuing in “Appropriation Mode”).

Referring again to step 328 of FIG. 3C, if it is determined that a cashout indication was made by the player, then an indication 332 of possible default is provided to the player (For example, the player may have made a request to cashout before reaching the goal of paying off the benefit value and/or before satisfying one or more gaming requirements.) The player is then provided with an opportunity to continue wagering game play in appropriation mode now or in the future, that is, to continue wagering game play according to the terms of the agreement. If the player agrees to continue wagering play now in the appropriation mode 334, then the process branches back to step 314 (of FIG. 3B). If not, then a determination is made if the player agreed to continue future play 336 in an appropriation mode. If so, then a grace period is provided 338, wherein the player is required to resume wagering game play in appropriation mode before a deadline that is determined and displayed to the player.

If in step 336 the player indicates that he will not agree to future play, then a penalty is imposed 340, wherein the player account is charged for the deficiency, and in this embodiment wagering game play ends. For example, a penalty amount that is equal to 5% of the benefit value may be charged to the player's credit card, in addition to a charge for any remaining amount that the player owes according to the benefit value listed in the agreement that was made. It is contemplated, however, that in some embodiments no penalty would be charged, or a penalty that is proportional to the degree of noncompliance with the terms and/or conditions of the agreement, or a very minor penalty would be imposed for failing to satisfy all the terms of an Agreement. It is also contemplated that, in some embodiments, no penalty would be imposed and there would only be a charge for the deficiency. In some embodiments, the player may be offered a grace period in which to continue gaming in order to satisfy the terms of an agreement and thus no penalty would be imposed if the player indicates that she will return to play a wagering game in an appropriation mode before a predetermined deadline expires.

FIG. 3D is a simplified drawing of an embodiment of a front panel 350 of a GD, showing a display screen 352 with a gaming results area and a payline 354, and a message area 356. Also included is a credit meter 358, a payment and identification input area 360, a receipt printer slot 362, and a debt meter 364. In particular, the display screen shows a non-winning outcome of “BELL-BELL-ORANGE” lined up along the payline 354, and a message in area 356 informing the player that he is playing in an appropriation mode. The message also informs the player of his prior “Play It Off” agreement that he made after his dinner at the “Davy Jones Seafood” restaurant, and a brief description of how many credits will be appropriated from his winning outcomes. A “Disable Appropriation Mode” button 366 is also provided on the touch screen, to enable the player to play the GD in a regular mode of game play if desired.

FIG. 3E is a simplified drawing of a second embodiment of a front panel 370 of a GD, similar to that of FIG. 3D, showing the display screen 352 with the gaming results area and payline 354, and a message area 356. Also included is the credit meter 358, the payment and identification input area 360, the receipt printer slot 362, and the debt meter 364. In particular, the display screen shows a non-winning outcome of “LEMON-BELL-ORANGE” lined up along the payline 354, and a message in area 356 informing the player that he the appropriation mode has been disabled. The message also informs the player of his prior “Play It Off” agreement and that he still owes $10.75 (shown on the debt meter 364) towards his dinner at the “Davy Jones Seafood” restaurant, and a prompt notifying him to pay off his debt by using his winning outcomes on this GD. An “Enable Appropriation Mode” button 372 is provided on the touch screen, so that the player can revert to playing the GD under appropriation mode if desired. The message also informs the player that if he does not re-enable appropriation mode, then his credit card may be charged.

FIG. 3F is a simplified drawing of another embodiment of a front panel 375 of a GD, similar to those of FIGS. 3D and 3E, showing a display screen 352 with the gaming results area and a payline 354, and a message area 356. The credit meter 358, payment and identification input area 360, receipt printer slot 362, and debt meter 364 are also depicted. In particular, the display screen shows a winning outcome of “ORANGE-ORANGE-ORANGE” lined up along the payline 354, and a message in area 356 informing the player that he won 15 credits. Also included is an explanation that 14 credits have been added to the balance shown on the credit meter 358, and twenty-five cents has been subtracted from the balance on the debt meter 360. In addition, an explanation is provided concerning why twenty-five cents has been appropriated, and a button 366 is provided for the player to use if he wishes to find out more information regarding the “Play It Off” agreement that he entered into previously. In some embodiments, the debt meter may change colors, and/or become enlarged on the display when a portion of a winning outcome is appropriated, and an audio alert may also be included, so that that player knows exactly what is occurring. Other methods are contemplated for alerting players that a portion of a winning outcome is being appropriated, which may occur before, during and after wagering game play in appropriation mode. For example, audio alarms, visual alarms, and various types of communication devices could be utilized to inform and/or to alert players that winning outcomes are being appropriated under one or more “Play It Off” agreements.

FIG. 3G illustrates yet another embodiment 380 of the front panel of a GD that is similar to that shown in FIGS. 3D-3F, with a display screen 352 that includes the gaming results area and payline 354 and a message area 356. The credit meter 358, payment and identification input area 360, receipt printer slot 362, and debt meter 364 are also shown. In this case, the message area 356 is displaying a warning message indicating that the player's credit balance is low. In particular, the player has only 20 credits left on the credit meter 358 but still owes $4.25 towards the benefit received according to the “Play It Off” agreement he made previously. The message also recites that if the credit meter falls to 17 credits, then the remaining credits will be appropriated to pay off the debt according to the agreement. Another message also appears reciting “Insert More Money Now to Keep Gaming”, and an “OK” button 382 is provided for the player to push to acknowledge that he has read the message.

FIG. 3H illustrates yet another embodiment 390 of the front panel of a GD that is similar to those shown in FIGS. 3D-3G, with a display screen 352 having the gaming results area and a payline 354, and a message area 356. Also included are the credit meter 358, payment and identification input area 360, receipt printer slot 362, and debt meter 364. In this case, the player has chosen to cash out before the balance on the debt meter has been paid off. Thus, a message is displayed in the message area 356 asking the player: “Are You Sure You Want to Cash Out?” Also provided are three touch screen buttons for selection by the player. A cash out button 392 permits the player to cash out now and then return later to pay off the debt (i.e., initiate a pause condition), and a separate cash out button 394 allows the player to cash out now but have $2.50 deducted from the credit balance to pay off the debt. A “Don't Cash Out” button 396 is also provided that permits the player to continue gaming in appropriation mode according to the agreement.

In some embodiments, when the player cashes out, the GD provides a cashout ticket or coupon that may be printed and then provided through the receipt printer slot 362, and the receipt indicates that the player has either paid off his debt or still owes the casino a portion of, or the entire amount of, a benefit value. In addition, some embodiments may utilize a GD configured to print rebate coupons for players that qualify, for example, by paying off the debt owed before a predetermined deadline (for example, the deadline may be calculated from the time the benefit was obtained to when a debt meter reads zero). As described above, in some embodiments, the player may be permitted to pause and/or restart a gaming session within a certain time period (i.e., at any time within 48 hours from the time a benefit is provided) according to terms in the “Pay It Off” agreement. In some embodiments, the player may also be able to indicate that he wishes to totally repay his debt by either making a payment into a payment device associated with the GD or, as described above, by having an amount of credits deducted from his credit meter. For example, during wagering game play in appropriation mode according to the terms of a “Play It Off” agreement, the player may be permitted to utilize a touch screen to access a menu that includes an “Instant Repay” button (not shown). When the player selects the “Instant Repay” button the GD then deducts any remaining debt balance from the player's credit meter in order to fully satisfy the player's remaining debt. In an implementation, after selecting “Instant Repay”, the player may be prompted to insert payment in order to pay off the remaining debt.

1. Types of Benefits

Various types of benefits may be offered to players, and the agreement may specify which benefit to be provided to the player. Benefits may include products, services, money, and other forms of consideration, and may be provided by various parties (e.g., a casino, a retail store, a credit card issuer). For example, the player may be offered discounts on products or services (e.g., a player may go shopping at a store that is associated with, or partners with, a casino, and receive an offer to get a 10% discount on his purchase). The player may also be offered an amount of an alternate currency (e.g., comp points, casino chips, frequent flyer miles). For example, a player may be offered a benefit of earning double the number of comp points that he would otherwise earn for gaming, and/or may be offered a lump-sum of comp points up-front (before gaming) so that he can use them prior to playing a wagering game. In some embodiments, the type of benefit may be activation of one or more features on a GD, or another type of gaming-related benefit. In addition, multiple benefits may be offered.

In an advantageous embodiment, a player may be made an offer and then make an agreement to receive an immediate benefit of a lump-sum of comp points in exchange for agreeing to have a portion of his future winnings appropriated. The player may then use this lump-sum award of comp points to purchase comp-related benefits such as products or services. For example, a player might approach a kiosk on a casino floor, enter his player tracking card, and select a quantity of points he wants to get up-front, and make an agreement to gamble in the future so that his winning outcomes will cover the points. This embodiment may be particularly appealing to retailers and casinos that already have an existing mechanism for processing purchases using comp points. For example, in some areas (e.g., Las Vegas), retailers accept comp points as payment for products or services.

Products and services that may be provided as benefits could include tickets to sporting events, concerts, performances, movies, musicals, magic shows, retail merchandise (i.e., clothing, electronics, jewelry, books, magazines), personal & professional services (i.e., haircut, spa treatment, manicure, tour guide, classes), communication services (i.e., high speed internet access, long distance phone calls, cell phone service), travel services (i.e., rental car, hotel room, airline tickets, upgrades), items on loan (i.e., movie rental, DVD player), various electronics (i.e., GPS device, cell phone, video camera), sporting equipment (i.e., in-line skates, bowling ball, baseball glove, tennis racket), clothing (e.g., tuxedo, jewelry, gown), food and beverages (i.e., restaurant meals, pizza delivery, free drinks), entertainment (i.e., premium movies on hotel room TV, dinner show tickets), and/or discounts on products or services (i.e., coupons, buffet tickets).

As mentioned above, features of a GD may be activated as a benefit to a player who agrees to have a portion of his future winning outcomes appropriated. Examples of such features include activating an auto-play mode (wherein the GD automatically generates outcomes without the player having to press the “spin” or “deal” button), activating a 3D graphics mode (wherein the graphics and sounds of a game machine are enhanced to provide additional entertainment to a player), activating a customizable reel symbols mode (e.g., a player may be able to choose which symbols appear on the reels of a slot machine), activating services provided by the GD (e.g., free telephone calls on GDs that include a telephone handset that allows a player to make telephone calls while he is gaming, and/or free internet access), activating movie playback (for example, a player may be able to watch movies or television on the GD while he plays), activating music selections (for example, a GD may include a jukebox that allows a player to select music that will be played and/or downloaded while he is gaming), and/or upgrading features available on the GD (for example, increasing the maximum bet permitted, activating additional paylines, and increasing the rate at which comp points are earned). Another feature that may be activated as a benefit may be an insurance feature. For example, a player may obtain an insurance feature that guarantees that a certain event will not occur on a GD, but if that event does occur, then an appropriate conciliatory benefit is provided to the player (of course, insurance may apply for a complimentary case, wherein an event is guaranteed to occur, such as a particular winning outcome within 200 spins, and if that event does not occur then an appropriate conciliatory benefit is provided to the player). The benefit offered to the player may also be activation of additional devices on a GD (for example, a GD may have a biometric input device that allows a player to provide his own personal biometric that affects an outcome produced by the game machine), and or activation of one or more social gaming features (i.e., players of several GDs may share outcomes and/or prizes, wherein the GDs may be linked together). A list of features that a player may be permitted to activate as a benefit can be found in U.S. Published Application No. 2004/0024666 entitled “Method and Apparatus for Managing Features on a Gaming Device”, which is assigned to the assignee of the present application, and which is incorporated by reference herein.

A player may also be provided with an offer for gaming-related benefits. For example, the player may be offered an entry into a game of chance (e.g., free spin on a slot machine, a free entry into a bonus round on a game machine), and/or increased odds of certain outcomes on a game machine (e.g., a player may be able to select one or more prize values), and/or GD enhancement feature (e.g., a re-spin of the last reel, one or more wild cards, and the like). The player may also be given the ability to draw additional cards in video poker, or to have at least one additional symbol added to the reels on a slot machine (e.g., a wildcard symbol, a double prize value symbol), or to obtain gaming insurance (e.g., insurance against losing streaks, guarantee of at least one bonus round entry every hour), or enter a tutorial mode (e.g., in video poker, the game machine may warn a player if the player is about to make a poor choice of which cards to discard), or be provided with a retroactive activation of a pay line on a slot machine (for example, a player may bet 1 pay line on a slot machine and achieve an outcome that would have been a winning outcome if he had bet 3 or more pay lines), or be permitted to manually adjust a reel of a slots game (i.e., change a “near miss” into a win by moving one or more of the reels one or more positions to line up a winning combination; for example, change a “BAR-CHERRY-LEMON” outcome having no payout, into a “BAR-BAR-SEVEN” outcome by moving the second and third reels one position each to form an outcome that pays 3 credits). Consequently, the benefit to the player in such cases is that the player gets to retroactively activate one or more additional pay lines or manipulate one or more reels to thereby win a prize that he was not otherwise entitled to.

2. Trigger Conditions

A player may be offered a benefit in exchange for agreeing to have a portion of his future winning outcomes appropriated when one or more trigger conditions occur. A trigger condition may be an event or some other occurrence that occurs within a casino, or in a retail store that may or may not be in the same geographical vicinity as a casino, or while a player is viewing a website, or at some other location. However, it has been recognized that a player may be more responsive to an offer for a benefit while he is actually engaged in game play at a GD. For example, a player may be using a GD in a regular mode of operation, and a trigger condition may occur that is based on one or more factors. In this case, one or more of the following factors may affect the occurrence of a trigger condition: events that occur at the GD, metrics of game play, factors relating to a credit balance on the GD, game play on other GDs, conditions relating to the player, one or more indications provided by the player, and/or indications provided by other parties (e.g., a casino representative, a friend of a player, a regulator, and the like).

Some specific examples of events at the GD that may affect a trigger condition include: money is inserted into the GD by a player (e.g., using the GD's payment system); particular types of outcomes are generated by the GD (e.g. 50 losing outcomes in a row may be a losing streak that triggers an offer for a benefit); certain predetermined types or amounts of payouts that are provided by the GD (e.g., a $100 jackpot); one or more intra-game events occur (e.g., a player is dealt a card in video poker, a player discards a card in video poker, a player gains access to an offer to play a bonus round on a slot machine); money is removed from the GD by a player (e.g., a player presses the ‘cash out’ button); a bonus is provided to a player (e.g., a player may earn a 10 coin bonus for inserting a $20 bill into the GD); a player identifies himself (e.g., a player may insert a player tracking card into the GD); and/or a feature is activated or deactivated. Such events or factors may trip a trigger condition that may in turn cause the GD to display an offer for a benefit if the player agrees to have a portion of future winning outcomes appropriated up to a predetermined benefit value (which he may chose not to accept). In some embodiments, the GD may display a menu or menus that the player may use to select a feature or to indicate his preferences regarding a benefit and/or regarding terms of an agreement.

In some embodiments, information may be output to a player by an output device associated with the GD (e.g., a message may be displayed to a player on a video screen), and also offer the player the opportunity to obtain a benefit. A menu of pre-packaged “Play It Off” agreements associated with one or more products or services that the player is contemplating may be displayed, for example, on a video screen. In another example, a particular one or more “Play It Off” agreements may be displayed next to a product and/or a service advertisement, or on a placard next to a GD (e.g., a display placard next to a GD may list features that can be activated if the player agrees to have future winnings appropriated, and/or a message board advertising show tickets may indicate that tickets may be purchased by using a “Play It Off” agreement whose terms are also included on the board).

In some embodiments, one or more indications from one or more sensors may affect or cause a trigger condition. For example, the GD may have a weight sensor that determines when a player is standing in front of the GD, and a trigger condition may occur after the player has stood in front of the GD for a predetermined amount of time (for example, 5 seconds), which in turn may cause a message to be displayed on a screen of the GD offering a benefit to the player. In a second example, the GD may have a microphone that may be used to determine when a player is speaking (e.g., with a friend).

In addition to events themselves, information about events may be factors that affect or cause a trigger condition. For example, the following information about events may affect or cause a trigger condition: when the event occurred (e.g., what date, what time of day, ordering of events), how often an event occurred (e.g., 14 times, an average of 32.6 times per hour), how much money was added and/or removed and/or involved in the event (e.g., how much money did a player insert into a GD? How large was a payout provided to a player?), results of the event (e.g., what was a player's credit balance after he won a jackpot? What is the state of a program on a GD after the GDs' software is upgraded?), what caused an event to occur (e.g., why did a player win a jackpot of 100 coins?), and/or other information describing the event.

Metrics of game play may also affect or cause a trigger condition in some embodiments. For example, the following metrics may affect a trigger condition: duration of play (e.g., how many minutes a player has operated a GD, how many games a player has played, how much money a player has bet), a rate of play (e.g., average number of games per minute, amount of currency per minute, changes in a player's rate of play), how long a condition has been true (e.g., How long has the player maintained a rate of play of more than 7 games or spins per minute? For how many games has the player's credit balance been above 40 coins? What percentage of games are played with a particular feature enabled?), an amount of play (e.g., as measured by session win or session theoretical win, number of prizes won), and/or the amount wagered (e.g., if a player wagers more than a threshold amount of coins in a period of time, a prompt may be triggered).

In some embodiments, factors relating to a credit balance or to a debt balance associated with the GD may affect or cause a trigger condition. For example, a trigger condition may be caused by a current credit balance or a current debt balance on the GD (e.g., is the current credit balance above a threshold value?; is the debt balance below a certain value?), a change in the credit balance or a change in the debt balance (e.g., has the credit balance fallen by more than $40 during the last 30 minutes?; has the credit balance fallen below a minimum value which indicates that the player may not be able to satisfy a gaming requirement?; has the debt balance fallen below a threshold level?), a current credit or debt balance on a plurality of GDs (e.g., in an embodiment in which a player may operate a plurality of GDs simultaneously), and/or metrics of a credit balance or of a debt balance, or both (e.g., average value of credit balance, average rate of change of credit and/or debt balance).

In some embodiments, factors relating to game play on other GDs may affect or cause a trigger condition. For example, a trigger condition may be caused by a determination that other GDs are occupied or unoccupied (for example, a trigger condition may be that one or more similar GDs within a predetermined area are unoccupied), by relative game play on other GDs (e.g., an offer for a benefit may be output to the player if he has lost 10 games in a row while at the same time a second player on a nearby GD has won multiple prizes). Such conditions may cause the GD to make an offer to the player that can be obtained immediately at the GD, or at a future time, for example.

In some embodiments, conditions relating to the player may affect a trigger condition. For example, a trigger condition may be determined based on the identity of the player (e.g., status of the player as a preferred member of casino club), by the gaming history of the player (e.g., comp points earned by the player greater than a threshold value, amount of money wagered over a period of time), and/or by the preferences of the player (e.g., the player has indicated a preference that he be alerted when free play mode becomes available). In some embodiments, the identity of the player could be determined “passively”, that is by using a device such as an imaging system to identify the player. For example, a video camera may be operable to capture facial expressions of a player and transmit them to a system that compares the captured images to images stored in a player ID database to automatically identify players, without the need for the player to swipe his player ID card in a card reader. In this manner, an appropriation mode of wagering game play may be initiated passively (i.e., the player need not provide a wagering ticket, receipt, or player tracking card), however, the player would be provided with an indication of the mode of play so that he would be informed that he is playing in an appropriation mode according to an agreement. It is contemplated that such methods of identifying players could also be used for other functions related to the player, such as debt collection.

In some embodiments, a player may indicate that he would like to consider an offer for a benefit (e.g., by using an input device on the GD, or by approaching and asking a casino representative), and/or the player may indicate one or more conditions upon which he would like to be prompted to obtain an offer, and such indications may be considered to be trigger conditions. For example, at the start of a gaming session, a player may indicate that he would like to be offered a gaming feature on the GD that increases payouts on a paytable if he goes on a losing streak of 20 games (i.e., spins of a slot machine) or more. In another example, a player may indicate that he would like to be prompted to obtain an offer for a benefit anytime his credit balance falls below 30 credits. Other parties (i.e., parties other than the player) may also indicate a desire to have an offer presented to the player for a benefit under certain conditions. For example, a friend, relative or spouse of a player may indicate that the player should be offered a benefit to appropriate a portion of any winning outcomes and apply those amounts to that player's credit card account. In another example, a wife may indicate that her husband should be prompted for receiving a similar benefit because she is worried that her husband is losing money at an alarming rate, or because she knows that her husband is upset with his most recent gaming experiences. In addition, a casino representative (e.g., a waitress, a casino host, a blackjack dealer, a pit boss) may use a computer terminal or other device (e.g., a personal computer, a cash register, a PDA) to indicate information relating to a player that may cause a prompt for a benefit to be displayed at the GD for the player. For example, a casino host may notice that a player seems to be depressed or angry about his current losing streak and may then use a wireless PDA to transmit an indication of this observation to the GD or to a central computer such as a GS or casino server. Based on this indication, an offer for a benefit, such as an upgrade to a more favorable paytable, or to upgrade to an improved probability table to increase the chances of achieving winning outcomes, may be output to the player at that GD in exchange for an agreement to have a portion of future winnings appropriated.

In some embodiments, if a trigger condition occurs, then a benefit is offered to a player, and the benefit may be provided at that time, for example, if the player agrees to permit the casino to appropriate a share of future winning outcomes and submits to at least one gaming requirement. For example, if a player on a GD incurs 50 losing outcomes in a row, or his credit balance falls below a predetermined threshold level, an offer message may appear on a GD display that the player can obtain use of an advantageous or generous paytable in exchange for agreeing to let the casino take a share of future winning outcomes until a target value is reached, wherein the target value may be less than or equal to (or greater than) a predetermined benefit value. Offers for benefits wherein a player agrees to game play in an appropriation mode may also be made to VIP players or other selected players as a “bonus” to entice them to engage in wagering game play. For example, a benefit may be offered to a VIP player that has a specific retail value, and a “Play It Off” agreement may specify a target value of winning outcomes to be appropriated that is below that retail value to entice the VIP player to enter into the Agreement (because the player perceives this as a “good deal”). In some embodiments, the player may be permitted to indicate preferences and/or to customize one or more terms of the agreement.

In some embodiments, a trigger condition may be a Boolean expression. The Boolean expression may reference one or more variables (i.e., factors) and may include Boolean modifiers and conjunctions (e.g. AND, OR, XOR, NOT, NAND), comparators (e.g., >, <, =, >=, <=, !=), mathematical operations (e.g. +, −, *, /, mean, standard deviation, logarithm, derivative, integral), and constants (e.g. $10, 20 coins, 300 credits, 0.02, 15%, pi, TRUE, yellow, “raining”). The Boolean expressions can be used in a process, for example, with a GD to affect or to cause a trigger condition. For example, the following Boolean expressions may be used alone or in combination: (session_win>$100) AND (losing_streak>10 spins), (time_of_day>6 pm) AND (empty_game_machines>30) AND (most_recent_outcome=loss), (free_play_button_pressed=TRUE).

Thus, in some embodiments, the process includes determining whether or not to offer a benefit to at least one player, which may be based on a trigger condition as discussed above. The player may be offered the benefit and be presented with terms and/or conditions associated with appropriating anticipated future winning outcomes of a wagering game, and then he is provided with the benefit if he agrees. When the player does play the wagering game, a portion of the player's winning outcomes are appropriated according to at least one agreement term.

3. Providing Benefits

After a player makes an agreement, in some embodiments the benefit is immediately provided to the player according to the terms of the agreement. For example, a POS terminal may provide a discount to a player on one or more products or services that a player is purchasing, a GD may increase a player's balance on a credit meter, a feature on a GD may be activated, a computer server may increment a balance of comp points stored in a player account or may increase the rate used to provide comp points, a POS terminal, kiosk, or GD may print out tickets to a show or sporting event, a set-top box may provide a player with access to a premium movie channel, and/or a POS terminal may indicate to a cashier that the cashier should provide a gift certificate to the player for the amount of $50.

A benefit is generally provided after a player agrees to honor terms of an agreement. This prevents players from obtaining benefits (which may be costly to a casino) without making an agreement to engage in wagering game play. In some embodiments, a player may receive a benefit soon after making the agreement (e.g., a player makes an agreement while shopping at a retail store and then immediately receives a discount on a purchase at the store). This may be very desirable to players because of the immediacy of the reward for making an agreement.

In some embodiments, a player may receive a benefit prior to gaming (e.g., a discount on a rental car prior to visiting a casino), or may receive a benefit at a later time (e.g., the player makes an agreement via a casino website and then visits the casino a week later to play wagering games and to receive his benefit). In some embodiments, a player may make an agreement and receive a benefit while gaming (for example, an offer may be presented to a player who is operating a GD to activate a gaming feature or to receive a gaming-related benefit like immediate entry into a bonus round, if the player accepts the offer). In some embodiments, a player may make an agreement while gaming and then receive a benefit that is not related to gaming (e.g., offer for free show tickets is output to a player who is operating a GD).

In some embodiments, a benefit may be provided in an ongoing manner (e.g., activation of a feature on a game machine), and the player may cease to receive the benefit when a termination condition occurs (for example, the player completes a gaming requirement specified in an agreement). Alternatively, the benefit may continue indefinitely.

In an implementation, the benefit only begins once a condition is met (e.g., once the player completes a gaming requirement). In addition, an agreement may specify that the value of a benefit is variable, and thus a GD or a GS may determine the value of the benefit to provide to a player after the agreement has been made (e.g., based on gaming activity by the player).

B. Agreements for Benefits

1. Terms and Conditions

The agreement for benefits may contain various terms and conditions that the player must satisfy, including agreeing to have a portion of his future winnings appropriated. For example, an agreement may specify that a player will receive a $25 discount on a spa treatment in exchange for allowing 10% of her future slot machine winnings to be appropriated (up to a maximum of $20). In another example, an agreement may specify that a player will get free movie playback on a GD in exchange for giving up 1 coin from any payout worth 10 coins or more.

In some embodiments, the agreement defines the benefit to be provided to the player if the player accepts the offer, includes an appropriation scheme (a repayment scheme) that describes how the player's winnings will be appropriated if the player accepts the offer, may include a gaming requirement (e.g., an amount of time that a player must play the wagering game, or a deadline for when a player much complete his gaming), and/or may include a penalty condition that describes when and how a penalty may be levied against the player if the player does not complete the gaming requirement. The player may also be required to agree to play the wagering game using one or more of an altered pay table, a modified payout scheme, an altered probability table, a modification to the odds of obtaining winning combinations, and a modification of the types of winning combinations.

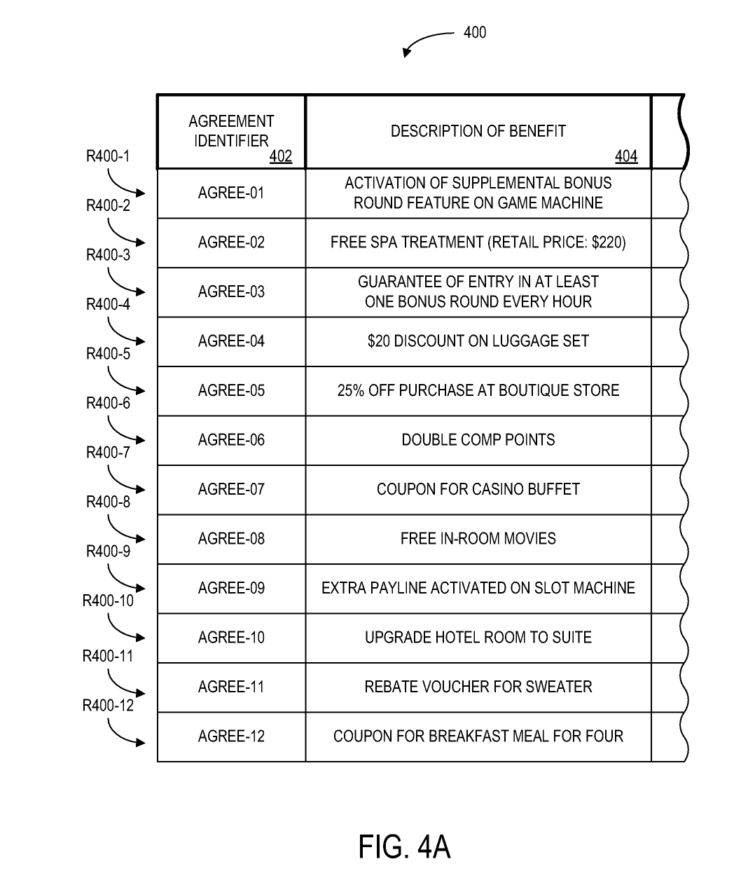

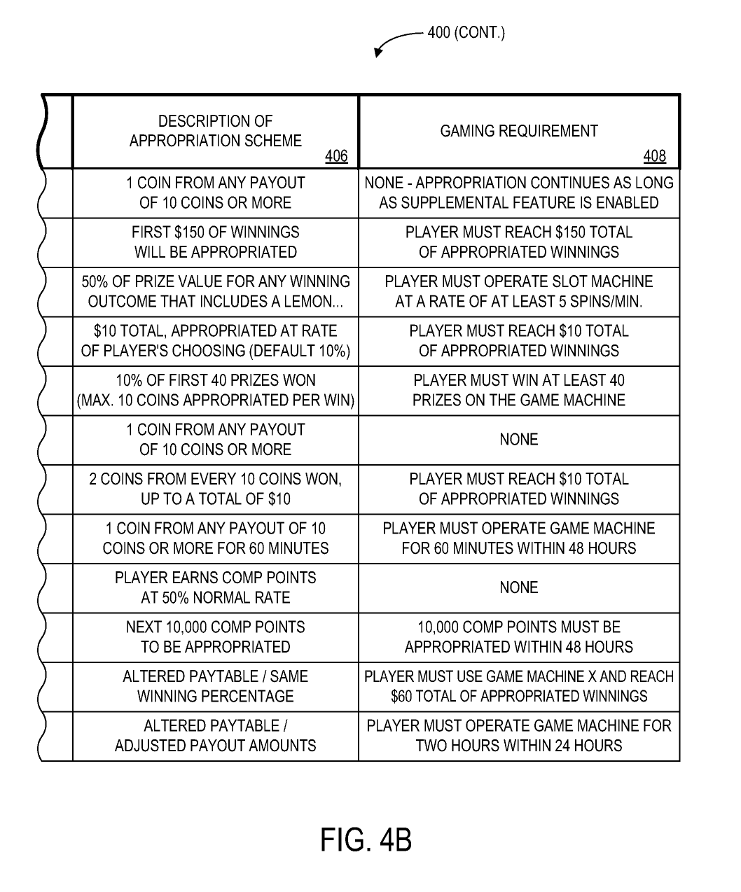

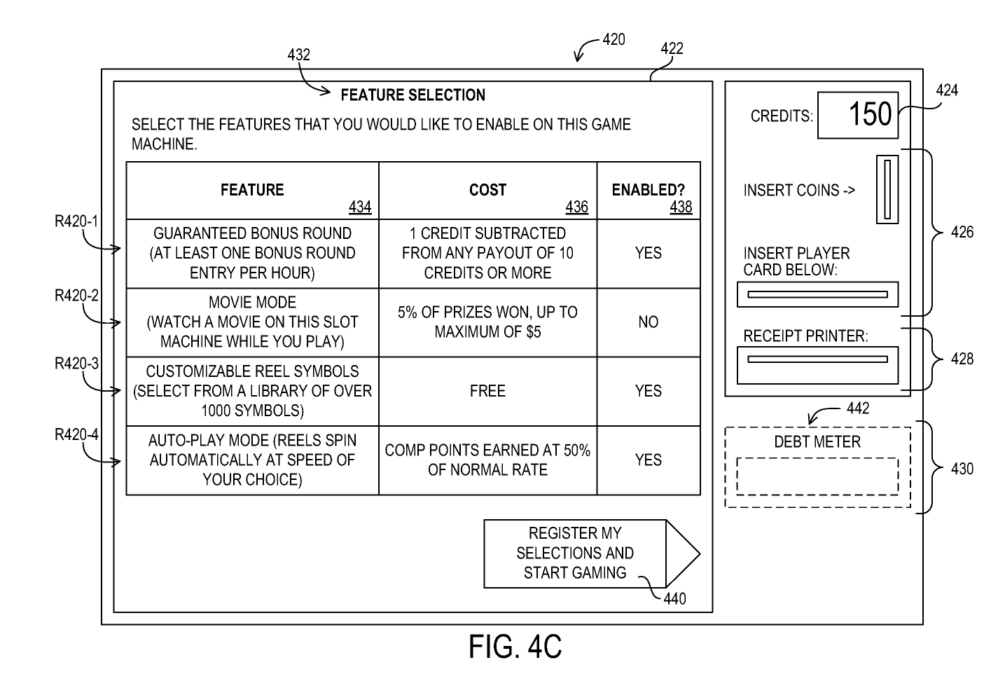

FIGS. 4A and 4B illustrate an embodiment of an agreement database 400 that includes data concerning a plurality of agreements that may be provided to players. Each agreement listed in the database includes an Agreement Identifier 402, a Description of the Benefit 404, a description of the Appropriation Scheme 406 and any Gaming Requirement 408 that may apply. For example, referring to FIG. 4A, in row R400-1 the first agreement (AGREE-01) provides a benefit of activating a supplemental bonus round feature on a GD. In order for the player to get this benefit, he agrees to an appropriation scheme that calls for 1 coin from any payout of 10 or more coins to be taken by the casino, with no gaming requirement. In this case, the benefit applies as long as the player continues to play the wagering game. In some embodiments, the player may have a choice of repaying the debt that is owed by either (i) agreeing to play the wagering game under the appropriation scheme agreed to previously, or (ii) by charging a player account, such as a credit card account, for a portion or for all of the deficiency.

In another example, a second agreement (AGREE-02) shown in row R400-2 concerns a free spa treatment having a benefit value of $220, wherein the appropriation scheme calls for the first $150 of winning outcomes to be appropriated, and includes a gaming requirement that requires that the portion of appropriated winnings of the player must total of $150. A player may perceive this second agreement (AGREE-02) as being particularly attractive, since she will acquire the spa treatment at a reduced value (i.e., she will have $150 of winnings appropriated instead of paying the $220 retail value). The other rows shown in the database 400, R400-3 to R400-10, pertain to other agreements (AGREE-03 to AGREE-10) for other types of agreement benefits, such as discounts, comp point enhancements, coupons, free services, extra GD features and upgrades. Each of these agreements have different associated appropriation schemes and/or gaming requirements, but some or all of the agreements could have similar or the same appropriation schemes and requirements as desired. It should also be noted that not all agreements require a gaming requirement (see AGREE-06 and AGREE-09 of rows R400-6 and R400-9). Further, rows R400-9 and R400-10 are agreements that include appropriation schemes that take a share of the player's comp points (that are either earned or otherwise acquired by a player) in exchange for providing a benefit. In addition, row R400-11 for AGREE-11 recites that, in exchange for a rebate voucher for a sweater, the player must play a particular type of GD that is operating under an altered paytable and the same winning percentage of outcomes, until the player reaches sixty dollars ($60.00) of total appropriated winnings. The agreement AGREE-12 in row R400-12 corresponds to a benefit of a coupon for a breakfast meal for four persons, which requires the player to play a wagering game for two hours within the next 24 hours, wherein the GD is operating under an altered paytable and adjusted payout amounts, which in some embodiments are less favorable to the player than a typical paytable and payout amounts that would be used in a regular mode of GD operation.

2. Determining an Agreement

Prior to offering an agreement to a player, the process may include determining an agreement for a player. For example, a GD may be programmed to determine, based on a player's preferences, that the player might be interested activating a movie mode on the GD. Based on this determination, the GD offers an agreement to the player that allows the player to activate the movie mode on the GD in exchange for having 1 coin appropriated from any prize of 10 coins or more. In another example, a player is shopping at a shoe store, and a store employee notices that the player is interested in a pair of designer shoes and enters this information into POS terminal. The shoe store has a partnership with the “Royale Casino”, and the POS terminal determines that the casino would like that player to patronize its slot machines, so an appropriate agreement is chosen and provided to the store employee. The terms of the agreement allows the player to obtain the designer shoes for a discounted price in exchange for playing a slot machine at the “Royale Casino” for a predetermined amount of time, and for allowing the casino to appropriate a portion of the winning outcomes. The store employee may then present the offer with the associated agreement to the player. In another example, a player is purchasing a meal at a restaurant and is presented with an offer to get the meal for free if he agrees to allow a portion of his future winnings to be appropriated up to a threshold value. The player may be allowed to select at what rate he would like his winnings to be appropriated (e.g., 10%, 20%, or 30%), and then the agreement is determined based on the player's selection. In some embodiments, determining an agreement may include determining one or more of a benefit, an appropriation scheme, a gaming requirement, and/or a penalty condition and associated penalty.

A computer or processor (e.g., computer server, game machine, POS terminal) may determine the agreement based on factors such as an indication by a player, a player's interests or preferences, other offers and agreements, gaming activity at a casino, and/or an indication by another party (e.g., a casino employee, a store clerk). The processor or computer may also determine the agreement based on a transaction at a POS terminal, by using data or information in a database, and/or by utilizing a trigger condition at a GD.

An indication by a player may affect the determination of an agreement. For example, an offer may allow a player to select a benefit from a list of potential benefits (e.g., the player can get either a free lunch buffet or a free necktie). In another example, a player may indicate which benefit he would like and then a processor may determine a suitable agreement that contains an appropriation scheme which may be at least partially based on the benefit. For example, the player uses an input device of a GD to indicate that he would like to receive double comp points, or, prior to visiting a casino, the player logs onto the casino's website and searches for agreements that would give him a discount of at least 50% on his hotel room. In yet another example, a player may indicate a financial obligation (e.g., a product purchased on his credit card, an outstanding phone bill, cable television service for the next year) and request a benefit be provided to him that helps him offset the cost of the financial obligation. Further, a player may be permitted to make a selection at the time of the offer, or at some later point in time after accepting the offer (e.g., when the player starts gaming).

A player's interests or preferences may affect the determination of an agreement. For example, a GD may determine a player's preferences based on the player's operation of the game machine. In another example, the GD may determine that a player is interested in the “guaranteed bonus round every hour” feature offered in its pull-down menu but may be concerned about the cost of the feature (e.g., because the player has selected the feature and then cancelled his selection when the cost of the feature is displayed). Based on this, the game machine may offer the player an agreement that activates the “guaranteed bonus round every hour” feature in exchange for appropriating a portion of the player's winnings.

In some embodiments, a player may indicate his preferences. For example, a player may log onto a casino website and indicate his favorite type of slot machine. Based on this preference, an offer may be presented to the player for a benefit (a good or a service or enhanced gaming features on that slot machine), so the player can then play his favorite slot machine while having a portion of his winnings appropriated. In some embodiments, the value of a benefit may be determined based on the player's estimated propensity to gamble, which will be discussed below.

In some embodiments, other offers and agreements may affect the determination of an agreement. For example, an agreement may be determined based on offers to a player who may be offered the agreements, or based on offers to other players. In another example, a computer server may track a player's acceptances and rejections of offers for benefits that include certain terms for having a portion of his winnings appropriated. If a player has accepted certain types of offers in the past, the computer server may determine to offer a similar agreement to that player.

In some embodiments, a computer server such as a GS may track a player's progress towards completing gaming requirements for an agreement that the player has already made (e.g., how much money has been appropriated from the player's winnings). The GS may transmit reminders to the player (i.e., “You still owe $22.00 towards completing your obligation to pay off the amount owed for the Spa Treatment you received on May 10, 2006”), and such reminders may appear on a display screen of a GD that the player is using, or may be transmitted to another device, such as a cell phone, PDA, and the like. The GS may also determine a new agreement to offer to the player, which may include complementary benefits (e.g., 2 tickets to a show to go along with the dinner for 2 that was provided to the player by the previous agreement). In addition, the GS may determine a similar appropriation scheme and/or gaming requirement, or override an existing appropriation scheme and/or gaming requirement and replace it with a new one (e.g., instead of having 1 coin appropriated from any win of 10 coins or more, now the player will have 1 coin appropriated from any win of 7 coins or more). Thus, the GS may be able to determine an agreement that has an improved chance of being accepted by the player since it contains terms that have been determined by using data about the player that indicates his predilection for certain terms.

Gaming activity at a casino may also affect the determination of an agreement. For example, GD usage may be variable, and a casino may determine that its “Rascally Rabbit” GDs are often unused. Based on this, a player making a purchase at a retail store may be offered an agreement that includes a gaming requirement that the player must have at least 20 coins appropriated at a “Rascally Rabbit” slot machine. Another consideration may be the profitability of certain GDs. For example, if statistics show that a type of GD that a player is operating normally has a greater session theoretical win, then an agreement may be modified to reduce the gaming requirement on the GD.

Indications by other parties may affect the determination of an agreement. For example, a casino employee may notice that a player has been watching other players operate a Rascally Rabbit GD and therefore approaches that player and makes an offer that relates to game play of the Rascally Rabbit GD. In another example, a store clerk determines a customer's price point for a product and then uses an interactive POS terminal to craft a personalized agreement that would be appealing to the player, which may be based on the price point and other factors that may relate to wagering game play.

In some embodiments, transaction information and/or transaction data obtained at a POS terminal may affect the determination of an agreement. For example, the value of a benefit may be determined based on the value of a transaction (for example, the benefit is 50% off and the transaction total is $120, therefore the benefit value is $60). In order to maintain the profitability of an agreement that provides the benefit, an appropriation scheme specified in the agreement may be modified (e.g., with regard to the previous example, to ensure that at least $60 of the player's winnings are appropriated). In some embodiments, a transaction may occur on a website (e.g., wherein a player is purchasing a hotel room or booking a trip to the casino), and thus the offer can be presented to the player via the website or by email. In some embodiments, an agreement may be determined based on a player's purchasing history. For example, a player who has already purchased a wool hat may be offered an agreement that would provide her with a matching scarf as a benefit.

In some embodiments, determining an agreement is an interactive process. For example, a player may use a GD or kiosk to select an agreement from two or more choices. For example, a player at a GD may input a query to determine what benefits are available if he were to agree to have a portion of his winnings appropriated by the casino during further wagering game play. The GD may respond to this request by providing the player with a list of benefits (e.g., free tickets to a show, a discounted hotel room, gift certificates for purchases at retail stores, activated features on the GD, a sum of comp points to be instantly credited to the player's account, and the like), from which the player may select a benefit. The GD may then provide the player with a list of appropriation schemes and gaming requirements associated with the various benefits, and the player may then be able to choose terms acceptable to him. In another example, a personal computer, POS terminal, or PDA may be operable to prompt a casino employee to offer a benefit with an associated agreement to a player. However, prior to making the offer to the player, the casino employee may use the computer terminal to adjust the agreement and personalize it to the player. For example, in exchange for show tickets, the agreement might originally specify that the player should have a share of winning outcomes appropriated at a “Rascally Rabbit” GD, but the casino employee may recognize that the player would be more interested in playing at a “Volcano Fire” GD. The casino employee may enter this change into his PDA so that the agreement is adjusted accordingly. Depending on the change, other terms of the agreement (e.g., the duration of gaming required, the amount of appropriated winnings) may be adjusted (either automatically, or manually) to maintain the profitability of the agreement.

In some embodiments, if a player does not accept an agreement, then the terms and conditions of the agreement may be analyzed. The analysis may include agreement data associated with that player and/or other players, and also may include appropriation data which may also be associated with that player and/or other players. One or more agreement terms and/or conditions may be selected and then adjusted or modified based on the analysis, and then a modified agreement may be formed. A second offer for the same, similar or different benefit may then be made to the player in exchange for entering into the modified agreement. The modified agreement may also be used to make future offers to that player and to others. Appropriation data for a plurality of players may be analyzed in addition to, or in association with, different types of data of particular players or types of players. Examples of data that may be used in the analysis include player preferences, prior agreement terms, player activity associated with purchases of products or services, and player gaming activity.

3. Agreement Value

An agreement may specify how the value of a benefit is determined. For example, the value of a benefit may be a percentage of its retail value or a percentage of its wholesale value, either of which may be 100%. In one embodiment, the value of a benefit may be undetermined (or indicated as “variable,” perhaps within a certain range of values) at the time an agreement is made. Instead, the value of the benefit may be determined based on events that occur after the agreement is made. For example, the value of a benefit may be determined based on gaming activity by a player (e.g., how much is appropriated from a player's winnings). For example, a player may make an agreement to receive a discount of up to $50 off of a hotel room. The actual discount received by the player will depend on how much is appropriated from the player's winnings as he plays a wagering game. For example, using the above agreement (to provide a $50 room discount), if the player operates a GD long enough to have $20 taken by the casino and/or the benefit provider from his winnings, then the player may receive a $30 discount off of his hotel room bill. In such cases, the GD may be configured such that the player is able to monitor a display of the GD to see his progress towards obtaining the full discount as he is gaming. For example, an LED display may provide a “Benefits Meter” that displays an amount of money that the player of that GD has accumulated so far towards the $50 discount, and may also output a message using the same and/or additional output devices or components to notify the player when he achieves the maximum discount (i.e., an audio message may be played over a speaker system saying “Congratulations, Joe Public, you have just achieved a $50 hotel room discount by playing this Double Diamonds Deluxe slots machine!”).

In some embodiments, the agreement may specify a formula or table that describes how the value of a benefit may be determined based on a player's appropriated winnings. An example formula may have the form:

Value_of_Benefit=1.5*Value_of_Appropriated_Winnings (Up to a maximum benefit of $50.)

In some embodiments, the value of the benefit could be determined based on gaming activities on the casino floor. For example, if it's a slow period (i.e., there aren't many players utilizing GDs at that time and most of them are idle), offers for benefits could be higher or the terms or the agreements more generous to encourage people to take the benefits by entering into an agreement and then occupy the GDs. In the alternative situation wherein virtually all of the GDs are occupied by players (i.e., the casino slot floor is crowded), the offers for benefits may be minimal and/or the agreement terms less generous, so that fewer people are drawn to the GDs. This feature may be incorporated in one or more of the embodiments of the processes described herein to provide a way for casinos to be flexible with regard to load balancing wagering game play and/or managing player traffic on the casino floor.

As mentioned above, the value of a benefit provided to a player may be determined based on the player's actual gaming activity. But in some embodiments, the value of the benefit may be based on an amount appropriated from a player's winnings. For example, a player may make an agreement to receive a discount on a hotel room, where the amount of the discount is equal to double the value of any share of prizes that are appropriated from the player (up to a maximum of $100). The agreement may specify that a portion of the player's winnings will be appropriated at a rate of 5%. According to this agreement, if the player has $38 of his winnings appropriated, then he will receive a discount of $76 on the hotel room.

4. Agreement Presentation and Acceptance

An agreement may be offered to a player via an electronic device (e.g., a GD, POS terminal, a personal computer), by a person (e.g., a casino host, a store employee), and/or in printed form (e.g., on a flyer or promotional mailing). A GD may present an offer to a player by, for example, displaying a pop-up message on a display screen such as: “Want a guarantee of getting into the bonus round at least once per hour? If you agree to give up 1 coin from any payout of 5 coins or more, this game machine will guarantee that you get to play the bonus round at least once per hour.”

It has been contemplated that benefits related to gaming may be particularly appealing to players who receive offers at a GD. For example, activation of features on the GD, and increased prize values may be more attractive benefit choices while the player is actually utilizing the GD. FIG. 4C is a simplified drawing of an embodiment of a front panel 420 of a GD, that includes a touch screen display screen 422, a credit meter 424, a payment and identification input area 426, a receipt slot 428, and a second display area 430 that outputs various information during GD operation as required. In particular, illustrated on the touch screen display 422 is a “Feature Selection” menu 432 that includes various features 434 in rows R420-1 to R420-4, the cost 422 associated with each feature, and whether or not such feature is enabled 438. The player may be instructed to press on a desired feature in order to select it and change a “No” entry in the Enabled column 438 to “Yes” to enable the feature. For example, the features shown in rows R420-1, R420-3 and R420-4 are enabled and the cost are as described in column 436. It is noted that the feature of customizable reels in row R420-3 is free and is enabled, which means that the player can choose the set of icons that appear on the reels of this machine without having any credits appropriated. But in the case of the “Guaranteed Bonus Round” feature in row R420-1, the cost is 1 credit from any payout of 10 coins or more. If the player wishes to enable “Movie Mode” in row R420-2, then he would have to agree to have 5% of his winning payouts appropriated up to a maximum of $5. Once the player makes his selections, he may press the “Register My Selections and Start Gaming” button 440 to continue wagering game play in appropriation mode. A “Debt Meter” display 442 may then be provided in display area 430 to remind him of the debt owed while he plays the GD. In addition, other messages and/or reminders of wagering game play in appropriation mode may be displayed in the touch screen display area 422.

A GD may determine when to present an offer or additional offers when a trigger condition occurs, which will be explained in more detail below. The offer may be output to a player using an output device (e.g., a touch screen of the GD, and/or an audio speaker), and a player may indicate his acceptance of an agreement by using one or more input devices provided on the GD (e.g., a button, a touch screen, a roller ball device).

In some embodiments, a player may verbally indicate acceptance of an agreement to a casino employee, and then the casino employee may indicate and/or transmit this acceptance to a GD and/or to a GS using an electronic device (e.g., a handheld wireless device configured to communicate with the GD and/or a network of GDs that may include a GS). This method, wherein the player talks to a casino employee to indicate his acceptance, may be advantageous in cases where the player has questions, and may allow for a more fluid negotiation process regarding terms and conditions of an agreement. In addition, the casino employee may be able to verify that the player understands the terms of the agreement.

In some embodiments, as mentioned above, an offer may be presented to a player at a POS terminal. The POS terminal may have a customer display (i.e., a display that faces the customer), and during a transaction, the POS terminal may offer a benefit with an agreement to the customer by displaying information about them on the customer display. In other implementations, an offer may be output by a kiosk or other electronic device located, for example, in a retail store. In some cases a POS terminal or other device may display an offer and agreement to a store employee, and then the employee may provide the offer and explain the agreement terms to a player and/or customer. Alternatively, an offer and agreement may be output using any electronic device (e.g., a personal computer, a PDA) that may be accessed by a store employee. In another example, when a player checks into a hotel near a casino, the hotel desk clerk may present an offer to the player to obtain a service, such as free Internet access from his hotel room in exchange for entering an agreement. If the player accepts the offer and associated agreement terms, then the hotel desk clerk may enter an indication of this acceptance into a computer at the hotel desk. A player may also be able to indicate her acceptance of an agreement by using an input device on the POS terminal (e.g., a customer display with a touch screen).

A website may present an offer and an associated agreement to a player. For example, a website belonging to or sponsored by a casino or an online retailer may present one or more offers to players that include various agreement terms. A player may access the website using a personal computer, wireless handheld device (e.g., PDA), cell phone, a kiosk, and/or other digital device. For example, a player may use a personal computer to visit a casino's website a week before he makes a trip to the casino, and the casino's website may present an offer that allows the player to get a discount on a hotel room in exchange for agreeing to allow a portion of his winnings to be appropriated by the casino during future game play. In another example, a player may use an interactive television system in his hotel room to view an offer and sign up by agreeing to the terms of an agreement. For example, in order to view a pay-per-view movie for free, the player agrees to have a portion of his winnings up to a threshold value appropriated by the casino from gaming. The player may indicate his acceptance of an agreement using by clicking a button, initializing a text box, or checking a box on a website, and/or by printing out an agreement from the website, signing the printed copy, and then mailing or otherwise delivering the signed agreement to a casino, website operator, or other processor of the agreement.

In some embodiments, an offer for a benefit may be sent via email, text message, voice message, or other electronic message. For example, a player may receive an email or text message on his cell phone that contains an offer for a benefit, and that may also contain “Play It Off” agreement terms, to the player (e.g., “Get tickets to a boxing match in exchange for allowing the Starliner Casino to appropriate 10% of any win of 10 coins or more during 6 hours of wagering game play on the “Lucky-Sevens” GD”.) In another example, a player may view the electronic message using a personal computer, wireless handheld device (e.g., PDA), or cell phone.

In some embodiments, an electronic message describing an offer may be transmitted to a casino employee and then the casino employee may present the offer to one or more players. For example, a casino host may carry a wireless handheld device (e.g., PDA) and receive messages from a computer server such as a GS indicating that certain players should receive offers (i.e., players A and C who are playing the GDs identified as GD00036 and GD00038 by the slot floor entrance), and indicating what particular offers should be presented to these players. In such a case, the player may be allowed to accept an offer and agreement terms by sending a text message using his cell phone, PDA, or pager (e.g., by hitting a “reply” button). Alternatively, the player may make a phone call or visit a customer service desk and speak to a representative who may register the player's acceptance for the benefit.

An offer and agreement terms may be presented to a player on a printed piece of paper, cardstock, or other substrate, and such presentations may also contain other material such as directions or a map to a casino floor, or to a particular type of GD within a casino. For example, an offer describing a benefit and agreement terms may be mailed to a player in a promotional mailing from the casino (e.g., printed on a postcard that the player can mail back to the casino to sign up for the offer). In another example, an offer describing one or more benefits and associated agreement terms may be printed on a player's credit card billing statement. In some embodiments, the player may be able to receive a benefit relating to his credit card statement (e.g., a discount on a product purchased, a reduced interest rate, a longer period to pay) in exchange for agreeing to terms related to appropriating a portion of his future winnings. It is noted that this type of agreement may be particularly useful in helping players get out of debt, because the player will then have a portion of his future winnings appropriated to pay off his credit card debt while enjoying playing the wagering game.

In some embodiments, an offer for one or more benefits (and associated terms and conditions) may be printed on a receipt or record-of-charge that is provided to a player when paying for a transaction. The player may use this receipt to sign up for the benefit and for agreeing to the terms and conditions involved (e.g., by signing an alternate pay line on the receipt, or by inserting the receipt into a reader device of a GD or kiosk).

In some embodiments, an offer and agreement terms may be printed on a leaflet or flyer that is given to a player when he checks into a hotel, or the flyer may be available next to a GD. A player may indicate acceptance of agreement terms and receive a benefit by signing the printed agreement and delivering it to an appropriate party (e.g., a customer service desk at a casino, or a POS terminal at a store or restaurant).

In some embodiments, an offer may be output to a player on a display screen or by other means (as described above) as a “Play It Off” deferred payment plan option. In particular, the player may be enticed to obtain the benefit (such as a product or a service) now, and then pay it off later by having future anticipated winnings appropriated at a wagering game according to predefined terms and conditions. Such a deferred payment plan may be output and/or displayed adjacent to the price of a product or service that a player may be contemplating purchasing.

In some embodiments, when making an agreement a player may be asked to provide a player identifier. A player identifier may include the player's name, credit card number, debit card number, bank account number, hotel room number, player tracking card number, social security number, a biometric identifier (i.e., a retinal scan, fingerprints, topical facial patterns), and/or any other type of identifier associated with that player. The player identifier (or digital copy thereof) may be stored in a database of a GS, for example, possibly along with other information related to the agreement (e.g., the type of benefits, appropriation scheme, etc.), and/or related to other or additional agreements that the player has made. This information may be useful later (e.g., determining whether and how to appropriate a player's winnings when a player begins gaming on a GD, and/or determining whether a player has met a gaming requirement). The player may also be required to provide a financial identifier (e.g., a credit card number), which may be useful in charging a penalty to the player's account if the player does not perform a gaming requirement specified in an agreement.

Upon making an agreement, a player may be provided with a receipt. This receipt may include printed information about the agreement that the player just made, including a player identifier (e.g., a player's name and hotel room number), a date, time, or location where an agreement was made (e.g., “Joe's Big and Tall Clothiers, Apr. 10, 2006 3:49 pm”), a description of the agreement terms (e.g., including the benefit provided, the appropriating scheme, and the gaming requirement), and/or an agreement identifier (e.g., AGREE-5467981). Such an agreement identifier may be printed in a machine-readable form, such as a bar code, or on a magnetic stripe. This agreement identifier may also be stored in a database by a computer server such as a GS, possibly in association with information about the agreement terms, a timestamp, and/or a player identifier. The agreement identifier may be particularly useful in determining information about an agreement (e.g., what appropriating scheme was specified) at a later point in time (e.g., when a player initiates a gaming session on a GD, or if a player has a question about any agreement terms). In addition, certain information about an agreement may be encrypted (e.g., a public-key encryption algorithm such as RSA or Diffie-Hellman could be used) and printed on a receipt that is provided to a player. This information may later be read and decrypted (e.g., by a GD) in order to determine information about an agreement (e.g., what type of appropriation scheme was specified).

5. Interactions Between Parties

As mentioned above, various parties may be involved in the process of enticing and/or convincing a player to enter into an agreement to accept a benefit in return for having a portion of his future winnings appropriated. It is noted that a first party that forms an agreement with a player may be different from a second party that provides a benefit to the player, and a third party may be responsible for appropriating a portion of the player's winnings. In some embodiments, however, the first, second and third parties are all the same party. Other combinations are also possible, which is explained below.

In some embodiments, a casino makes an agreement with a player for a benefit, the casino provides the benefit, and the casino also appropriates a portion of winnings from the player. For example, a GD of the casino may make an agreement with a player to provide a GD feature (i.e., a wild card on a reel of the GD), in exchange for appropriating a portion of all winning outcomes over 10 credits during wagering game play.

In some embodiments, a casino may make an agreement with a player for a benefit, in exchange for appropriating a portion of the player's winning outcomes, but the benefit is provided by a third party. For example, the casino makes an agreement for providing a product or service in exchange for appropriating one coin for each prize of over 15 coins at a GD up to a threshold number of spins, and a retailer provides the product of service either before or after wagering game play occurs (in accordance with the terms of the agreement).

In some embodiments, a retailer and/or service provider (e.g., department store, website, spa, credit card company, etc.) offers the benefits in exchange for players entering into agreements, and then provides the benefits. In such cases, a casino may provide payments to the retailer up front for costs associated with the benefits, and then collect the money advanced to the retailer by appropriating the winnings of players in accordance with the terms of the “Play It Off” agreements that the players agreed to abide by. For example, a retailer provides 20% off the retail price of a product in exchange for an agreement by the player to engage in wagering game play for a minimum of 5 hours at the “Casino Blue Royale” where 5% of all winning outcomes will be appropriated up to a threshold value. In this example, the Casino Blue Royale has already paid the retailer and will collect the amounts advanced from the winning outcomes of the player.

In some embodiments, a promoter (e.g., a website, a retailer) may make an agreement with a player for a benefit, and the casino provides the benefit and appropriates a portion of the player's winning outcomes in exchange for receipt of the benefit. For example, the benefit may be activation of a feature of a GD, which is provided by the casino, in exchange for appropriating a portion of at least some of the player's winnings according to an appropriation scheme agreed to by the player.

When multiple parties are involved in the process of offering benefits, entering into agreements with players, providing the benefits, and appropriating a portion of winning outcomes, then in some embodiments a reconciliation process is performed to ensure that such cooperation is beneficial to all parties. This reconciliation process may include a casino (or other party that operates a GD that appropriates a portion of a player's winnings) providing payment (or other consideration) to another party who makes offers to players (e.g., a retailer, a promoter) and/or who provides the benefit to the players (e.g., a retailer). The payments may be above or in addition to the cost of the benefits provided, for example, to encourage promoters and/or retailers to aggressively recruit players for the casino. Such additional fees may be characterized as “bounty” fees that are paid to recruit players, and such fees may be optional (or may be discontinued) because bounty fees may not be required to entice players to enter into such “Play It Off” agreements. Reconciliation payments are intended to compensate retailers, for example, for the costs associated with providing the benefit to players.

In some implementations, a casino (or other party that operates a GD and appropriates a portion of a player's winnings) may provide payment (or other consideration) to a party that signs up a player to an agreement (e.g., a retailer or promoter). The casino may provide this payment because it gains additional revenue by having a player visit the casino, operate a GD (e.g., for longer than he otherwise might have played a wagering game), and have at least a portion of his winnings appropriated. In some embodiments, a party that signs a player to an agreement (e.g., a promoter) may provide a payment (or other consideration) to a party that provides a benefit to a player (e.g., a retailer). This payment may help to offset some or all of the cost of the benefit that is provided to the player, and may be worthwhile to the promoter because a casino may be providing the promoter with payments that are based on how many new players come to their casino to play a wagering game as a result of accepting such offers for benefits.

In some embodiments, a computer server such as a GS may store data and/or information concerning the reconciliation process in a database. For example, a reconciliation database may store data concerning the value of a benefit provided to a player, the value of a player's gaming activity at a casino (which may be calculated based on the player's session theoretical win and the player's appropriated winnings), the value of signing a player up to an agreement (which may be calculated based on the value of the benefit, the value of the player's gaming activity, and the odds that player will complete the agreement).

6. Appropriation Schemes

The agreement made by a player to obtain a benefit in return for having a portion of his future winnings appropriated includes an appropriation scheme. In some embodiments, the appropriation scheme is described in the agreement, and several different types of appropriation schemes may be available for selection by a player or by a GD operator. A database of such appropriation schemes may be stored on a GD and/or on a server, such as a GS, and include instructions concerning how to appropriate a portion of the player's winnings from his wagering game play. The appropriated winnings may be used to help defray the cost or value of a benefit that was already been provided to the player, or to compensate for a benefit that is currently being provided (i.e., activation of a gaming feature at the GD that the player is currently using). In particular, an appropriation scheme may specify a condition or conditions when appropriation should occur (e.g., only take a portion of winnings from jackpots of at least 10 coins), an amount to appropriate when the condition occurs (e.g., 10% of prize value), and/or a termination condition that describes and/or defines when the appropriations should stop, if ever.

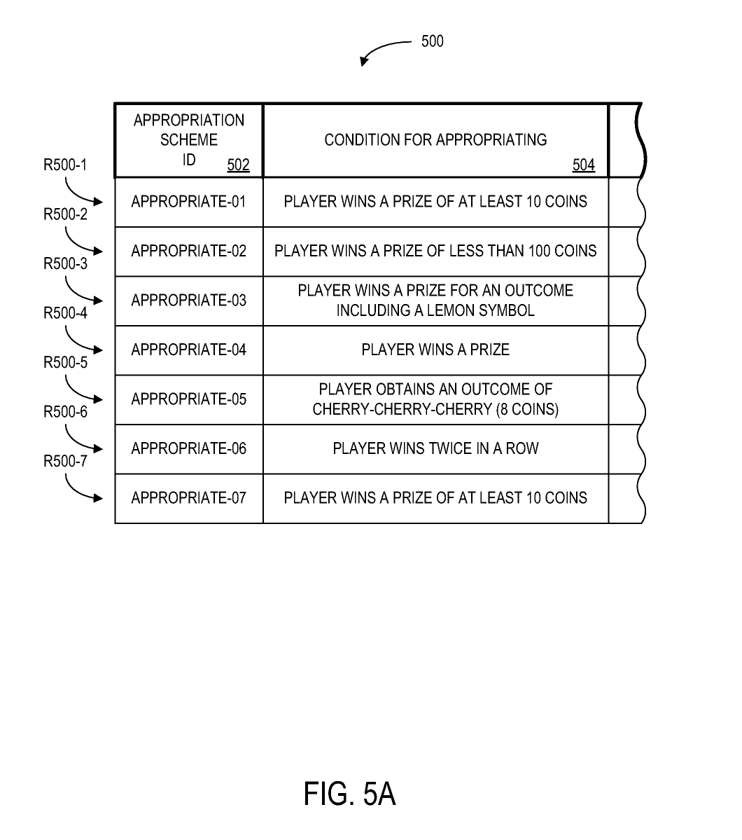

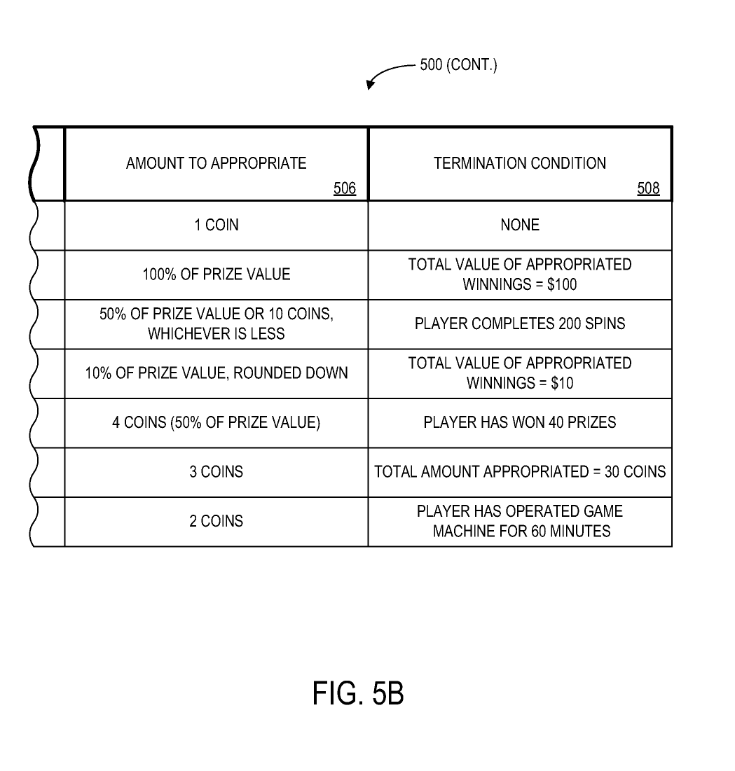

FIGS. 5A and 5B illustrate an embodiment of an Appropriation Scheme database 500, which includes a plurality of appropriation schemes. Each appropriation scheme of the database includes an Appropriation Scheme ID 502, a Condition for Appropriating 504, an Amount to Appropriate 506, and a Termination Condition 508. It should be understood that, although the Appropriation Scheme database 500 is shown in tabular format, other types of formats, including but not limited to object-oriented formats, XML formats, and relational database formats, could be used.

Referring to FIG. 5A, in row R500-1, the first appropriation scheme APPROPRIATE-01 is conditioned on the player winning a prize of at least 10 coins, which triggers the taking of 1 coin (see FIG. 5B), and there is no termination condition. Thus, in this case, the appropriation scheme continues as long as the player continues to play the wagering game. In another example, if the player obtained a benefit and agreed to an agreement that specifies that the APPROPRIATE-02 scheme applies, then as shown in row R500-2, when the player wins a prize of less than 100 coins, the entire prize value is taken until the total value of the appropriated winnings equal $100. As shown in rows R500-3 to R500-7, other types of appropriation schemes may apply, that include taking a share of winning outcomes, or a specified amount of coins, and may terminate after a predetermined amount of game play, or when a player reaches a certain threshold value of winnings, prizes, and/or time spent playing the wagering game. It should be understood that the various appropriation schemes shown in the tabular database example of FIGS. 5A and 5B are for illustration only. Many other types of appropriation schemes are possible, for example a scheme that combines certain conditions. Moreover, in some embodiments, alternate schemes may be desirable in order to, for example, promote certain types of benefits in relation to other types of benefits (i.e., offer a less onerous appropriation scheme to players who accept a gaming feature benefit as opposed to appropriation schemes used for those players who opted for a hotel room discount).

Thus, as discussed above, in accordance with one or more appropriation schemes, a casino may appropriate a player's winning outcomes when a player wins a payout (e.g., 10% of all payouts, jackpots, and/or prizes are appropriated), when a player wins a payout greater than a threshold value (e.g., a share of only payouts greater than 10 coins are appropriated), when a player wins a payout less than a threshold value (e.g., only appropriate a share of payouts when a winning outcome is less than 8 coins), when a player wins a payout or prize equal to a specified value, when a player wins a payout within a certain period of time, when a player achieves a certain outcome (e.g., take a portion of a jackpot only when the winning outcome includes a lemon symbol), at the start or end of a round of play (e.g., when cards are dealt in a hand of blackjack or poker, when a ball is spun for a game of roulette, before dice are rolled in a game of craps), when a player completes a bonus round on a GD (e.g., appropriate 10% of winnings at end of bonus round), and/or when a player receives a prize as part of multiple-player gaming experience (for example, in certain banks of slot machines, all of the players may win prizes when one player enters a bonus round).

In other examples, one or more appropriation schemes may require that a portion of a winning outcome should be taken when a counter reaches a threshold value (e.g., a share of every 10^{th} outcome is appropriated, every 10^{th} coin paid out is appropriated), when a timer reaches a threshold value (e.g., appropriate a share of winnings every 10 minutes), when a player cashes out of game machine (for example, a player may be required by an agreement to have a total of $20 appropriated; and if the player cashes out when he has only paid back $14, then in some embodiments the remaining $6 that is owed may be taken from the player's credit balance upon cash out. One benefit of appropriating money upon cash out is that it may encourage players to continue gaming), when a player exchanges chips, tokens, tickets or other markers for hard currency (e.g., 5% of all chips exchanged for cash will be appropriated during the next 24 hour period), when a player inserts money into a game machine (e.g., 10% of the money inserted into a game machine by a player may be appropriated to pay for a benefit that was provided to the player), when a player's credit balance falls below a threshold value (for example, a player may be required by an agreement to have a total of $20 appropriated, and if the sum of the player's appropriated winnings and the player's credit balance falls below $20, then the player's remaining credit balance may be taken. This embodiment may be helpful in ensuring that players are able to comply with a gaming requirement because it entices a player to make sure that he doesn't run out of money before meeting the gaming requirement), when a player is operating a certain GD or type of GD (for example, a player may make an agreement to have his winnings appropriated when operating Rascally Rabbit GDs, and when the player operates other types of GDs like a Diamond Deluxe GD, the player's winnings may not be appropriated), and/or when combinations of conditions occur (e.g., appropriation occurs on outcomes that include a lemon symbol and for outcomes that provide prizes of at least 10 coins).

In some embodiments, an appropriating scheme may specify an amount to take. Such amounts may be specified as a fixed value (e.g., 1 coin taken from every prize of 10 coins or more), a percentage of a prize value (e.g., 10% of prize value), a percentage of a bet value (e.g., 10% of total amount wagered, deducted from a player's credit balance in 10 minute intervals), and/or a maximum amount to take from a single prize (e.g., never appropriate a share that is more than 10 coins from a single prize).

An appropriating scheme may specify a type of game machine, and thus a portion of the player's winning outcome may only be appropriated while the player is operating a certain type of game machine. If a player operates a different type of game machine, then his winnings may not be appropriated. Note that a gaming requirement (see details below) may require a player to operate a certain type of game machine.

In some embodiments, an appropriating scheme may also vary depending on what type of game machine the player is operating. For example, the terms of an appropriating scheme may call for taking 1 coin from any payout of 10 coins or more on “Rascally Rabbit” slot machines, but for taking 1 coin from any payout of only 6 coins or more on “Big Game Hunter” slot machines. In another example, an appropriating scheme may call for taking ten percent from all jackpots of ten dollars ($10.00) or more of a “Double-Diamond” slot machine, which is a dollar a play GD, or twenty percent from all jackpots of three dollars ($3.00) or more from the “Triple-Hearts” slot machine, which is a quarter a play GD. In yet another example, the appropriation scheme may specify appropriating credits from one or more different types of GDs, wherein a credit may be worth a different amount depending on which GD is being played. Thus, the player may play under one set of terms associated with one type of GD, and slightly different terms associated with another type of GD, which terms may depend upon, for example, the denomination of money and/or credits being wagered. In some embodiments, the terms and conditions of play in appropriation mode may be modified according to the type of GD and/or the denomination being wagered during game play, as a player moves from one type of GD to another, and the amount appropriated per winning outcome may also be increased or decreased in proportion to the wagered amount.

7. Gaming Requirements

The value of an appropriation scheme to a casino may be dependent on a player's gaming. For example, if a player doesn't operate a GD for a long enough period of time to win any prizes, then an adequate portion of the player's winnings cannot be appropriated to cover his debt. While this may not be an issue for offers that provide benefits to players during gaming (e.g., activation of features on a GD), in some cases benefits are provided to a player prior to gaming (for example, a player may receive a discount on clothing purchases while shopping) in accordance with terms of an Agreement. Thus, a player must be made to understand that if she accepts an offer and obtains a benefit, then she is obligated to play a wagering game in order to pay back an amount based on the value of the benefit through appropriation of her winnings. Thus, in some embodiments, one or more gaming requirements are specified during the offer for the benefit, and may be included in the Agreement entered into by the player.

Gaming requirements may specify that the player must play a GD for a predetermined duration. The amount of play may be specified in various ways. For example, the Agreement may specify gaming requirements such as achieving a minimum number of outcomes (e.g., number of spins on a slot machine), an amount of money appropriated (for example, a player may required to continue gaming until at least $20 of his winnings have been appropriated), an amount of money wagered (e.g., measured in coins or dollars, for example, a player may be required to wager a total of at least $200), a minimum duration of play (e.g., 1 hour) and an associated rate of play (e.g., a minimum of 5 spins per minute of a GD), an amount of money won and/or lost (e.g., measured in coins or dollars, for example, a player may be required to win at least $100 gaming).

A gaming requirement may specify a deadline for the player to complete a required amount of play. The deadline may be specified as an offset from the time that a player accepts an offer (for example, the player must complete 6 hours of wagering game play within 48 hours of acceptance of an offer). In some embodiments, the deadline may be an event or the combination of an event and an amount of play (for example, the player must have a total of $50 appropriated (i.e., an amount of play) before the player checks out of his hotel room at the casino (i.e., a deadline)).

In some embodiments, a gaming requirement specifies a type of game machine. Such a gaming requirement may be helpful to casinos that wish to promote a certain type of GD, or if only certain GDs are capable of appropriating a player's winnings, or if the value of an agreement is dependent on the expected value of a player's gaming at a specific type of GD. For example, a player may be required to complete the gaming requirement of having $20 of his winnings appropriated on any of the “Rascally Rabbit” GDs that are located on the slot floor, or one of that type of GD located in a specific area of the casino.

8. Valuations

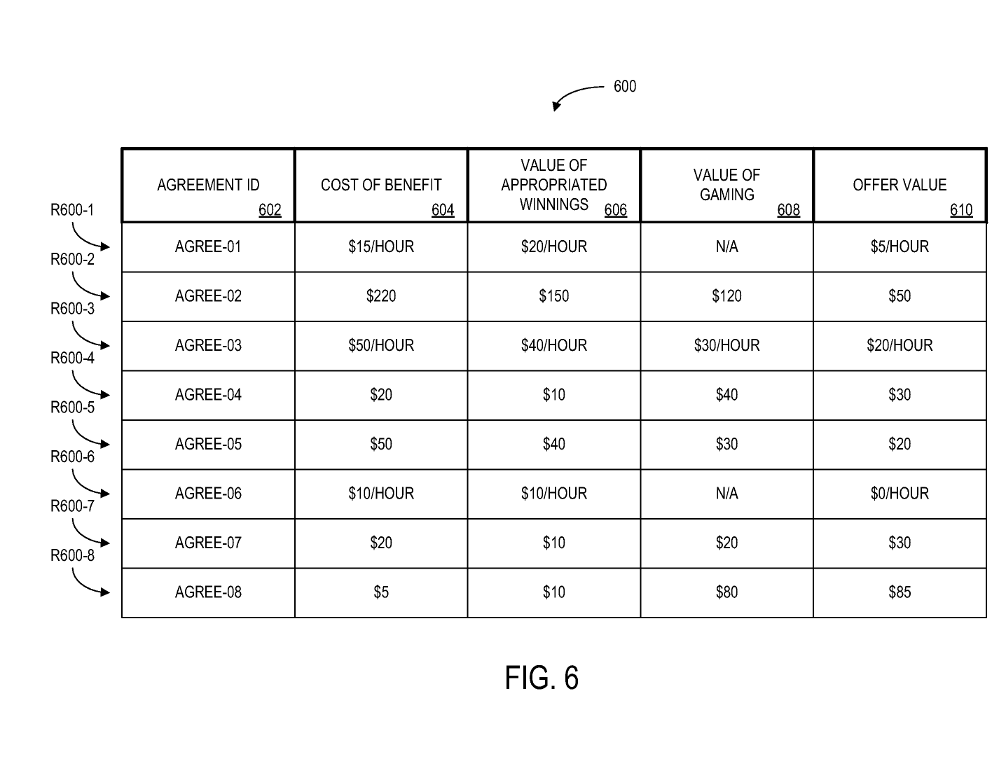

FIG. 6 illustrates an embodiment of an Agreement Valuation Database 600 that includes a plurality of agreement identifiers, benefit costs, and associated values. The data in the Agreement Valuation Database 600 can be used by a casino to keep track of the costs and values associated with a plurality of “Play It Off” agreements, to ensure that the appropriation schemes and one or more associated gaming requirements provide enough money to a casino (and to any affiliated entities) to make it worthwhile to provide benefits to players. In particular, the data can be used to calculate the total value associated with a player fulfilling the terms of an agreement.

Referring to FIG. 6, the database 600 includes entries corresponding to an Agreement ID 602, a Cost of Benefit 604, a Value of Appropriated Winnings 606, a Value of Gaming 608, and an Offer Value 610. As will be explained below, the data in the database 600 may be utilized to determine “Play It Off” agreements that include appropriation schemes and gaming requirements that are adequate to cover the value of a benefit that has been (or will be) provided to the player. It should be understood that, although the database of FIG. 6 is shown in tabular format, other types of formats, including but not limited to object-oriented formats, XML formats, and relational database formats, could be used.

For the example database 600 of FIG. 6, the Offer Value 610 is calculated using the following formula:

V=G+W−B
where:
   V=the Offer Value;
   G=the Value of Appropriated Winnings;
   W=the Value of Gaming (e.g., session win or session theoretical win); and
   B=the Cost of Benefit.

### It should be noted that the expected values of benefits, appropriated winnings, and gaming may be substituted where appropriate to obtain the expected value of an offer.

The Cost of Benefit may be calculated to include costs such as the retail price of the benefit (for example, the retail price of a pair of shoes), the cost of the benefit to a retailer (e.g., the price that a retailer pays to a manufacturer or distributor), the value of the benefit to a retailer (e.g., in the case of distressed or expiring inventory like show tickets or food products, which may be less than a retail price), the reimbursement cost of the benefit (e.g., the price that a casino reimburses a retailer for providing the benefit to a customer. It is noted that a casino may negotiate a discount off the retail price of a product), the cost of the benefit to a casino (for example, the theoretical expected cost of a feature on a GD), the value of the benefit to a casino (for example, distressed or expiring inventory like show tickets or food products). The cost of a benefit may include a restocking fee, a discount to casino based on a prior agreement, a licensing fee for implementing a feature on a GD, an expected value of other business that may be gained or lost based on providing the benefit (e.g., a customer who obtains a benefit of show tickets may be likely to buy a show souvenir or snacks after the show).

Row R600-1 of FIG. 6 includes data corresponding to a first agreement labeled AGREE-01. In this case, the cost of a benefit is $15 per hour, the value of the appropriated winnings is $20 per hour, the value of gaming is not applicable, and the offer value is therefore $5 per hour for this agreement. In another example, AGREE-05 in row R600-5 shows that the cost of the benefit is $50, the value of the appropriated winnings is $40, the value of gaming is $30, and the offer value is thus $20. Consequently, as shown in rows R600-2 to R600-7, other “Play It Off” agreement types include different entries as the benefit offered and the terms and conditions of these agreements (such as appropriation schemes and gaming requirements) are different, which results in different calculated values.

The anticipated winnings and/or the anticipated value of the gaming might be calculated based on the particular player's propensity to gamble or not, as inferred from their player tracking card status (e.g., if the player has a gold level or a platinum level player tracking card), prior gaming history, duration of hotel stay, and the like. For example, a normal, middle-class weekend visitor can be expected to generate a certain dollar value in theoretical win money for the casino, whereas a high-roller staying at the top property hotel suite for two weeks might generate a much higher dollar amount in theoretical win money for the casino. Such variables can influence the type of benefit offered to such players because different offers may be made, for example, to high-rollers because the value of gaming associated with such players will be higher.

An Agreement Valuation database 600 may be useful in helping a casino determine what benefit, appropriating scheme, or gaming requirement to specify when making offers to players. For example, as shown in row R600-2 of the database 600, the total amount of money appropriated from a player's winnings ($150) may be less than the cost of a benefit ($220), but this difference is offset by the additional value to be gained from the player's gaming ($120). Of interest is that the value of gaming shown in column 608 tends to be greater than the value of appropriated winnings shown in column 606. In such cases, it is more valuable for a casino to entice a player to keep on gaming for a long period of time so that a portion of the players winning outcomes are appropriated (until the player at least reaches his goal of “paying off the debt” for the benefit received), than it is for the casino to get the money “up front” or early in the gaming session. Such “Play It Off” agreements may also be beneficial to retailers, for example, who will now be able to sell products to players that a consumer ordinarily would not buy (for example, an upgrade to a more expensive product or service which is now affordable to the player because of a discount that was offered as a benefit for agreeing to gamble at the casino and have anticipated future winnings appropriated). It should be understood that the various “Play It Off” agreements and associated costs and values shown in the tabular database example of FIG. 6 are for illustration only, as many other types of agreements that include alternate associated costs and values are possible.

In some embodiments, a “Play It Off” agreement may specify a penalty that may be levied against a player if the player does not meet a gaming requirement. Such a provision may help to prevent players from ignoring agreed upon gaming requirements. For example, a “Play It Off” agreement may specify that a player should maintain a threshold rate of play, and if he does not maintain this threshold rate of rate of play, then the player may be penalized.

The value of a penalty may be based on the value of a benefit provided to a player. For example, a player may make an agreement and receive a benefit of a $50 discount on the purchase of a new luggage set. If the player does not complete a gaming requirement specified in the agreement (e.g., play a wagering game at least until a total of $30 of winnings are appropriated), then a charge is posted to that players' credit card account for either the full amount of $50, or some lower amount. While any value of penalty is possible, players may be hesitant to accept agreements that specify large penalties. It is thus anticipated that a player may prefer to make a payment guarantee that is approximately equal to or less than the value of a benefit that was provided, which should be an adequate incentive to insure that players will complete their gaming requirements.

Penalties may be assessed by taking money (e.g., charging a player's credit card), appropriating alternate currencies (e.g., subtracting comp points from a player's player account), denying services (e.g., preventing a player from accepting agreements in the future), and/or rescinding a benefit (e.g., deactivating a feature on a game machine). For example, a penalty may be levied against a player by charging a player's credit card or other financial identifier for an amount (e.g., debit card number, bank account number, hotel room number, player number).

A player may provide this financial identifier when making an agreement. For example, a player may make a “Play It Off” agreement while shopping to receive 50% off the retail price for a spa treatment (a $100 value), and provide her credit card number as a guarantee that she will perform sufficient gaming to reach a $100 of appropriated winnings. The agreement may further specify that 10% of her future winnings will be appropriated, up to a maximum of $100, and if she does not play enough to reach at least a $50 minimum of appropriated winnings (a gaming requirement), then her credit card will be billed for whatever amount is owed towards the value of the benefit provided to her plus a penalty. If she does at least reach the $50 minimum of funds appropriated, but does not have enough winning outcomes to cover the entire $100 amount owed, then her credit card will be billed for the difference (i.e., in this example, if she played a GD for a long enough duration to have $75 of winnings appropriated during her gaming session, then her credit card will be charged the difference of $25).

9. Making Adjustments

In some embodiments, a player may be able to make adjustments and/or modifications to an agreement after he makes the agreement. For example, if the player makes an agreement to have 1 coin appropriated from each of his prizes up to a total of 100 coins, he may realize later while a operating the GD that he would prefer to have a larger portion appropriated from each prize. Such a change will enable him to reach the termination condition (i.e., his goal for paying off the debt owed for obtaining the benefit) more quickly. The player may then operate a touch screen on the game machine to indicate that he would like 2 coins appropriated from each of his prizes. From this point forward the game machine may use a new “2 coins per prize” appropriation scheme for the player. In another example, the player may win a big prize on a GD, and thus may be presented with an option of paying off his debt immediately rather than continuing to have a portion of his future winnings appropriated. In yet another example, a player may realize that he needs to depart a casino earlier than expected and therefore he will not have time to complete a gaming requirement of 90 minutes of gaming. To solve this problem, the player may use his cell phone to call a 1-800 number and update his agreement to reduce the gaming requirement to only include 45 minutes of gaming. During the process of updating the agreement, the player may agree to a different appropriating scheme or benefit.

In some embodiments, adjustments may be made to any portion of an agreement, including the benefit, appropriating scheme, or gaming requirement. For example, the player decides that he would rather receive a benefit of obtaining a 3D graphics mode on a GD instead of guaranteed bonus round entries. The player may indicate the adjustments by using input devices of a GD, a kiosk, a POS terminal (which may be operated by a cashier), a personal computer, a cell phone, or other electronic device. In an example, a player may make a phone call to a 1-800 number and an interactive voice response (IVR) system may make any desired changes to his agreement.

In some embodiments, if a player requests a change to an agreement, such change may need to be approved. For example, an indication of the change may be transmitted to a GS or to a central server computer, and the GS may respond with acceptable updates to the agreement. In addition, a verification prompt (e.g., “Are you sure you wish to modify these terms of the Agreement?”) may be output to a player to verify that the player does indeed wishes to change the agreement. The player may respond to this verification prompt using an input device (e.g., a “yes” button on a touch screen).

10. Appropriating Winnings

In some embodiments, as described above, a player may make a “Play It Off” agreement and then receive a benefit at one location, and then travel to another location to engage in wagering game play to satisfy the terms of the agreement. For example, a player may purchase an article of clothing at a reduced price at a retail store during a Friday afternoon, wherein the player agrees to play a wagering game at a casino that is half a mile from the store before Sunday night until a predefined value is paid off out of the anticipated winnings according to terms of an agreement. In some embodiments, a player who makes such an agreement is provided with a receipt printed out by the POS terminal that includes an agreement identifier, which may be in the form of a bar code. The player then takes the receipt to a GD and inserts it into a bar code scanner of the GD, which operates to scan the agreement identifier. The GD may then use the agreement identifier to determine an agreement made by the player (e.g., by downloading information about the agreement from a computer server).

In some embodiments, at the start of a gaming session an event may occur that prompts the GD to determine if the player has entered into an agreement. For example, a player inserts his player tracking card or other type of player identifier into a reader device of the GD, then inserts money into the GD and requests a first outcome. Before providing regular play mode operation, the GD may inform the player via a display that an agreement is in effect that includes an appropriation scheme and possibly other terms that will govern game play.

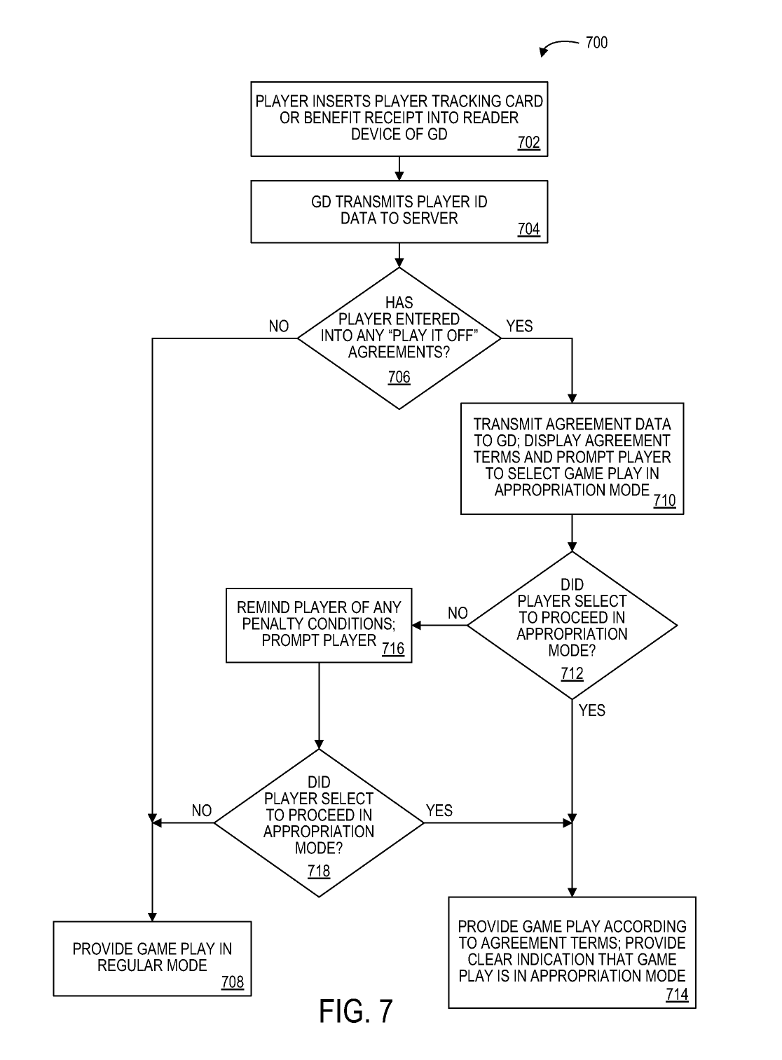

FIG. 7 is a flowchart 700 illustrating an embodiment of a process for determining that a player who is about to initiate wagering game play has entered into a “Play It Off” agreement associated with the receipt of a benefit, and if so, then appropriating a portion of at least one winning outcome in accordance with the terms of the agreement. In particular, in this example, a player inserts 702 a player tracking card or a benefit receipt (which may have been printed by a POS terminal) into a reader device of a GD when initiating game play. Next, the GD transmits 704 data from the player tracking card or receipt to a computer server (such as a GS), and the server then may search one or more databases to determine 706 if the player has made any “Play It Off” agreements. If the player has not made any such agreements, then the GD provides 708 wagering game play in regular mode.

But if the player did enter into at least one agreement (as explained herein, it is possible for a player to enter into multiple agreements that may or may not have the same or similar gaming requirements), then the GS transmits 710 agreement data to the GD (e.g., details of an appropriation scheme and any gaming requirements). The GD then indicates the terms of the agreement (for example, by showing them on a display screen, or by providing a menu on a display screen to enable the player to select one or more of a plurality of agreement terms to display, which in some cases may correspond to several agreements) that the player agreed to in order to obtain a benefit. This serves as a reminder to the player of any “Play It Off” agreements that are in effect. The player is prompted to select game play in an appropriation mode. If the player selects to proceed in appropriation mode 712, then the GD provides 714 the wagering game according to the terms of the agreement, and also clearly indicates that game play is proceeding under appropriation mode. If the player does not select to proceed in appropriation mode in step 712, then the player is reminded of any penalty conditions 716 that may be imposed and is again prompted to select wagering game play under appropriation mode. If the player then changes his mind and selects 718 to continue in appropriation mode, then the process again branches to step 714 wherein the GD provides the wagering game according to the terms of the agreement, and the player is given a clear indication that game play is proceeding under appropriation mode. If the player does not change his mind in step 718, then the GD provides 708 wagering game play in regular mode.

In some embodiments, before engaging in wagering game play, the player provides at least one identifier input to the GD. For example, a player may provide one or more indications such as a player identifier (e.g., player tracking card number), a financial identifier (e.g., a credit card number), a biometric indicator (e.g., a topical face scan), and/or an agreement identifier (as shown in FIG. 4). Use of a biometric indicator (e.g., a fingerprint, a retinal scan, topical facial scan) as a player identifier may be advantageous because it allows players to be identified “passively”, without requiring the player to produce a card or a paper identifier, for example. This may be desirable in some circumstances, since players who receive up-front benefits may be less inclined to actively tender identifying information (for example, a player tracking card) later on when gambling, because they know that a portion of any winnings may be appropriated according to the agreement that they made. By passively identifying customers through biometric indicators, potentially all customers with in-place agreements can have a portion of their winnings appropriated, without requiring such customers to tender a player ID prior to gaming at a GD. In some embodiments, one or more of these identifiers, or a combination thereof, could be used to retrieve information about an agreement from a database.

In some embodiments, a GD may not have a network connection or may not be operable to use a network connection to determine information about an agreement (e.g., in some systems, the network connection is dedicated to sending gaming information to a gaming server and provides no downstream pathway for providing any other information). But it may still be possible for the GD to identify an agreement made by a player, and to impose the agreement terms on game play. For example, the player may make an agreement at a GD and then have his winnings appropriated at the same GD. In another example, the player may make an agreement at an alternate location (e.g., a POS terminal) and then receive a receipt that includes encrypted information (e.g., encrypted using public-key encryption) such as an encrypted bar code or magnetic stripe, wherein the receipt is inserted into a reader of a GD which reads the encrypted information into the GD (e.g., by scanning a bar code). The GD may then use this information to access internal data to determine how to appropriate a player's winnings and/or any gaming requirement that must be fulfilled by the player. In an alternate example, an agreement identifier (e.g., a number) is provided to the player at a POS device, and the player inputs this number by using a keypad of a GD to provide the agreement identifier to the game machine. The GD may then be operable to match the agreement identifier to a record stored in an internal database on the GD (e.g., an agreements database of standard agreements, such as that shown in FIG. 4), and then proceed to determine a benefit (i.e., a gaming feature), appropriating scheme, or gaming requirement for the player based on the matched record.

After the GD determines if a player has an existing agreement, and (if applicable) determines the necessary details of this agreement, the GD proceeds to implement an appropriating scheme specified in the agreement. The process of appropriating a player's winnings may include determining whether an appropriating scheme is active (for example, a player may have already completed a gaming requirement, or reached a termination condition specified in a appropriating scheme. In this case, no additional appropriating of a portion of winning outcomes should be performed.), identifying the occurrence of a condition for appropriating (e.g., a player wins a prize of at least 10 coins), identifying a prize to be appropriated (e.g., a prize of 18 coins), and determining an amount to appropriate from the prize (e.g., 2 coins). It should be noted that an amount appropriated from a prize may be determined based on the prize value (e.g., only prizes of 10 coins or more), the winning outcome (e.g., appropriating from outcomes that include lemons), or other factors (e.g., a player's credit balance). Fore example, a player may make an agreement that specifies that a portion of his winnings will be appropriated at a rate of 10%, up to a total of 100 coins. If the player has had 96 coins appropriated and wins a prize of 200 coins, only 4 coins will be appropriated from the prize of 200 coins.

In some embodiments, appropriating a portion of winning outcomes includes determining a remaining portion of the prize to be provided to the player (e.g., 18 coins original prize—2 coins appropriated

=16 coins remaining). The remaining portion may be determined based on a prize won by the player and an appropriating scheme. The process may also include providing the remaining portion of the prize to the player (e.g., adding the remaining portion of the prize to the player's credit balance), storing an indication of the appropriated amount (e.g., in a database, which data may be used to reconcile accounts between the provider of the benefit and the operator of the GD), storing an indication of the remaining portion of the prize (e.g., in a database, or by adding the remaining portion of the prize to the player's credit balance), and/or crediting a prize to a player's credit balance and appropriating a portion of the player's credit balance (for example, a player may win a prize of 14 coins, from which 1 coin should be appropriated according to a appropriating scheme. The prize of 14 coins may be credited to a player's credit balance, bringing his total credit balance from 50 coins to 64 coins. Next, after a short delay (such as a 1 second delay), 1 coin may be appropriated from the player's credit balance, bringing it down from 64 coins to 63 coins.). This latter embodiment may be helpful in making it clear to a player than he has in fact won a prize of 14 coins and has had 1 coin appropriated according to the terms of his agreement.

In some embodiments, appropriating a player's winnings may include altering a pay table on a GD and/or changing the odds for a particular wagering game. For example, a player may make an agreement to have 1 coin appropriated from every win of 10 coins or more. Based on this information, an alternate pay table may be created for the player that has prizes reduced by 1 coin for outcomes that normally pay 10 coins or more. Thus, an altered pay table may be created based on an agreement (e.g., when a player starts a session on a GD), and an altered pay table may be associated with a player. Thus, when the player cashes out of a first GD and moves to a second GD, the altered pay table may be loaded onto the second GD for the player. Alternately, the odds of winning may be changed such that the player, over time, will win a bit less often for a predetermined duration, and the reduced odds may also be associated with that player and utilized whenever the player is playing in an appropriation mode.

In some embodiments, appropriating a player's winnings may include altering a pay table on a GD and/or changing the odds for a particular wagering game, and/or changing the rules or altering the conditions associated with winning outcomes. For example, a player may make an agreement to have 1 coin appropriated from every win of 10 coins or more, and wherein the rules for winning outcome are changed so that fewer winning combinations that will result in sub-10 coin winning outcomes are possible. The odds of obtaining some jackpots may also be changed, making such winning outcomes more unlikely to occur. Thus, the overall odds of winning small jackpots and relatively large jackpots may be changed such that the player, over time, will win a bit less often for a predetermined duration, and such probabilities, rules and appropriation schemes may also be associated with a particular player and “follow” that player to each GD that the player utilizes in an appropriation mode. Consequently, one or more gaming conditions may be altered and/or modified for the player according to the terms of an agreement. Such altered gaming conditions may include providing an altered pay table, a modified payout scheme, an altered probability table, a modification to the odds of obtaining winning combinations, and/or a modification of the types of winning combinations that are possible. Each of these altered gaming conditions may be customized to a particular type of GD, and may be modified again as appropriate, for example, if the player decides to wager on another type of GD.

In some embodiments, a GD may monitor a player's progress towards reaching a termination condition for an appropriation scheme or for completing a gaming requirement. For example, an appropriation scheme may continue to be in force for wagering game play until a player has had $20 in winnings appropriated (a termination condition). In another example, a gaming requirement may be that the player operates a GD for at least 90 minutes within the next 48 hours.

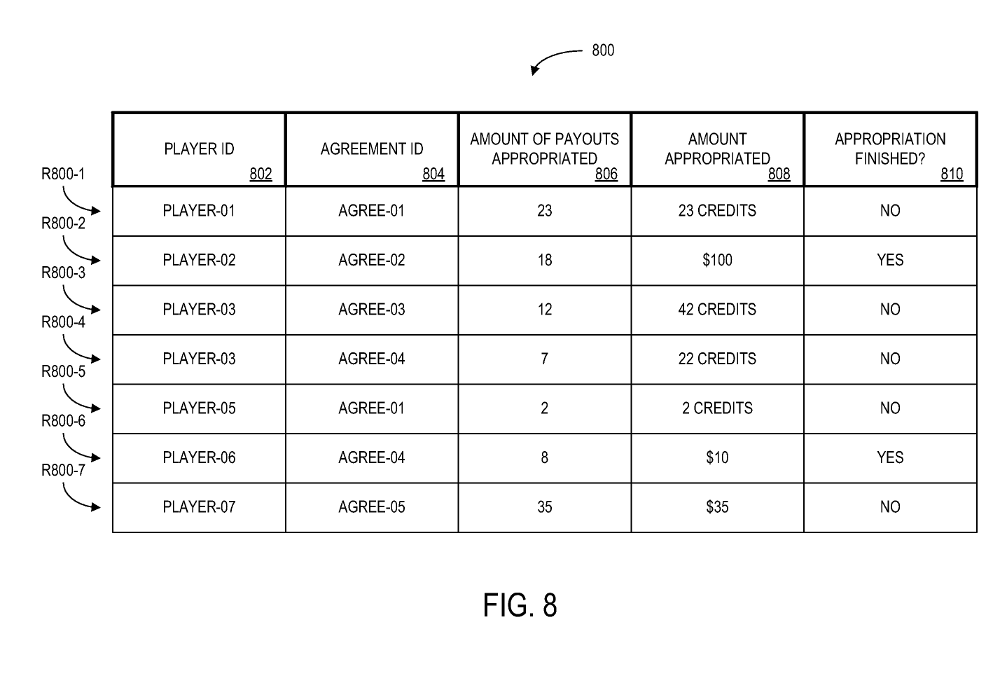

A GD or a computer server may store information about a player, the player's gaming, any agreements and terms thereof, for example, in one or more databases. FIG. 8 illustrates an example of an embodiment of an appropriation tracking database 800. The appropriation tracking database includes columns for holding entries concerning a player ID 802, Agreement ID 804, Amount of Payouts Appropriated 808, and to indicate if an Appropriation Finished 810. Rows R800-1 to R800-7 contain entries for players who have accepted offers for benefits and are now playing wagering games under one or more agreements. For example, with reference to row R800-1, PLAYER-01 has entered into an agreement AGREE-01 and thus far has had 23 prizes appropriated and 23 credits appropriated, but has not finished paying back the debt to the benefit. In contrast, PLAYER-02 (see R800-2) has played under agreement AGREE-02 with a portion of 18 prizes appropriated totaling a value of $100, and thus appropriation has finished for this player. As shown in rows R800-3 and R800-4, the same player, PLAYER-03, has entered into two agreements simultaneously (AGREE-03 and AGREE-04), and has had portions of 12 prizes and 7 prizes totaling 42 credits and 22 credits appropriated. However, PLAYER-03 has not yet satisfied either agreement, and thus must continue playing a wagering game and having portions of his winning outcomes appropriated until reaching a termination condition. In contrast, PLAYER-05 has entered into agreements AGREE-04 and AGREE-05 (see rows R800-6 and R800-7), and has had portions of 8 prizes and 35 prizes appropriated, wherein AGREE-04 has been satisfied but AGREE-05 has not yet been satisfied.

It should be noted that some players may enter into multiple agreements, and in some embodiments, a GD may implement two or more appropriation schemes simultaneously. Alternatively, one appropriation scheme may not start until a previous appropriation scheme has finished (thereby limiting the amount of the portion of winning outcomes taken by the casino, to prevent a player from having too much of his winnings appropriated at one time, and to extend the player's gaming session).

When a player satisfies all the conditions of an agreement, then she met her obligations and has earned a termination condition of the appropriating scheme. Thus, in an embodiment, a message is presented to the player to inform her that a portion of her future winnings will no longer be appropriated under that particular agreement, and the Appropriation Finished field of the tracking database 800 is updated to reflect this new status.

11. Termination Conditions

The appropriation of a portion of a player's winning outcomes may be terminated or stop in response to a termination condition. A particular termination condition may be based on factors such as a total amount to appropriate (e.g., appropriate winnings up to a total of $10 appropriated), a number of outcomes generated (e.g., stop appropriating after 200 spins), a duration of time (e.g., stop appropriating after 60 minutes, stop appropriating at 3 pm), a number of prizes won (e.g., only appropriate from the first 20 prizes won by a player), a specific outcome (e.g., stop appropriating immediately if the player lines up Cherry-Cherry-Cherry icons on a slot machine as an outcome), an event occurring at a GD (e.g., an activated feature is no longer available), an indication by a player (for example, a player may use an input device on a game machine to indicate that he would like to stop the appropriating from continuing).

In some embodiments, the appropriation of a portion of a player's winning outcomes may continue until a termination condition occurs or a gaming requirement is complete. In particular, an appropriating scheme may specify a termination condition and/or a gaming requirement, which may be monitored by a GD. When the termination condition occurs or the gaming requirement is satisfied, the appropriation of a portion of winning outcomes may stop, and a player may have completed the terms of an agreement.

In some embodiments, it may be possible for a player to request to pause appropriation under the agreement (i.e., continue to play in a regular mode instead of in an appropriation mode) and/or to terminate the agreement. For example, a player may indicate that he would like to terminate an agreement because he is no longer interested in obtaining an ongoing benefit, or because the player would like to switch to a different appropriation scheme. In some cases, the player may prefer to receive a penalty (e.g., as specified in an agreement) instead of having his winnings appropriated according to an agreed upon appropriation scheme. In other cases, the player may wish to pause use of the appropriation scheme and just play the GD in a regular mode.

In order to terminate an agreement, or to modify it, or to pause use of the appropriation scheme, in some embodiments a player may use an input device (e.g., button, touch screen) to provide the indication to the GD. For example, a player may select a menu option on a GD touch screen display that is presented as a button that reads: “Pause Appropriation” (the GD would then continue in a regular mode of play, and thus the player has effectively postponed carrying out wagering game play under the agreement. In some embodiments, a menu selection could be made available to the player as a menu option button, for example, that reads “Resume Appropriation”, to enable the player to then continue GD operation under the terms of the agreement). In another example, the player may deactivate a feature on a GD that was being provided to the player as a benefit. In yet another example, a switch or menu option may be available for selection by the player labeled “Terminate Agreement”, or the player may simply press the “cash out” button on a GD (in the latter case implementation, simply cashing out of the GD terminates the agreement). Such embodiments may be particularly helpful in keeping players happy by preventing them from feeling that they are stuck in undesirable appropriation schemes with no way out.

In some embodiments, a verification prompt (e.g., “Are you sure?”) may be output to a player to clarify that the player does indeed want to terminate an agreement. Such a verification prompt may include information about a penalty that may be levied against the player for terminating the agreement. For example, a message such as “If you terminate the agreement now, you'll be charged full price for the spa treatment that you received as a benefit when you signed up for the agreement” may be displayed. The verification prompt may include information about a benefit that the player may no longer receive after the agreement is terminated. For example: “If you terminate the agreement now, you will no longer be guaranteed at least one entry into the bonus round every hour.” The verification prompt may also include details about the agreement or information about when an agreement would naturally terminate (e.g., “Are you sure? You only need to have 6 more coins appropriated in order to finish your gaming requirement.”). In some embodiments, the player responds to a verification prompt by using an input device (e.g., a “yes” button on touch screen).

In some embodiments, if a player manually terminates an agreement or does not comply with a gaming requirement described in an agreement, then a penalty is enforced against the player. The value of a penalty may be based on the value of a benefit that was provided to a player (e.g., a player may be charged the full cost for a benefit that he received at an earlier point in time). In addition, enforcing a penalty against a player may include charging an amount to a player's financial identifier (e.g., credit card number, hotel room). Also, the value of a penalty may be determined based on a player's gaming activity. For example, if a player makes an agreement to have $100 of his winnings appropriated on a GD, and after having $80 of his winnings appropriated, the player terminates the agreement, then based on the player's appropriated winnings, the player may only be penalized $20 (the difference $100-$80).

As mentioned above, in some embodiments a player may have an option to temporarily pause the appropriation of a portion of winning outcomes. A button or a switch on a GD may be available to the player to select between an appropriation mode (i.e., the player presses a button on the GD labeled “Apply Agreement”) and a regular mode of operation (i.e., by pressing a button labeled “Pause Agreement”). If the player wishes to resume using an appropriation scheme after having paused it, the player may provide a second indication (i.e., by flicking the switch back to “Apply Agreement”).

In some embodiments, when the player pauses use of the appropriation scheme, the player's game play does not count towards a gaming requirement (e.g., if a player is supposed to operate a game machine for 90 minutes). In some embodiments, while appropriating is paused, a player may no longer receive a benefit (for example, a feature on a GD may be deactivated while appropriating is paused). In such cases, a message may be output to a player to indicate the consequences of gaming while appropriating is paused (e.g., a benefit may be disabled, a player's gaming may no longer count towards a gaming requirement). In some embodiments, a player may choose to pause appropriation of a portion of winning outcomes if he is concerned about the cost involved or because he is no longer interested in receiving a benefit. For example, the player may temporarily deactivate or pause a feature on a GD that he initially wanted.

If a player reaches a termination condition of an appropriation scheme, or completes a gaming requirement specified in an agreement, a congratulatory message may be output to the player. For example, a message such as: “Congratulations! You're completed your gaming requirement! Your spa treatment has been paid in full, and a portion of your winnings will no longer be appropriated!” In some embodiments, an additional benefit (e.g., one not specified in an agreement) may be provided to a player when a player finishes a gaming requirement. For example, the player may receive 3 free spins on a GD as a complimentary reward for completing her obligations according to the agreement, and the player may be provided with another congratulatory message.

### 4. Indications During Gaming

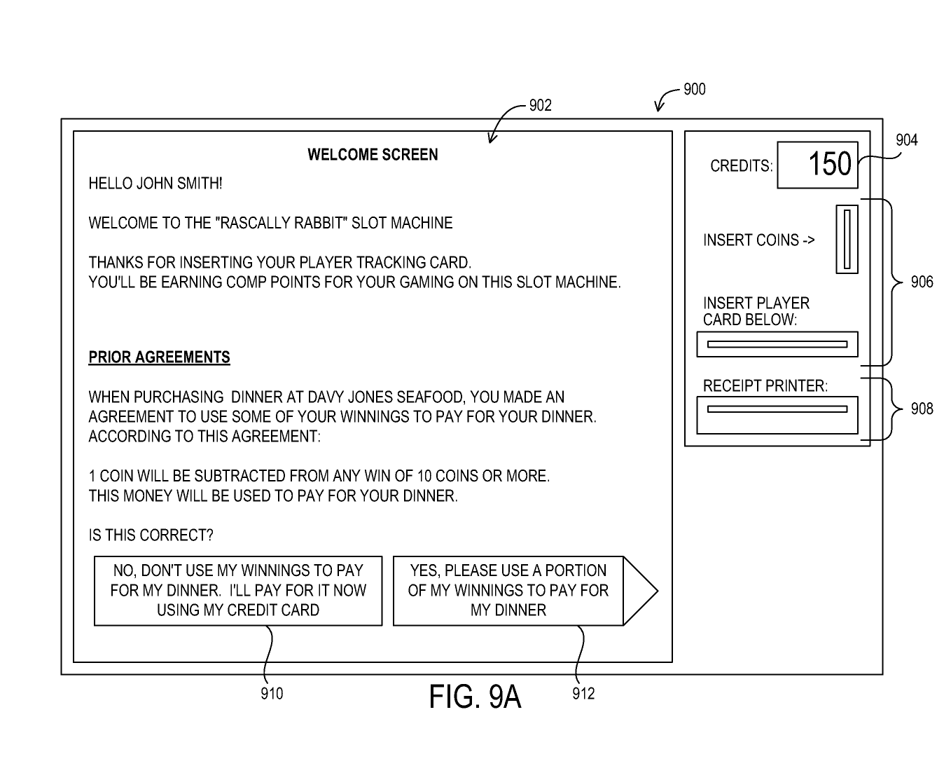

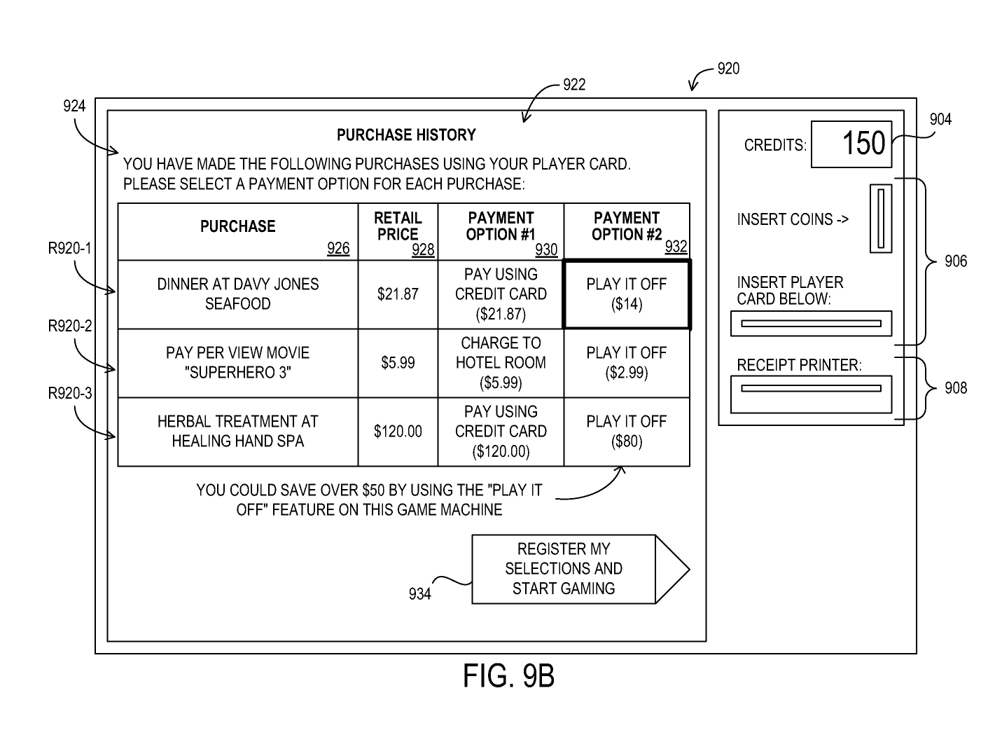

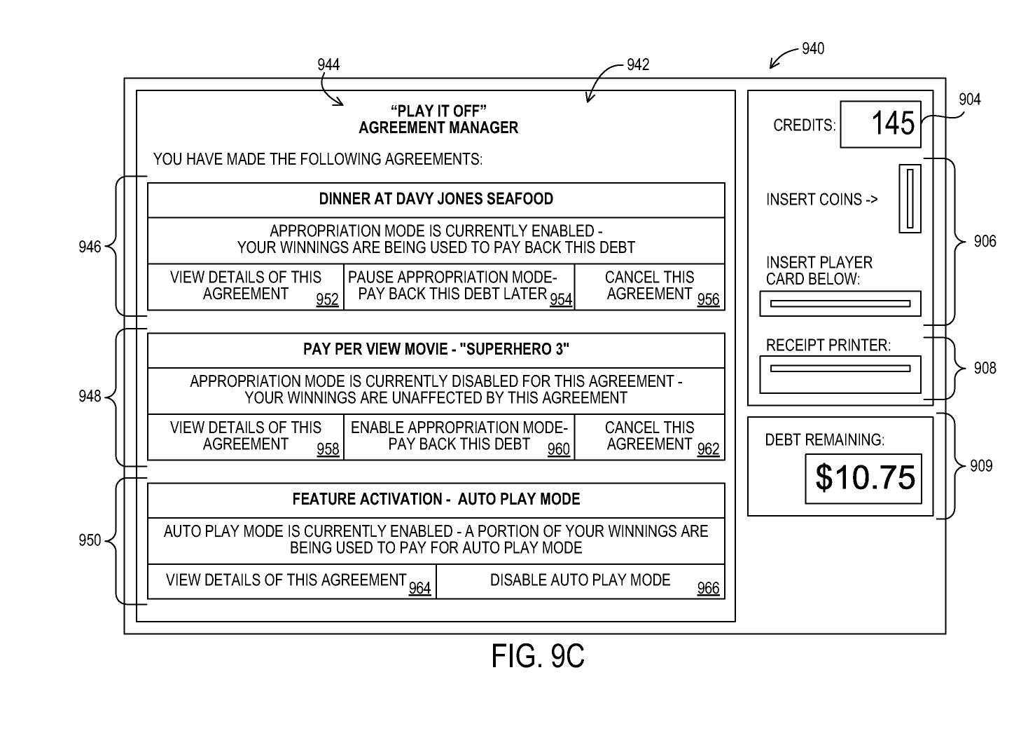

It is anticipated that some players may forget the terms of an agreement, or even forget that they made an agreement at all, when they visit a casino to begin wagering game play. Consequently, to avoid confusion, concern and/or anger by a player when he realizes that a portion of his winnings are being appropriated, an indication that a portion of that player's winning outcomes is being appropriated in accordance with an agreement may be output to a player. FIG. 9A is a simplified drawing of an embodiment of a front panel 900 of a GD, showing a touch screen display area 902, a credit meter 904, a payment and identification input area 906, and a receipt printer slot 908. The display area 902 is displaying a “Welcome Screen” which is provided when the player first initiates wagering game play on the GD. The message welcomes the player by name (John Smith), which information was obtained in this example from a player tracking card, and a reminder message that he made a prior agreement to pay for his dinner by having a portion of his winning outcomes appropriated. A first touch screen button 910 may be selected by the player to indicate that he'd rather pay for the dinner now by credit card, and a second touch screen button 912 may be selected to affirm that the player wishes to have a portion of winning outcomes appropriated according to the terms of his “Play It Off” agreement.

Thus, a GD may display a message on a display screen that may include a reminder of the benefit that the player has received (or is currently receiving, such as a gaming feature), a description of the agreement terms (e.g., the appropriation scheme, the amount owed, and any gaming requirement or penalty conditions), an indication of a current amount that has been appropriated (e.g., “1 coin was appropriated from your current prize”, or “5 coins were appropriated from this payout due to a previous agreement you made; Press here to see information about this agreement”), an indication of a total amount appropriated (e.g., “You have had $5.45 appropriated so far”), an indication of why a portion of a prize was appropriated (e.g., “1 coins was appropriated because your prize value was greater than 10 coins”), an indication when a portion of a prize was not appropriated (e.g., “This prize wasn't appropriated because it was less than 10 coins”), and/or an indication of the value of a benefit (e.g., “You've earned $28 off the retail price of a portable DVD player”). It is noted that an indication of a player's progress in obtaining a benefit may be particularly appealing to players when the value of the benefit is based on a player's gaming activity.

In some embodiments, the player may be able to transmit a message (for example, send an email message or make a telephone call to an 800 number) to ask a question and/or to register complaints about how, why, and/or when a portion of his winning outcomes is being appropriated. Such a feature may help diffuse the anger of a player who is upset because of a losing streak, for example, or who wishes to complain about the appropriation process (i.e., because he perceives either that too much money is being appropriated from his winnings, or that the appropriation scheme that he agreed to is not being followed properly). It also provides a method for players to question some or all of the terms of the agreement that they entered into in exchange for receiving a benefit.

An indication of the appropriation scheme that is being used may be output and/or provided to a player in response to various events at a GD. In some embodiments, such an indication may be output when a player first starts a gaming session, when a player inserts his player tracking card into a GD, when a player inserts money into a GD to either begin a gaming session or to continue with one, when a bet is placed, when an outcome is generated (e.g., during the spinning of the reels on a slot machine; after the reels on the slot machine stop), when a player wins a prize, when a portion of a prize is appropriated, every 5 minutes or at some other predetermined interval, when a player activates a feature on a GD (e.g., customizable reel symbols), when a player cashes out of a wagering game (e.g., an indication of an appropriated amount, and/or the appropriation scheme may be printed on a player's cashless gaming ticket), and/or when a player pauses a gaming session (e.g., an indication that the appropriation scheme will be enforced again when the player again plays the wagering game).

In some embodiments, a GD may output an indication such as providing a message on a display screen that relates to one or more termination conditions or to one or more gaming requirements. For example, a GD may provide an indication of a termination condition like “The appropriation of a portion of your winnings will stop after 40 spins”, an indication of a gaming requirement like “You need to play for at least 90 minutes during the next 48 hours”, an indication of the progress made towards obtaining a termination condition such as “You need to have an additional $21 appropriated to complete the terms of your agreement.”, and/or an indication of progress made towards completion of a gaming requirement, such as “You're 64% done with the gaming requirement of 250 spins”.

In some embodiments, a GD may be configured to have a plurality of display devices such as credit balance meters, debt meter balance meters, and/or gaming requirement meters (for example, see the GD shown in FIG. 1A). For example, as mentioned above, a GD may have a credit balance meter that displays a number of credits in the player's possession, and a debt meter that displays a number of credits owed by a player. As the player wins prizes and has a portion of his winnings appropriated, the number shown on the debt meter may decrease until it eventually hits zero, which may indicate that the player has completed his gaming requirement. It is contemplated that players will find it encouraging to watch a debt meter value go down as portions of their winning outcomes on the GD are appropriated.

In some embodiments, the GD may display supplementary credit meter balances. For example, the GD may display an amount that has been appropriated (e.g., “You have had 52 credits appropriated so far”), a total amount to be appropriated (e.g., “According to your agreement, $20 of your winnings will be appropriated”), an amount that remains to be appropriated (e.g., “Only 24 more credits to be appropriated before you're done with this agreement”), a debt amount owed by a player (e.g., “You owe 24 credits according to the agreement you made on Apr. 10, 2006 at 5 pm”), a gaming requirement (e.g., “You need to wager at least 100 credits”), an amount that remains in a gaming requirement (e.g., “You need to wager 54 credits before you've satisfied your gaming requirement”; “You're 38% done with your gaming requirement”), and/or a benefit that may be provided to the player (e.g., “You've earned a rebate of $24 off of your spa treatment”).

In some embodiments, a player may make multiple agreements and thereby receive multiple benefits for agreeing to multiple agreement terms, which may include one or more appropriation schemes and/or gaming requirements. FIG. 9B is a simplified drawing of an embodiment of a front panel 920 of a GD, showing a touch screen display area 922, a credit meter 904, a payment and identification input area 906, and a receipt printer slot 908. In this case, the touch screen display area 922 is showing a purchase history 924 associated with the player. Listed in rows R920-1 to R420-3 are data concerning each purchase 926, including the retail price 928, a first payment option 930 and a second payment option 932. In particular, in row R920-1, the dinner at Davy Jones Seafood restaurant had a retail price of $21.87, which can be paid by credit card now or by using the “Play It Off” option wherein $14.00 will be appropriated from winning outcomes. The player merely touches one of the two option boxes in wither of option one column 930 or option two column 932 to choose which option is preferred, and then the selected box is highlighted (for example, as shown in FIG. 9B by dark lines around the box in the second option column called “Play It Off ($14)”). Similarly, the player may choose to pay the $5.99 charge for the pay per view movie by having his hotel room charged, or “Play It Off” by having $2.99 appropriated; the player may choose to pay for the herbal treatment by credit card for $120 or by choosing to “Play It Off” by having $80 of his winnings appropriated. Once the player has made his selections, he registers them by pressing the touch screen button 934 and then starts gaming.

It may also be helpful to a player to view a display of a list of agreements, their appropriation schemes, and/or the gaming requirements. Thus, FIG. 9C is a simplified drawing of an embodiment of a front panel 940 of a GD similar to that of FIG. 9A, showing the touch screen display area 942, credit meter 904, payment and identification input area 906, receipt printer slot 908, and a debt meter 909. In this case, the touch screen display area 942 is displaying a “Play It Off Agreement Manager” 944 that provides information and selection possibilities to the player. In this example, the player has made three “Play It Off” agreements 946, 948 and 950. In the first agreement 946, appropriation mode is currently enabled so that the player's winnings on the GD are being used to pay back his debt. The player can press touch screen button 952 if he wishes to view details of the agreement, button 954 if he wishes to pause the appropriation mode, and button 956 if he wishes to cancel the agreement. Similarly, for the agreement 948 concerning the pay per view movie, a message indicates that appropriation mode is currently disabled so that any winnings by the player are unaffected at the present time. The player may press touch screen button 958 if he wishes to view details of the agreement, button 960 if he wishes to enable the appropriation mode to pay back the debt, and button 962 if he wishes to cancel the agreement. Lastly, with regard to the agreement 950 concerning the auto play mode feature, the feature is currently enabled and a portion of winnings is being appropriated. The player may press touch screen button 964 if he wishes to view details of the agreement, and may press button 966 if he wishes to disable the auto play mode of operation (which will effectively cancel the agreement). When the player presses any of the buttons concerning viewing details of the agreements, in addition to displaying the various terms and conditions associated with each one, the progress made (if any) towards completing or satisfying the terms of each “Play It Off” agreement may also be displayed.

In some embodiments, when a player enters into multiple “Play It Off” agreements, the player may choose which, if any, to use when playing a GD in appropriation mode as discussed above. In other embodiments, the casino may pick which of the agreements to enforce first, for example, the casino may require a player to pay off the debt associated with a particular agreement (which may be the one with the largest debt owed), or may choose the one with the most gaming requirements, or may rank the agreements to be paid off in an order that is the most desirable to the casino, to the player or to some third party.

### 5. Additional Descriptions Of Some Embodiments

A. Alternate Appropriation Schemes

1. Appropriating from a Credit Balance

In some embodiments, a player may make an agreement to receive a benefit in exchange for agreeing to have a portion of his credit balance on a GD appropriated. For example, a player who is shopping at a retail store may get a 100% discount on a necktie (retail value of $20) in exchange for agreeing to have $15 appropriated from his credit balance when he next plays a GD operated by a particular casino (which translates into a savings of $5 off the retail price). If the player agrees, then on his next visit to the casino he will insert payment into a GD, and $15 may be appropriated at that time from his credit balance to pay for the necktie.

In some embodiments, a portion of a player's credit balance may be appropriated in response to an appropriation condition or event that either is or is not specified in the agreement. For example, a portion of the player's credit balance may be taken immediately after a player inserts money into a GD. In this case, when the player inserts the money into a GD a message is displayed to remind the player about an agreement he made, and then a portion of the money the player inserted into the GD is appropriated. Such operation may be particularly helpful in preventing problem gamblers from spending too much money on wagering game play.

In some embodiments, a portion of the player's credit balance may be taken when a player inserts his player tracking card into a game machine, and/or when a player wins a prize on the game machine. (It is anticipated that players will be more willing to have a portion of their credit balance appropriated immediately after winning a prize.) In an implementation, a share of a player's credit balance may be taken based on at least one outcome on a GD (e.g., a series of wins or losses), when a player's credit balance on a GD reaches an upper threshold value (for example, a player may make an agreement to have $20 appropriated from his credit balance, and the GD may automatically appropriate this $20 after the player wins a prize that pushes his credit balance above $100), when a player's credit balance on a GD reaches a lower threshold value (for example, a player may make an agreement to have $20 appropriated from his credit balance, and if his balance falls to $20, then the remaining portion of the player's credit balance may be appropriated). Such operation may be particularly helpful in preventing players from running out of money before a sufficient amount of money has been appropriated from their winnings), and/or when a player cashes out of a GD.

In some embodiments, an amount that is appropriated from a player's credit balance may be determined based on the value of the player's credit balance, another value specified in the agreement made by the player, and/or an amount that has already been appropriated from the player (e.g., by appropriating a portion of a player's winnings). In some embodiments, the player may be prompted to insert more money into the GD to avoid having his credit balance on the GD appropriated at that moment, which may be particularly advantageous for implementations where the appropriation scheme otherwise calls for taking a large portion or all of the player's remaining credit balance because it has decreased below a predetermined minimum threshold level. For example, an agreement may specify that 50 credits will be deducted from the player's credit balance if it falls below 100 credits during play of the GD. Thus, if the player's credit balance falls from 105 credits to 95 credits after a non-winning outcome, a message may then be presented to the player that reads: “Your Credit Balance is Below 100 Credits, to Avoid Appropriation of 50 Credits Insert Payment Now!” The player may then choose to insert $20 dollars into a bill validator, for example, that is associated with the GD to increase his credit balance. Consequently, such an option may encourage the player to continue to play the wagering game rather than give up and walk away from the GD (or cashout his remaining credit balance and then walk away).

In some embodiments, an amount that is appropriated from a player's credit balance may be determined based on the value of the player's credit balance. For example, in an implementation if the player's credit balance is greater than 100 credits, then appropriate 2 credits from every winning outcome of 10 credits or more, but if the player's credit balance falls below 100 credits, then appropriate only 1 credit from every winning outcome of 10 credits or more. In this implementation, the player may be warned that if his credit balance falls below 50 credits, then twenty credits will be appropriated towards satisfying his obligation (if the obligation is, for example, 50 or more credits at that point in the player's gaming session), unless the player chooses to insert more money into a bill validator, for example, that is associated with the GD to increase his credit balance. Such a process may prolong the player's gaming session, and encourage the player to continue to play the GD rather than give up, cash out his remaining credits, and then walk away when his credit balance falls below a predetermined threshold value.

In some embodiments, the amount owed by the player is appropriated from a player's credit balance at the time of cashout. In other embodiments, the amount owed by the player is appropriated by a casino cashier when a player presents his cashout ticket (printed out by the GD) to exchange it for money (for example, the cashier scans a barcode on the cashout ticket before handing over any money and is informed that the player owes a certain amount of money according to a “Play It Off” agreement. The cashier then communicates the information to the player and appropriates the amount owed). Such processes permit the player to have full use of all his credits for wagering until he decides to end his gaming session. In some embodiments, if the player either does not have enough credits remaining at cashout to pay back his debt, or if his credit balance falls to zero, the GD may display a message warning the player that he still has an outstanding debt and prompting him to either insert further payment to continue wagering and/or to pay off the debt by charging one of the player's financial accounts (such as a credit card account).

It is noted that a GD may be configured to appropriate both a portion of a player's winnings and a portion of a player's credit balance. For example, a player may make an agreement to have 1 coin appropriated from any win of 10 coins or more, up to a total of $10. But if the player has had $5.40 appropriated and his credit balance falls below $5, then the GD may operate to appropriate $4.60 from the player's credit balance in order to make up the difference between the player's gaming requirement ($10 total appropriated) and the amount that has been appropriated so far ($5.40). Such operation may be particularly helpful in preventing a player from running out of money before meeting a gaming requirement. This method of appropriating from a secondary source if certain conditions are met may be described in detail in the player's agreement.

In some embodiments, a benefit may be provided to a player based on an appropriation condition that specifies taking a portion of the player's credit balance under certain circumstances. For example, in response to an appropriation condition, a GD may appropriate a portion of a player's credit balance and also dispense a rebate check to a player. For example, a player with a credit balance of $80 may cash out of a GD, and if the player made an agreement to have $20 appropriated, then the player may receive $60 in credits and a $20 gift certificate to a retail store.

2. Appropriating Comp Points

In some embodiments, a player may make an agreement for a benefit in exchange for agreeing to have a portion of his comp points appropriated as they are awarded. For example, a player may normally earn comp points at the rate of 1000 points per hour. However, in exchange for a benefit, the player agrees to have 40% of his comp points appropriated as they are awarded, up a total of 5000 points. According to this agreement, the player will earn 600 comp points per hour (40% less than usual). In another example, comp points may be appropriated from a player at various times. For example, one or more of various trigger conditions, which have been described herein, may occur to prompt appropriation of comp points, and/or comp points may be appropriated as the comp points are awarded to a player (e.g., comp points may be awarded after each spin, or after a predetermined number of spins), when a timer reaches a threshold value (e.g., comp points appropriated every 10 minutes), when a counter reaches a threshold value (e.g., comp points appropriated after every 10th spin), and/or when a player cashes out of a GD (e.g., comp points appropriated at the end of a players session).

An appropriation scheme for appropriating a portion of comp points may specify an amount to appropriate, which may be specified as a fixed value (e.g., 1 comp point appropriated each spin), a percentage of comp points awarded (e.g., 10% of comp points awarded will be appropriated), and/or a maximum amount to appropriate (e.g., up to a total of 10,000 comp points).

It is contemplated that appropriation of comp points may be particularly appealing to some players as these players do not view comp points as valuable, and are therefore more willing to have them appropriated. In addition, some players may not notice or care too much when comp points are appropriated while they are at a GD (because most GDs do not display how many comp points a player earns while he is gaming), and therefore loss of comp points may feel less significant to a player. The player may also prefer that comp points be appropriated instead of credits on a GD because appropriating a player's comp points instead of a portion of his winnings allows a player to reinvest his winnings from wagering game play to place additional bets.

In some embodiments, an agreement may specify comp points as a benefit and then appropriate comp points from a player. For example, a player may make an agreement to receive an “advance” of 20,000 comp points as a benefit in exchange for allowing his future awards of comp points to be appropriated at a rate of 50% (up to a total of 20,000 comp points). The player may then use this advance of 20,000 comp points to purchase products or services at a retailer that accepts comp points as payment.

3. Appropriating at Table Games

In some embodiments, in exchange for a benefit a player may make an agreement to have a portion of his winnings that occur at a table game (e.g., blackjack, poker, roulette, craps) appropriated. For example, a player may make an agreement to have 1 chip appropriated each time he wins a prize while playing craps, or a player may make an agreement to have 10% of his winnings appropriated when playing poker at a poker table, or a player may make an agreement to play roulette at a table that has reduced prize values (e.g., a winning bet on a number pays out 32:1 instead of 35:1). In such an embodiment, the reduced prize values at the table game take are equivalent to, or take the place of, a formal appropriation scheme.

In some embodiments, when starting a gaming session at a table game, a player may identify himself or identify an agreement that he has made. For example, a player may provide his player tracking card number to a casino employee (e.g., a dealer) who is operating the table game. The casino employee may then use an electronic device (e.g., a table-top computer) to retrieve information about an agreement the player has made (e.g., a description of the appropriation scheme), and then provide wagering game play to that player according to the terms of the agreement.

In other implementations, an electronic device (e.g., a table-top computer, a PDA) may prompt a dealer (or other casino employee) to appropriate a portion of a player's winnings according to an appropriation scheme. This prompting may include instructions concerning when to appropriate the player's winnings and how much to appropriate from the player's winnings. The dealer may then perform the necessary actions to appropriate a portion of the player's winnings as directed by the prompt. For example, a player may have made an agreement to have 1 chip appropriated each time he wins a prize while playing roulette. When the player goes to the roulette table and wins a prize, an electronic device at the roulette table may display a prompt to the dealer (“Appropriate one chip from player #3's prize”). In another example, a player may make an agreement to have 10% of his winnings appropriated when player poker at a poker table. When the player wins a pot at the poker table, an electronic device at the poker table may calculate 10% of the pot value and display this amount to a dealer so that the dealer may take that calculated amount from the player's winning outcome.

B. Modifying a Wagering Game

In some embodiments, a wagering game that is played on a GD may be altered based on one or more terms of an agreement made by a player. For example, a modification that a player may be permitted to make to a wagering game is adding one or more symbols to the reels of a slot machine. When these additional symbols appear in a gaming outcome, the player may win a prize that relates to the agreement. For example, the player may make an agreement to receive a free dessert at a restaurant, and based on this agreement, 3 “Sundae” symbols are added to the reels of a slot machine. If the player achieves an outcome of “Sundae-Sundae-Sundae” on that GD, then the player wins the prize of having his free dessert agreement paid off in full. Alternatively, existing symbols on the reels of a slot machine may be modified based on an agreement (e.g., the lemon symbols on slot machine reels may be changed to sundae symbols).

Other embodiments may permit additional types of wagering game modifications. For example, a card (e.g., a joker) may be added to a deck of cards in a video card game (e.g., video blackjack, video poker) or to a table game. If this card is dealt to a player who has made an agreement, then the player wins a prize relating to the agreement (e.g., the player's agreement may be terminated without penalty). In another example, a bonus game on a GD may be modified to include a prize relating to an agreement. In a particular example, a player wins an entrance into the bonus round on a “Frantic Frogs” GD, and during the bonus round, the player selects lily pads and win prizes based on his selections. If the player selects lily pad #3, then he wins a prize of $20 that is used to offset any value on a debt meter balance. Such a prize may thereby help the player work towards completing a gaming requirement of having a total of $40 appropriated from his winnings.

In some embodiments, a game may be modified to include references to an agreement. For example, an animated rabbit character that inhabits a Rascally Rabbit slot machine game may wear a top hat when a player has an active agreement that causes a portion of his winnings to be appropriated.

C. Play It Off Later

In some embodiments, players may be permitted to sign up for a “Play It Off Later” credit card that may be issued by a casino, or that may be issued by a third party provider who is associated with a casino. For example, players who are “regulars” at a particular casino, and/or who have player tracking cards, and/or who have good credit histories, and/or who are otherwise known to the casino to have favorable reputations may be offered the opportunity to acquire such a “Play It Off Later” credit card. In an embodiment, players use the “Play It Off Later” credit card at any participating establishment (i.e., retailers and/or service providers) to purchase any desired products and/or services. The cost (or a portion of the cost) of the products or services purchased with the “Play It Off Later” credit card may be paid for by appropriation of a portion of the card holder's (the player's) winning outcomes that occur during play of wagering games at one or more participating and/or sponsoring casinos. For example, a player inserts or swipes his “Play It Off Later” credit card at a GD located in a participating casino, and then plays the wagering game under the terms of the credit card agreement (which may include one or more appropriation schemes and/or gaming requirements that may be imposed depending on such variables as the amount being wagered, the amount of debt currently carried in the account of the “Play It Off Later” credit card, the type of wagering game being played, the player's credit history, the player's gaming history, and the like data). In some embodiments, the “Play It Off Later” credit card debt may not be subject to any interest charges if the amount owed is “played-off” according to the credit card agreement (i.e., settled within a predefined time window by appropriation of a required amount from the winnings of the player's wagering game play activity).

In some embodiments, the “Play It Off Later” credit card may be linked to another credit card account of the player (i.e., VISA, MASTERCARD, AMERICAN EXPRESS, DISCOVER, etc.), which may be utilized as a back-up card. Thus, if a balance of the “Play It Off Later” credit card is not played-off by a certain predetermined deadline (for example, the end date of a billing cycle), then the balance (or portion thereof) would be transferred to the linked card. The transferred balance (or portion thereof) would then be treated as any other credit charge that may be subject to interest charges according to the credit card agreement.

In some embodiments, instead of issuing a separate “Play It Off Later” credit card, the player may be provided with an opportunity to add a “Play It Off Later” option to one of his existing credit card accounts. For example, the player may sign up for benefits that include 20% discounts at participating retailers in exchange for having a “Play It Off Later” feature activated on his existing VISA card. Thus, whenever the player uses that VISA card at a participating retailer to buy a product or service, he automatically receives a discount and such charges are placed in a separate “bucket” or billing area associated with that VISA account. For example, charges associated with the “Play It Off Later” option may be broken out on the player's “First-Seventh Banc VISA” card account billing statement by printing such charges in an area separate from the normal charges, or such charges may be billed separately (i.e., on a separate billing statement that may or may not have the same billing cycle as his regular “First-Seventh Banc VISA” account, and/or may appear on a Web-based report that is accessible by the player). In this case, the “Play It Off Later” credit card charges may be subject to a “play-it-off” deadline that may be printed on the billing statement so that the player has a written indication of the time frame he has to play wagering games to settle any such charges. In some embodiments, if the player fails to “play it off” within the deadline, then such charges are transferred to the regular credit card account and are subjected to the normal billing cycle and to interest charges according to the player's credit card agreement. Thus, in an embodiment, at least a portion of the “Play It Off Later” credit card charges are not subject to interest charges unless these charges are transferred to the regular account. In yet other embodiments, on-line casino players may be permitted to obtain and use a “Play It Off Later” credit card and then have on-line gaming winning outcomes appropriated in accordance with the agreements associated with their credit cards.

D. Problem Gambling

In some embodiments, a casino may monitor players for indications of any of a plurality of behaviors or behavioral patterns indicative of “problem gambling”. Such behaviors may be detected, for example, by sensors and/or by other devices that may be associated with wagering games, such as one or more sensors and/or cameras associated with a GD. A list of such behaviors or behavior patterns may be stored, for example, in a database of the GD or of another device that is in communication with the GD. When such behaviors are detected, in some embodiments the GD may automatically transmit an indication of the behavior to another device and/or contact a casino representative and/or display a warning message to the player and/or take some other action. For example, the GD may transmit a signal to a GS indicating the behavior that the player is exhibiting, and display a warning message admonishing the player and indicating that if the behavior continues then appropriation mode will be ended and the player's credit card will be charged for the amount of debt owed for the benefit.

In some embodiments, the GD may be operable to access a database to output messages and/or signals GD concerning the problem gambling behavior of a player. For example, a sensor associated with the GD may operate to transmit a signal to another device such as a GS indicating that certain problem behavior is occurring which identifies the player currently playing that GD as potentially qualifying as a problem gambler. In another example, the GD may be directed by another device (or by its own processor) to output a message to a player (e.g., a message targeted at curbing the problem gambler's gambling behavior). In some embodiments, a processor of the GD may be operable to access a database (e.g., a problem gambler database) to write information to the database. For example, the GD may be operable to cause an indication of an input from a player to be stored in a record of the problem database that is associated with the player. For example, an indication of the player's aggression towards the GD (e.g., hitting or yelling at the GD) may be stored, and/or an indication of the player's attempt to initiate a game play prior to a resolution of a previously initiated game play may be stored. In some embodiments one or more of these behaviors may be an indication that a player qualifies as a problem gambler. Such data may be used to determine whether or not to terminate or otherwise restrict a “Play It Off” agreement, and/or the data may bee used when determining future offers for benefits for that player.

In one or more embodiments, a GS may also monitor player gambling history over time, by associating gambling behavior with player identifiers, such as player tracking card numbers and/or player photos. For example, in an embodiment a player's gambling patterns are monitored to determine if any changes have occurred (e.g., has the player changed the time of day or week that the player typically gambles), and a GS stores an indication of each time that a player gambles. Further, information about the player obtained or accessed by the GS may be analyzed, for example, to identify those players who may qualify as problem gamblers. For example, if a player has typically only gambled during evenings and on the weekends but suddenly and consistently starts to gamble during weekdays, such a change in gambling behavior may be determined to be an indication that the player may qualify as a problem gambler. Based upon desired objectives, a GS may direct the appropriate GD to display messages to specific players. For example, a message may notify the player that his behavior has been reported to authorities and/or stored in a database, and may also include a link and/or a telephone number to a gamblers anonymous hotline. In addition, an indication may be made in one or more databases that the player should be barred from obtaining future offers for benefits, or that the player should be restricted from receiving offers for benefits. For example, the player may not be eligible to receive an offer for a benefit until two weeks after the date of an incident involving problem gambling behavior.

Irrespective of the form in which such a list is stored, the following is an example list of events or actions on the part of the player who may be a problem gambler, the occurrence or detection of one or more of which may cause a GD to transmit such an indication: a player actuates or attempts to actuate an input device of the gaming device (e.g., a reel starting mechanism) during an inactive state of the input device (e.g., the player has attempted to spin the reels when the reels have not yet stopped spinning from a previously initiated game play); the player has selected or attempted to select a feature or option not available to the player (e.g., the player has attempted to select a wager amount not available to the player due to an insufficient credit meter balance or a payline or number of paylines not available to the player due to an insufficient credit meter balance); the player has engaged in certain wagering behavior, as explained below; the player has engaged in certain coin-in behavior, as described below; and the player has engaged a certain video poker strategy, as described below.

For example, a pattern of wagering that may be of concern may include one or more of the following: a player wins a jackpot and immediately keeps playing as fast as possible to wager with the win, without pausing at all to savor the big win or consider whether to cash out (i.e., no pause between a big win and the next game play initiation); on a high maximum wager gaming device, the player puts in 40 quarters (enough for one game play) and bets it all on one game play, then repeats the action for the next game play; a player persistently bets too high a proportion of coin in: for example, the player puts in $20, bets $6 on a first game play, bets $6 on a second game play; bets $6 on a third game play, bets $2 on the last game play, then puts in another $20 and repeats the betting pattern; the player places progressively larger bets after a series of losses (i.e., after an unlucky streak) which may be interpreted as a sign of desperation because the player is “chasing” the losses. In another example, if a player places large wagers on bets that are exceptionally improbable to pay out, such behavior may indicate a problem gambler. For example, a strategy pattern that may be of concern is if, in a video poker game, a player continuously applies a “desperation strategy” (e.g., of only going for the Royal Flush, no matter what cards are dealt). For example, a player may consistently throw away a high expected value hand (e.g., three of a kind) in order to attempt to get a Royal Flush. Accordingly, betting strategy in conjunction with wager size and player skill may be tracked by a peripheral server to determine if the player is making exceptionally poor strategy choices, which may be analyzed to determine if the player fits the profile of a problem gambler.

Many other patterns of behavior may be monitored and recognized among players. For example, consistently attempting to actuate the reel starting mechanism prior to the reels stopping spinning from a previously initiated game play may be a pattern of behavior that is recognized as a sign of a problem gambler. Excessively long gaming sessions wherein a person refuses to eat or go to the bathroom may indicate that player has a gambling problem. Repeated visits to casino at odd hours may indicate that a player could be skipping work or other responsibilities in order to play. Certain player movements on the casino floor, which may be picked up by cameras, may track certain patterns of movement (e.g., pacing in front of ATM machine, sitting alone in a corner of the gaming floor, sitting alone for long periods at the bar in a lounge area), and may be indicative of a potential problem gambler. Cameras within a casino may also be used to capture video of a player's face and process this video to determine emotions that are indicative of problem gaming (e.g., lack of sleep, inappropriate exuberance or inappropriate sadness). These emotions may be compared to gaming information (e.g., player betting patterns) to further identify problem gamblers.

Of course, in some embodiments a device besides the GD may analyze, process or compare a player's actions, emotional outbursts, or patterns of behavior to determine whether the player may qualify as a problem gambler. In such embodiments, the GD may simply transmit an indication of each player action or each qualifying player action to the other device (or the other device may otherwise determine each such player action or qualifying player action) in order to perform the analysis, processing or comparison.

In some embodiments, a peripheral device may be used to detect possible problem gamblers, and such devices could comprise one or more sensors associated with a GD. For example, a peripheral device may comprise one or more of (i) a microphone for detecting sounds emitted by a player of a GD; (ii) a weight sensor for detecting a player sitting in a chair associated with a GD; (iii) a tilt sensor for detecting a player tilting or moving a GD (e.g., if a player attempts to shake a GD); (iv) a camera for capturing images of a player and/or the GD; (v) an infrared thermometer which may be used, for example, to detect excitement, agitation or anxiety of a player; and/or (vi) one or more pressure sensors for detecting when a player strikes a GD. Such sensors may be utilized, for example, in embodiments in which a player is displaying aggressive behavior towards a GD or other aberrational behavior that could be interpreted as an indication or used as a factoring determining that the player may qualify as a problem gambler.

In summary, the player's wagering behavior may be monitored and if indicative of problem gambling, may affect the appropriation scheme and/or the determination of whether that player should receive future offers for benefits.

E. Hidden Account

In some embodiments, in addition to being able to handle agreement terms that include appropriating a portion of a player's winning outcomes, a GD may be configured to secretly store a portion of a player's credit balance in an account that is hidden from the player (e.g., not displayed on the credit meter of the GD). A description of such hidden accounts can be found in U.S. Published Application No. 2003/0,199,312, entitled “Methods and Apparatus for Managing an Account to Fund Benefits for a Player”, which is assigned to the assignee of the present application, and which is incorporated in its entirety herein.

For example, a very small portion of a player's winning outcomes may be stored in the hidden account, and this amount in the hidden account may be used to fund a bonus prize that is provided to the player, or may be used to purchase a complementary hotel room for the player. Money stored in a hidden account may be used as an appropriation amount to pay back a debt that is owed by a player or to terminate an agreement made by a player. For example, a player may make an agreement to get a free back massage in exchange for having a portion of his winnings appropriated on a GD up to a total of $50. When the player later visits the GD, money from a hidden account may be used to pay off the $50 debt. A message may then be output to the player (“Thanks to your status at the casino, your back massage is complimentary. Your winnings will not be appropriated.”) In another example, a player may make an agreement to get a free spa treatment in exchange for having a portion of his winnings appropriated on a GD up to a total of $100. The player may then operate a GD until he has had $64 of his winnings appropriated and still needs to have another $36 appropriated in order to complete his agreement. At this point, if there are adequate funds in a hidden account, the GD may use money from the hidden account to pay off the remaining $36 in the player's agreement. A message may then be output to the player (“Don't worry about satisfying the rest of your agreement—it's complimentary. From now on, your winnings will not be appropriated.”).

In some embodiments, a payout from a hidden account may be provided by generating a fake outcome on a GD. The fake outcome may be determined based on an agreement made by a player. For example, if an agreement provides a player with a discount on a bicycle, then a bicycle symbol may be added to the reels of a slot machine. If the bicycle symbol appears in an outcome generated by the player, then the player may win a benefit relating to the agreement (e.g., an additional $10 off the bicycle). If a player operates the GD for a sufficient time to build up a hidden account balance of over $10, then the GD may pay out a portion of this balance by generating a fake outcome on the GD that includes the bicycle symbol, and then pays out an appropriate prize to the player based on the outcome (e.g., an additional $10 off the bicycle). In another example, if according to an agreement, a player has 1 coin appropriated from any payout of 10 coins or more, and if the player wins an outcome of BAR-BAR-LEMON (which normally pays out 8 coins), the GD may use 4 coins from the player's hidden account to change this outcome to BAR-BAR-CHERRY, which pays out 12 coins. A coin may then be appropriated from this prize of 12 coins according to the terms of the player's agreement.

It is noted that using a hidden account to pay off a player's debt may result in a tremendous good will feeling from a player. For example, the player may be more willing to make additional agreements to obtain benefits in the future in exchange for appropriating a portion of his winnings, and he may also tell his friends and family about the good deal he received.

### 6. Rules of Interpretation

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise. The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning. Finally, unless a claim element is defined by reciting the word “means” and a function without reciting any structure, it is not intended that the scope of any claim element be interpreted based on the application of 35 U.S.C. §112, sixth paragraph.

Although the present invention has been described with respect to preferred embodiments thereof, those skilled in the art will note that various substitutions and modifications may be made to those embodiments described herein without departing from the spirit and scope of the present invention.

What is claimed is:

1. A method comprising:
determining that a player of a wagering game entered into an agreement associated with receipt of a benefit;
providing an indication of the agreement to the player, and
appropriating a portion of the value of at least one winning outcome in accordance with at least one condition of the agreement.

2. The method of claim 1, further comprising at least one of crediting any remainder portion of a winning outcome to a player account, and storing an indication of a value of the appropriated amount.

3. The method of claim 2, wherein the player account comprises at least one of a credit meter balance, a debt meter balance, a financial account, and a casino account.

4. The method of claim 1, wherein the agreement specifies at least one of the benefit, a value of the benefit, an appropriation scheme, and a penalty condition.

5. The method of claim 1, wherein the condition comprises at least one of utilizing at least one altered gaming condition during wagering game play, and utilizing an appropriation scheme.

6. The method of claim 5, wherein the at least one altered gaming condition comprises at least one of an altered pay table, a modified payout scheme, and altered probability table, a modification to the odds of obtaining winning combinations, and a modification of the types of winning combinations.

7. The method of claim 5, wherein the appropriation scheme comprises at least one of taking a share of each winning outcome, taking a share of winning outcomes up to a predetermined threshold value, taking a share of winnings for a predetermined type of winning outcome, taking a share of comp points, taking a share of a credit meter balance, and taking a share of winning outcomes at a predetermined rate.

8. The method of claim 5, wherein the appropriation scheme comprises appropriating a share of a credit meter balance if the credit meter balance falls below a threshold value.

9. The method of claim 8, which further comprises, prior to appropriating a share of the credit meter balance, prompting the player to make a payment to avoid having credits appropriated from the credit meter balance.

10. The method of claim 1, which further comprises terminating the appropriation of winning outcomes if a termination condition is satisfied.

11. The method of claim 10, wherein the termination condition comprises at least one of achieving a zero debt meter balance, accumulating a total amount of appropriated credits, achieving payment of a predetermined portion of the debt, obtaining a predetermined type of winning outcome, obtaining a predetermined event, receiving a pause indication by a player, and receiving a termination indication by the player.

12. The method of claim 10, which further comprises imposing a penalty if the termination condition is initiated by the player and occurs prior to satisfying the agreement.

13. The method of claim 1, which further comprises at least one gaming requirement in the agreement.

14. The method of claim 13, wherein the gaming requirement comprises requiring at least one of a minimum amount of wagering during a gaming session, wagering game play for a predetermined amount of time, achieving a threshold value of winning outcomes, achieving a predetermined threshold value of wagered credits, completion of wagering game play by a deadline, reaching a total amount of appropriated winnings, achieving a minimum amount of winning outcomes, operating an electronic game device at a minimum rate of speed, operating an electronic game device for a minimum amount of time, use of a specific type of electronic game device, and play at a specified table game.

15. The method of claim 1, further comprising monitoring wagering game play for satisfaction of at least one gaming requirement.

16. The method of claim 15, further comprising providing wagering game play in a regular mode if the player satisfies the at least one gaming requirement.

17. The method of claim 1, further comprising:
determining that the player is exhibiting problem gambler behavior; and
charging a remaining value of a debt owed by the player under the agreement to a player account.

18. The method of claim 17, which further comprises, prior to charging the remaining value of the debt to the player account:
warning the player that the player account will be charged unless the player agrees to cease the problem gambling behavior; and
continuing wagering game play if the player agrees to cease the problem gambling behavior.

19. The method of claim 1, further comprising, prior to determining that the player entered into the agreement:
providing an offer for a benefit to a player in exchange for entering into the agreement; and
providing the benefit if the player accepts the agreement.

20. The method of claim 19, which further comprises, prior to providing an offer, determining an agreement for the player.

21. The method of claim 20, wherein determining the agreement further comprises providing agreement terms based on at least one of player preferences, player activity associated with purchase of a product or service, a transaction at a retail establishment, a transaction at a point of sale terminal, other offers and agreements, gaming activity, an indication by the player, and an indication by a third party.

22. The method of claim 21, wherein the player indication further comprises at least one of pressing a button, using a touch screen display, using an input device, a request made to a casino representative, a request made to a retail employee, and inputting into an electronic game device at least one of a receipt, a player tracking card, a wagering ticket, a slots ticket, a voucher, and payment.

23. The method of claim 19, further comprising reconciling payment of a value associated with the benefit between at least two parties.

24. The method of claim 23, wherein the at least two parties comprise a two of a game machine operator, a retailer, a promoter, and a casino.

25. The method of claim 20, wherein determining the agreement further comprises monitoring an electronic game device for a trigger condition, and basing the offer for a benefit on the trigger condition.

26. The method of claim 25, wherein the trigger condition comprises an occurrence of at least one of an event at the electronic game device, at least one metric of wagering game play, at least one factor relating to a credit meter balance, wagering game play of at least one other electronic game device, conditions relating to the player, an indication provided by an eligible player, and an indication provided by a third party.

27. The method of claim 25, wherein the eligible player comprises at least one of a player using a player tracking card, a player who exceeds a predetermined credit balance, a player new to the electronic game device, a player who has been identified by a casino representative, a player having at least a predetermined number of comp points, a player who has been playing the electronic game device for at least a predetermined duration, and a player who has wagered at least a predetermined amount of money.

28. The method of claim 19, wherein the player accepts the agreement by at least one of verbally indicating acceptance to at least one of a casino employee and a retail establishment employee, signing an agreement document, and providing a digital signature.

29. The method of claim 19, which further comprises at least one of permitting the player to make at least one modification to the agreement, and storing an indication of the modified agreement.

30. The method of claim 29, wherein the modification comprises at least one of changing the type of benefit, modifying an appropriation scheme, modifying a gaming requirement, and terminating the agreement by agreeing to satisfy any remaining debt.

31. The method of claim 19, wherein the benefit comprises at least one of a product, a service, a discount on at least one of a product and a service, money, an alternate currency, comp points, wagering game credits, at least one activation feature of a gaming device, gaming-related benefits, and at least one wagering game feature.

32. The method of claim 19, wherein the benefit is provided by at least one of a casino, a gaming device operator, a promoter, a retail store, a credit card issuer, and a financial institution.

33. The method of claim 19, wherein offering a benefit further comprises offering the player at least one of a choice between at least two agreements, a choice of benefits, a choice of appropriation schemes, and a choice of gaming requirements.

34. The method of claim 19, which further comprises determining the benefit value after the agreement is made.

35. The method of claim 34, which further comprises basing the benefit value on at least one of a duration of the players' wagering game activity, the amount of credits appropriated from winning outcomes, and gaming activity on the casino floor.

36. The method of claim 19, which further comprises, before providing the benefit, authorizing a charge associated with the benefit to an account associated with the player.

37. The method of claim 36, wherein the account associated with the player comprises at least one of a credit card account, a debit card account, a casino account, a player financial account, and a bank account.

38. The method of claim 36, further comprising charging the player account for at least a portion of the value of the benefit if a penalty condition occurs.

39. The method of claim 38, wherein the penalty condition comprises at least one of the player failing to provide an agreed upon amount of winning outcome credits, failing to provide an agreed upon amount of game play wagering, failing to provide an agreed upon duration of game play, terminating the agreement before paying off the value of the benefit.

40. The method of claim 1, wherein the indication comprises at least one of an audio message, a video message, and written instructions on a substrate.

41. The method of claim 1, which further comprises providing the indication at least one of when a player begins a wagering game session, after each outcome during game play, in response to the occurrence of at least one event, and during a duration of the player's gaming session.

42. The method of claim 1, which further comprises storing appropriation data in a memory of at least one of a dedicated storage device, at least one electronic game device, at least one electronic game server, and a casino server.

43. The method of claim 40, which further comprises periodically transmitting the appropriation data to a central database.

44. The method of claim 40, which further comprises providing access to at least a portion of the appropriation data in the memory to at least one of authorized casino personnel, a regulator, and a player.

45. The method of claim 1, further comprising:
storing appropriation data in at least one memory;
analyzing the appropriation data;
determining at least one trend based on the analysis; and
determining at least one modified condition based on at least one trend indication.

46. The method of claim 1, further comprising modifying a wagering game according to the agreement.

47. The method of claim 46, wherein a modification to the wagering game comprises at least one of adding at least one symbol to at least one reel of an electronic game device, adding at least one card to a card table game, and adding a reference to the agreement.

48. The method of claim 1, further comprising associating a hidden account with the player.

49. The method of claim 48, which further comprises funding the hidden account by appropriating a portion of the player's winning outcomes.

50. The method of claim 48, further comprising using funds in the hidden account to at least one of generate a fake outcome for the player, pay off a debt of the player, provide a benefit to the player, and satisfy at least one term of an agreement made by the player.

51. A computer readable medium storing instructions configured to direct a processor to perform the method of claim 1.

52. The computer readable medium of claim 51, which further comprises instructions configured to direct a processor to at least one of credit any remainder portion of a winning outcome to a player account, and store an indication of a value of the appropriated amount.

53. The computer readable medium of claim 51, which further comprises instructions configured to direct a processor to terminate the appropriation of winning outcomes if a termination condition is satisfied.

54. The computer readable medium of claim 53, which further comprises instructions configured to direct a processor to impose a penalty if the termination condition is initiated by a player prior to satisfaction of the agreement.

55. The computer readable medium of claim 51, which further comprises instructions configured to direct a processor to monitor a player's game play for satisfaction of at least one gaming requirement.

56. The computer readable medium of claim 51, which further comprises instructions configured to direct a processor to, prior to determining that the player entered into the agreement: output an offer for a benefit to a player in exchange for entering into the agreement; and
provide the benefit if the player accepts the agreement.

57. The computer readable medium of claim 56, which further comprises instructions configured to direct a processor to, prior to outputting an offer, determine an agreement for the player.

58. The computer readable medium of claim 56, which further comprises instructions configured to direct a processor to reconcile a value associated with the benefit between at least two parties.

59. The computer readable medium of claim 56, which further comprises instructions configured to direct a processor to at least one of permit the player to make at least one modification to the agreement, and store an indication of the modified agreement.

60. The computer readable medium of claim 56, which further comprises instructions configured to direct a processor to determine a benefit value.

61. The computer readable medium of claim 56, which further comprises instructions configured to direct a processor to, prior to providing the benefit, authorize a charge associated with the benefit to an account associated with the player.

62. The computer readable medium of claim 61, which further comprises instructions configured to direct a processor to charge the player account for at least a portion of the value of the benefit if a penalty condition occurs.

63. The computer readable medium of claim 51, which further comprises instructions configured to direct a processor to output at least one of an indication that a share of winning outcomes has been appropriated, that predetermined gaming requirements apply, a player credit meter balance, a player debt meter balance, a list of agreements made by the player, and that a termination condition associated with appropriating winning outcomes occurred.

64. The computer readable medium of claim 51, which further comprises instructions configured to direct a processor to output an indication
when at least one of a player begins a wagering game session, after each outcome during game play, in response to the occurrence of at least one event, and during a duration of the player's gaming session.

65. The computer readable medium of claim 51, which further comprises instructions configured to direct a processor to store appropriation data in a memory of at least one of a dedicated storage device, at least one electronic game device, at least one electronic game server, and a casino server.

66. The computer readable medium of claim 51, which further comprises instructions configured to direct a processor to:
store appropriation data in at least one memory;
analyze the appropriation data;
determine at least one trend based on the analysis; and
modify at least one condition of the agreement based on at least one trend indication.

67. A method, comprising:
providing an offer for a benefit to a player in exchange for entering into an agreement to appropriate a share of at least one future winning outcome of a wagering game; and
providing the benefit if the player accepts the agreement.

68. The method of claim 67, wherein the agreement specifies at least one of the benefit, a value of the benefit, an appropriation scheme, a gaming requirement and a penalty condition.

69. The method of claim 68, wherein the gaming requirement comprises at least one of a minimum amount of wagering game play, a deadline for completing wagering game play, use of a specific type of electronic game device, and play at a specified table game.

70. The method of claim 67, which further comprises, prior to providing an offer, determining an agreement for the player.

71. The method of claim 70, wherein determining the agreement further comprises providing agreement terms based on at least one of player preferences, player activity associated with purchase of a product or service, a transaction at a retail establishment, a transaction at a point of sale terminal, other offers and agreements, gaming activity, an indication by the player, and an indication by a third party.

72. The method of claim 71, wherein the player indication further comprises at least one of pressing a button, using a touch screen display, using an input device, a request made to a casino representative, a request made to a retail employee, and inputting into an electronic game device at least one of a receipt, a player tracking card, a wagering ticket, a slots ticket, a voucher, and payment.

73. The method of claim 70, wherein determining the agreement further comprises monitoring an electronic game device for a trigger condition, and basing the offer for a benefit on the trigger condition.

74. The method of claim 73, wherein the trigger condition comprises an occurrence of at least one of an event at the electronic game device, at least one metric of wagering game play, at least one factor relating to a credit meter balance, wagering game play of at least one other electronic game device, conditions relating to the player, an indication provided by an eligible player, and an indication provided by a third party.

75. The method of claim 74, wherein the eligible player comprises at least one of a player using a player tracking card, a player who exceeds a predetermined credit balance, a player new to the electronic game device, a player who has been identified by a casino representative, a player having at least a predetermined number of comp points, a player who has been playing the electronic game device for at least a predetermined duration, and a player who has wagered at least a predetermined amount of money.

76. The method of claim 67, further comprising reconciling payment of a value associated with the benefit between at least two parties.

77. The method of claim 76, wherein the at least two parties comprise a two of a game machine operator, a retailer, a promoter, and a casino.

78. The method of claim 67, wherein the player accepts the agreement by at least one of verbally indicating acceptance to at least one of a casino employee and a retail establishment employee, signing an agreement document, and providing a digital signature.

79. The method of claim 67, which further comprises at least one of permitting the player to make at least one modification to the agreement, and storing an indication of the modified agreement.

80. The method of claim 79, wherein the modification comprises at least one of changing the type of benefit, modifying an appropriation scheme, modifying a gaming requirement, and terminating the agreement by agreeing to satisfy any remaining debt.

81. The method of claim 67, wherein the benefit comprises at least one of a product, a service, a discount on at least one of a product and a service, money, an alternate currency, comp points, wagering game credits, at least one activation feature of a gaming device, gaming-related benefits, and at least one wagering game feature.

82. The method of claim 67, wherein the benefit is provided by at least one of a casino, a gaming device operator, a promoter, a retail store, a credit card issuer, and a financial institution.

83. The method of claim 67, wherein offering a benefit further comprises offering the player at least one of a choice between at least two agreements, a choice of benefits, a choice of appropriation schemes, and a choice of gaming requirements.

84. The method of claim 67, which further comprises determining the benefit value after the agreement is made.

85. The method of claim 84, which further comprises basing the benefit value on at least one of a duration of the players' wagering game activity, the amount of credits appropriated from winning outcomes, and gaming activity on the casino floor.

86. The method of claim 67, which further comprises, before providing the benefit, authorizing a charge associated with the benefit to an account associated with the player.

87. The method of claim 86, wherein the account associated with the player comprises at least one of a credit card account, a debit card account, a casino account, a player financial account, and a bank account.

88. The method of claim 67, further comprising:
determining that a player of a wagering game entered into the agreement; and
appropriating a portion of the value of at least one winning outcome in accordance with at least one condition of the agreement.

89. The method of claim 88, further comprising at least one of crediting any remainder portion of a winning outcome to a player account, and storing an indication of a value of the appropriated amount.

90. The method of claim 89, wherein the player account comprises at least one of a credit meter balance, a debt meter balance, a financial account, and a casino account.

91. The method of claim 88, wherein the condition comprises at least one of utilizing an altered pay table during wagering game play, and utilizing an appropriation scheme.

92. The method of claim 91, wherein the at least one altered gaming condition comprises at least one of an altered pay table, a modified payout scheme, and altered probability table, a modification to the odds of obtaining winning combinations, and a modification of the types of winning combinations.

93. The method of claim 91, wherein the appropriation scheme comprises at least one of taking a share of each winning outcome, taking a share of winning outcomes up to a predetermined threshold value, taking a share of winnings for a predetermined type of winning outcome, taking a share of a credit meter balance, taking a share of comp points, and taking a share of winning outcomes at a predetermined rate.

94. The method of claim 91, wherein the appropriation scheme comprises taking a share of a credit meter balance if the credit meter balance falls below a threshold value.

95. The method of claim 94, which further comprises, prior to appropriating a share of the credit meter balance, prompting the player to make a payment to avoid having credits appropriated from the credit meter balance.

96. The method of claim 88, which further comprises terminating the appropriation of winning outcomes if a termination condition is satisfied.

97. The method of claim 96, wherein the termination condition comprises at least one of achieving a zero debt meter balance, accumulating a total amount of appropriated credits, achieving payment of a predetermined portion of the debt, obtaining a predetermined type of winning outcome, obtaining a predetermined event, receiving a pause indication by a player, and receiving a termination indication by the player.

98. The method of claim 96, which further comprises imposing a penalty if the termination condition is initiated by the player and occurs prior to satisfying the agreement.

99. The method of claim 88, further comprising monitoring a player's game play for satisfaction of at least one gaming requirement of the agreement.

100. The method of claim 99, wherein the at least one gaming requirement of the agreement comprises requires at least one of a minimum amount of wagering during a session of game play, wagering game play for a predetermined amount of time, achieving a threshold value of winning outcomes, achieving a predetermined threshold value of wagered credits, completion of wagering game play by a deadline, reaching a total amount of appropriated winnings, achieving a minimum amount of winning outcomes, operating an electronic game device at a minimum rate of speed, operating an electronic game device for a minimum amount of time, use of a specific type of electronic game device, and play at a specified table game.

101. The method of claim 99, further comprising providing wagering game play in a regular mode if the player satisfies the at least one gaming requirement.

102. The method of claim 88, further comprising:
determining that the player is exhibiting problem gambler behavior; and
charging a remaining value of a debt owed by the player under the agreement to a player account.

103. The method of claim 102, which further comprises, prior to charging the remaining value of the debt to the player account:
warning the player that the player account will be charged unless the player agrees to cease the problem gambling behavior; and
continuing wagering game play if the player agrees to cease the problem gambling behavior.

104. The method of claim 88, further comprising providing at least one indication that a share of winning outcomes has been appropriated, that predetermined gaming requirements apply, a player credit meter balance, a player debt meter balance, a list of agreements made by the player, and that a termination condition associated with appropriating winning outcomes occurred.

105. The method of claim 104, wherein the indication comprises at least one of an audio message, a video message, and written instructions on a substrate.

106. The method of claim 104, which further comprises displaying the indication at least one of when a player begins a wagering game play session, after each outcome during wagering game play, in response to the occurrence of at least one event, and during a duration of the player's gaming session.

107. The method of claim 88, further comprising storing appropriation data in a memory of at least one of a dedicated storage device, at least one electronic game device, at least one electronic game server, and a casino server.

108. The method of claim 107, further comprising providing access to at least a portion of the appropriation data in the memory to at least one of authorized persons, casino personnel, a regulator, and a player.

109. The method of claim 88, further comprising:
storing appropriation data in at least one memory;
analyzing the appropriation data;
determining at least one trend based on the analysis; and
modifying at least one condition of the agreement based on at least one trend indication.

110. The method of claim 88, further comprising, prior to appropriating a portion of a winning outcome, modifying a wagering game according to the agreement.

111. The method of claim 110, wherein a modification to the wagering game comprises at least one of adding at least one symbol to at least one reel of an electronic game device, adding at least one card to a card table game, and adding a reference to the agreement.

112. The method of claim 88, further comprising associating a hidden account with the player.

113. The method of claim 112, which further comprises funding the hidden account by appropriating a portion of the player's winning outcomes.

114. The method of claim 112, further comprising using funds in the hidden account to at least one of generate a fake outcome for the player, pay off a debt of the player, provide a benefit to the player, and satisfy at least one term of an agreement made by the player.

115. A computer readable medium storing instructions configured to direct a processor to perform the method of claim 67.

116. The computer readable medium of claim 115, which further comprises instructions configured to direct a processor to, prior to providing an offer, determine an agreement for the player.

117. The computer readable medium of claim 115, which further comprises instructions configured to direct a processor to monitor an electronic game device for a trigger condition, and basing the offer for a benefit on the trigger condition.

118. The computer readable medium of claim 115, which further comprises instructions configured to direct a processor to reconcile payment of a value associated with the benefit between at least two parties.

119. The computer readable medium of claim 115, which further comprises instructions configured to direct a processor to at least one of permit the player to make at least one modification to the agreement, and store an indication of the modified agreement.

120. The computer readable medium of claim 115, which further comprises instructions configured to direct a processor to determine the benefit value after the agreement is made.

121. The computer readable medium of claim 120, which further comprises instructions configured to direct a processor to base the benefit value on at least one of a duration of the players' wagering game activity, the amount of credits appropriated from winning outcomes, and gaming activity on the casino floor.

122. The computer readable medium of claim 115, which further comprises instructions configured to direct a processor to, before providing the benefit, authorize a charge associated with the benefit to an account associated with the player.

123. The computer readable medium of claim 115, which further comprises instructions configured to direct a processor to:
determine that a player of a wagering game entered into the agreement; and
appropriate a portion of the value of at least one winning outcome in accordance with at least one condition of the agreement.

124. The computer readable medium of claim 123, which further comprises instructions configured to direct a processor to at least one of credit any remainder portion of a winning outcome to a player account, and store an indication of a value of the appropriated amount.

125. The computer readable medium of claim 123, which further comprises instructions configured to direct a processor to at least one of utilize an altered paytable during wagering game play, and utilize an appropriation scheme.

126. The computer readable medium of claim 123, which further comprises instructions configured to direct a processor to terminate the appropriation of winning outcomes if a termination condition is satisfied.

127. The computer readable medium of claim 126, which further comprises instructions configured to direct a processor to impose a penalty if the termination condition is initiated by the player prior to satisfying the agreement.

128. The computer readable medium of claim 115, which further comprises instructions configured to direct a processor to monitor a player's game play for satisfaction of at least one gaming requirement.

129. The computer readable medium of claim 128, which further comprises instructions configured to direct a processor to provide wagering game play in a regular mode if the player satisfies the at least one gaming requirement.

130. The computer readable medium of claim 115, which further comprises instructions configured to direct a processor to determine that the player is exhibiting problem gambler behavior, and to charge a remaining value of a debt owed by the player under the agreement to a player account.

131. The computer readable medium of claim 130, which further comprises instructions configured to direct a processor to, prior to charging the remaining value of the debt to the player account, warn the player that the player account will be charged unless the player agrees to cease the problem gambling behavior, and continue to provide wagering game play if the player agrees to cease the problem gambling behavior.

132. The computer readable medium of claim 115, which further comprises instructions configured to direct a processor to provide an indication of at least one of that a share of winning outcomes has been appropriated, that predetermined gaming requirements apply, a player credit meter balance, a player debt meter balance, a list of agreements made by the player, and that a termination condition associated with appropriating winning outcomes occurred.

133. The computer readable medium of claim 115, which further comprises instructions configured to direct a processor to store appropriation data in a memory of at least one of a dedicated storage device, at least one electronic game device, at least one electronic game server, and a casino server.

134. The computer readable medium of claim 133, which further comprises instructions configured to direct a processor to provide access to at least a portion of the appropriation data in the memory to at least one of authorized persons, casino personnel, a regulator, and a player.

135. The computer readable medium of claim 115, which further comprises instructions configured to direct a processor to:
store appropriation data in at least one memory;
analyze the appropriation data;
determine at least one trend based on the analysis; and
modify at least one condition of the agreement based on at least one trend indication.

136. The computer readable medium of claim 115, which further comprises instructions configured to direct a processor to modify a wagering game according to the agreement.

137. The computer readable medium of claim 115, which further comprises instructions configured to direct a processor to associate a hidden account with the player.

138. The computer readable medium of claim 137, which further comprises instructions configured to direct a processor to fund the hidden account by appropriating a portion of the player's winning outcomes.

139. A method, comprising:
providing an offer for a benefit to a player in exchange for the player agreeing to have a portion of at least one future winning outcome appropriated during play of an electronic game device;
providing the benefit if the player agrees;
determining that a player of an electronic game device agreed to have a portion of at least one winning outcome appropriated;
providing an indication of the agreement to the player; and
appropriating a portion of at least one winning outcome in accordance with at least one condition.

140. The method of claim 139, further comprising at least one of debiting the portion of a winning outcome from a debit meter balance, and crediting a remainder portion of the winning outcome to a credit meter balance.

141. The method of claim 139, wherein the condition comprises at least one of utilizing an altered pay table during electronic game device play, and utilizing an appropriation scheme.

142. The method of claim 141, wherein the appropriation scheme comprises at least one of taking a share of each winning outcome, taking a share of winning outcomes up to a predetermined threshold value, taking a share of winnings for a predetermined type of winning outcome, taking a share of comp points, taking a share of a credit meter balance, and taking a share of winning outcomes at a predetermined rate.

143. The method of claim 139, which further comprises terminating the appropriation of winning outcomes if the player achieves at least one of a predetermined benefit value amount, a zero debt meter balance, accumulation of a total amount of appropriated credits, a specific type of winning outcome, a predetermined event, a pause indication by a player, and a termination indication by the player.

144. The method of claim 139, which further comprises, prior to providing the benefit, including at least one wagering game requirement in the agreement.

145. The method of claim 144, wherein the at least one wagering game requirement comprises requiring at least one of a minimum amount of wagering during a session of game play, wagering game play for a predetermined amount of time, achieving a threshold value of winning outcomes, achieving a predetermined threshold value of wagered credits, completion of wagering game play by a deadline, reaching a total amount of appropriated winnings, achieving a minimum amount of winning outcomes, operating an electronic game device at a minimum rate of speed, operating an electronic game device for a minimum amount of time, use of a specific type of electronic game device, and play at a specified table game.

146. The method of claim 144, further comprising monitoring the electronic game device being used by the player for satisfaction of the at least one gaming requirement.

147. The method of claim 146, further comprising providing wagering game play in a regular mode if the player satisfies the at least one gaming requirement.

148. The method of claim 139, further comprising:
determining that the player is exhibiting problem gambler behavior; and
charging a remaining value of a debt owed by the player under the agreement to a player account.

149. The method of claim 148, which further comprises, prior to charging the remaining value of the debt to the player account:
warning the player that the player account will be charged unless the player agrees to cease the problem gambling behavior; and
continuing wagering game play if the player agrees to cease the problem gambling behavior.

150. The method of claim 139, which further comprises, prior to providing an offer, determining an agreement for the player.

151. The method of claim 150, wherein determining the agreement further comprises providing agreement terms based on at least one of player preferences, player activity associated with purchase of a product or service, a transaction at a retail establishment, a transaction at a point of sale terminal, other offers and agreements, gaming activity, an indication by the player, and an indication by a third party.

152. The method of claim 150, wherein determining the agreement further comprises monitoring an electronic game device for a trigger condition, and basing the offer for a benefit on the trigger condition.

153. The method of claim 151, wherein the trigger condition comprises an occurrence of at least one of an event at the electronic game device, at least one metric of wagering game play, at least one factor relating to a credit meter balance, wagering game play of at least one other electronic game device, conditions relating to the player, an indication provided by an eligible player, and an indication provided by a third party.

154. The method of claim 153, wherein the eligible player comprises at least one of a player using a player tracking card, a player who exceeds a predetermined credit balance, a player new to the electronic game device, a player who has been identified by a casino representative, a player having at least a predetermined number of comp points, a player who has been playing the electronic game device for at least a predetermined duration, and a player who has wagered at least a predetermined amount of money.

155. The method of claim 139, further comprising reconciling payment of a value associated with the benefit between at least two parties.

156. The method of claim 155, wherein the at least two parties comprise a two of a game machine operator, a retailer, a promoter, and a casino.

157. The method of claim 139, which further comprises the player acknowledging agreement by at least one of verbally indicating acceptance to at least one of a casino employee and a retail establishment employee, signing an agreement document, and providing a digital signature.

158. The method of claim 139, which further comprises at least one of permitting the player to make at least one modification to an agreement to obtain the benefit, and storing an indication of the modification.

159. The method of claim 158, wherein the modification comprises at least one of changing the type of benefit, modifying an appropriation scheme, modifying a gaming requirement, and terminating the agreement by agreeing to satisfy any remaining debt.

160. The method of claim 139, wherein the benefit comprises at least one of comp points, wagering game credits, at least one activation feature of the electronic game device, and providing at least one electronic wagering game feature.

161. The method of claim 139, wherein offering a benefit further comprises offering the player at least one of a choice between at least two agreements, a choice of benefits, a choice of appropriation schemes, and a choice of gaming requirements.

162. The method of claim 139, which further comprises basing a benefit value on at least one of a duration of the wagering game activity on the electronic game device, the amount of credits appropriated from winning outcomes, and gaming activity of a plurality of electronic game devices.

163. The method of claim 139, further comprising charging a player account for at least a portion of a value of the benefit for failure by the player to at least one of provide an agreed upon amount of winning outcome credits, provide an agreed upon amount of game play wagering, provide an agreed upon duration of game play, and provide repayment of a predetermined benefit value.

164. The method of claim 139, which further comprises indicating at least one of that a share of winning outcomes has been appropriated, that predetermined gaming requirements apply, a player credit meter balance, a player debt meter balance, a list of agreements made by the player, and that a termination condition associated with appropriating winning outcomes occurred.

165. The method of claim 139, wherein the indication comprises at least one of an audio message, a video message, and written instructions on a substrate.

166. The method of claim 139, which further comprises storing appropriation data in a memory of at least one of a dedicated storage device, at least one electronic game device, at least one electronic game server, and a casino server.

167. The method of claim 166, which further comprises providing access to at least a portion of the appropriation data in the memory to at least one of authorized persons, casino personnel, a regulator, and a player.

168. The method of claim 139, further comprising:
storing appropriation data in at least one memory;
analyzing the appropriation data;
determining at least one trend based on the analysis; and
modifying at least one condition of the agreement based on at least one trend indication.

169. The method of claim 139, further comprising modifying a wagering game of an electronic game device according to the agreement.

170. The method of claim 169, wherein a modification to the wagering game of the electronic game device comprises at least one of adding at least one symbol to at least one reel of the electronic game device, adding at least one card to a video card game, and adding a reference to the agreement.

171. The method of claim 139, further comprising associating a hidden account with the player.

172. The method of claim 171, which further comprises funding the hidden account by appropriating a portion of the player's winning outcomes on the electronic game device.

173. The method of claim 172, further comprising using funds in the hidden account to at least one of generate a fake outcome for the player, pay off a debt of the player, provide a benefit to the player, and satisfy at least one term of an agreement made by the player.

174. A computer readable medium storing instructions configured to direct a processor to perform the method of claim 139.

175. The computer readable medium of claim 174, which further comprises instructions configured to direct a processor to at least one of debit the portion of a winning outcome from a debt meter balance, and credit any remainder portion of the winning outcome to a credit meter balance.

176. The computer readable medium of claim 174, which further comprises instructions configured to direct a processor to at least one of utilize an altered pay table during electronic game device play, and utilize an appropriation scheme.

177. The computer readable medium of claim 174, which further comprises instructions configured to direct a processor to terminate the appropriation of winning outcomes if the player achieves at least one of a benefit value amount, a zero debt meter balance, accumulation of a total amount of appropriated credits, payment of a predetermined portion of the debt, a specific type of winning outcome, a predetermined event, a pause indication by a player, and a termination indication by the player.

178. The computer readable medium of claim 174, which further comprises instructions configured to direct a processor to include at least one electronic game device gaming requirement in the agreement.

179. The computer readable medium of claim 178, which further comprises instructions configured to direct a processor to monitor the electronic game device being used by the player for satisfaction of the at least one gaming requirement.

180. The computer readable medium of claim 179, which further comprises instructions configured to direct a processor to provide wagering game play in a regular mode if the player satisfies the at least one gaming requirement.

181. The computer readable medium of claim 174, which further comprises instructions configured to direct a processor to, prior to providing an offer, determine an agreement for the player.

182. The computer readable medium of claim 174, which further comprises instructions configured to direct a processor to:
determine that the player is exhibiting problem gambler behavior; and
charge a remaining value of a debt owed by the player to a player account

183. The computer readable medium of claim 182, which further comprises instructions configured to direct a processor to, prior to charging the remaining value of the debt to the player account:
warn the player that the player account will be charged unless the player agrees to cease the problem gambling behavior; and
continue wagering game play if the player agrees to cease the problem gambling behavior.

184. The computer readable medium of claim 174, which further comprises instructions configured to direct a processor to reconcile payment of a value associated with the benefit between at least two parties.

185. The computer readable medium of claim 174, which further comprises instructions configured to direct a processor to monitor an electronic game device for a trigger condition, and to base the offer for a benefit on the trigger condition.

186. The computer readable medium of claim 174, which further comprises instructions configured to direct a processor to at least one of permit the player to make at least one modification to the agreement, and store an indication of the modified agreement.

187. The computer readable medium of claim 174, which further comprises instructions configured to direct a processor to offer the player at least one of a choice between at least two agreements, a choice of benefits, a choice of appropriation schemes, and a choice of gaming requirements.

188. The computer readable medium of claim 174, which further comprises instructions configured to direct a processor to charge a player account for at least a portion of the value of the benefit for failure by the player to at least one of provide an agreed upon amount of winning outcome credits, provide an agreed upon amount of game play wagering, provide an agreed upon duration of game play, and provide repayment of a predetermined benefit value.

189. The computer readable medium of claim 174, which further comprises instructions configured to direct a processor to provide an indication of at least one of that a share of winning outcomes has been appropriated, that predetermined gaming requirements apply, a player credit meter balance, a player debt meter balance, a list of agreements made by the player, and that a termination condition associated with appropriating winning outcomes occurred.

190. The computer readable medium of claim 174, which further comprises instructions configured to direct a processor to store appropriation data in a memory of at least one of a dedicated storage device, at least one electronic game device, at least one electronic game server, and a casino server.

191. The computer readable medium of claim 190, which further comprises instructions configured to direct a processor to provide access to at least a portion of the appropriation data in the memory to at least one of authorized persons, casino personnel, a regulator, and a player.

192. The computer readable medium of claim 174, which further comprises instructions configured to direct a processor to:
store appropriation data in at least one memory;
analyze the appropriation data;
determine at least one trend based on the analysis; and
modify at least one condition of the agreement based on at least one trend indication.

193. The computer readable medium of claim 174, which further comprises instructions configured to direct a processor to utilize funds of a hidden account associated with the player to at least one of generate a fake outcome for the player, pay off a debt of the player, provide a benefit to the player, and satisfy at least one term of an agreement made by the player.

194. A method, comprising:
providing an offer for a benefit to a player in exchange for entering into an agreement to appropriate a share of at least one future winning outcome during wagering game play;
providing the benefit if the player accepts the agreement;
analyzing at least one of offer data and appropriation data if the player does not accept the agreement;
determining at least one agreement term to adjust based on the analysis;
adjusting the least one agreement term to form a modified agreement; and
providing at least a second offer for a benefit to the player in exchange for entering into the modified agreement.

195. The method of claim 194, wherein analyzing the appropriation data further comprises utilizing appropriation data for a plurality of players.

196. The method of claim 195, which further comprises analyzing at least one of player preferences, prior agreement terms, player activity associated with purchases of products or services, and player gaming activity.

197. A method, comprising:
determining whether to offer a benefit to at least one player;
offering the benefit with agreement terms associated with a wagering game to the player if at least one condition is satisfied; and
providing the benefit if the player agrees to the terms of the agreement.

198. The method of claim 197, further comprising appropriating a portion of the player's winning outcomes of the wagering game according to at least one agreement term.

199. The method of claim 197, wherein the at least one condition comprises at least one of the availability of electronic game devices, the number of players present on the casino floor, the occurrence of at least one gaming metric, costs associated with providing the benefits, and the applicability of player attributes.

200. An electronic game device, comprising:
a processor;
a memory coupled to the processor;
a payment system coupled to the processor and configured to accept payment from a player desiring to play a wagering game and to establish a credit balance for the player;
at least one display device coupled to the processor configured to provide wagering game
play and to display messages to the player; and
at least one player input device coupled to the processor;
wherein the memory stores a program and a database, and wherein the database includes data associated with a regular play mode of operation and data associated with at least one type of player agreement, and
wherein the program includes instructions executable by the processor that are operable to:
determine that a player entered into an agreement associated with receipt of a benefit;
provide an appropriation mode of operation to the player;
appropriate a portion of the value of at least one winning outcome in accordance with at least one term of the agreement; and
store appropriation data.

201. The electronic game device of claim 200, further comprising a debt meter for displaying a value associated with a debt owed by a player.

202. The electronic game device of claim 200, wherein the processor is operative to monitor the electronic game device for the occurrence of a termination condition, and to terminate the appropriation of a portion of the value of winning outcomes when the termination condition occurs.

203. The electronic game device of claim 200, wherein the processor is operative to at least one of monitor the electronic game device for the occurrence of a trigger condition and a termination condition, to determine an appropriation value to subtract from each qualifying winning outcome, and to decrease the debt value displayed on a debt meter when appropriating a portion of a winning outcome.

204. The electronic game device of claim 200, further including an input-output device coupled to the processor and operable to obtain appropriation data.

205. The electronic game device of claim 204, further comprising at least one of a peripheral device, a smart card, a USB key device, a personal digital assistant, a handheld device, and a casino personnel device configured to access the memory and to obtain at least a portion of the appropriation data.

206. A method, comprising:
determining that a player of a wagering game entered into an agreement associated with receipt of a benefit; and
appropriating a portion of at least one winning outcome in accordance with terms of the agreement up to a predetermined benefit value after the player has concluded wagering game play.

207. The method of claim 206, further comprising at least one of crediting any remainder portion greater than the benefit value to a player account, and storing an indication of the appropriated amount.

208. The method of claim 206, which further comprises imposing a penalty on the player if wagering game play is concluded before terms of the agreement are satisfied.

209. The method of claim 206, further comprising, before appropriating at least one winning outcome, providing an indication of the agreement to the player.
